(19) United States
(12) Patent Application Publication
(10) Pub. No.: US 2006/0127871 A1
(43) Pub. Date: Jun. 15, 2006

(54) Method and apparatus for teaching

(76) Inventor: George Dale Grayson, Parker, TX (US)

Correspondence Address: SLATER & MATSIL, L.L.P., 17950 PRESTON RD, SUITE 1000, DALLAS, TX, 75252-5793, US

(21) Appl. No.: 11/351,691

(22) Filed: Feb. 10, 2006

Related U.S. Application Data
(63) Continuation of application No. PCT/US04/25985, filed on Aug. 11, 2004.
(60) Provisional application No. 60/494,164, filed on Aug. 11, 2003.

(51) Int. Cl. G09B 3/00

(52) U.S. Cl. 434/350

(57) ABSTRACT

A method and an apparatus for teaching through assessment-directed individualized instruction using a series of interrelated interactive and linear lessons on a computer or computer network. In an embodiment, subject matter is broken into dependent and independent skills and concepts. Students are presented the skills and concepts in skill/sub-skill teaching cycles that incorporate concept-teaching activities, guided practices, independent practices, and assessments. The progress of the student is tracked in a knowledge base. The teaching of each student is customized based upon the level of understanding of each skill and concept. In an embodiment, the student is allowed to proceed even though the student has not achieved a predetermined level of understanding of past skills and concepts as these concepts will be re-introduced over time based upon evaluations of the knowledge base as needed until mastery is developed.

This application is a continuation of co-pending International Application No. PCT/US2004/025985, filed Aug. 11, 2004, which designated the United States and was published in English, and which is based on U.S. Provisional Application No. 60/494,164, filed Aug. 11, 2003, both of which applications are incorporated herein by reference.

### TECHNICAL FIELD

The present invention relates generally to a method and an apparatus for teaching and more particularly, to a method and an apparatus for teaching through assessment-directed individualized instruction.

### BACKGROUND

Teaching complex subjects such as reading, math, science, or a subset thereof is typified by a teacher or teachers teaching hundreds of grade level appropriate skill-based lessons following a general scope and sequence organized into lesson plans and lessons that, when taught to student(s) with sufficient motivation to learn for a sufficient duration, are learned and result in the student(s) developing an understanding of the overall subject matter. The “scope” in a scope and sequence is the overall subject matter to be taught such as reading, math, science, a subset thereof, or the like. The “sequence” is the order that skills are to be taught.

The teaching environment typically includes a teacher lecturing or demonstrating specific skills and concepts to a group of students. Additionally, some teachers use class participation as a method to further reinforce the concepts and to allow the student to practice the skills. As teachers teach, they use a variety of subjective informal assessments and periodic formal assessments to obtain a general understanding of student knowledge. Based on this general understanding of student knowledge, the teacher typically assigns a numerical or letter grade to each student. If the numerical or letter grade indicates that the student does not understand the concepts at a required level, that student may receive additional instruction or be held back a grade.

The group-teaching discussed above, however, provides little or no individualized instruction and does not allow for customized lesson plans to be created for each student based upon their individual needs. Furthermore, assessment of the student's understanding by the periodic assessments only provides a macro view of the student's understanding, such as a gross letter or numerical grade. Thus, because subjects comprise complex, interrelated concepts, the teacher often does not have available tools or data to identify or dissect the cause of a student's learning deficiency. And even if the teacher knows which concepts or skills each student understands, the teacher does not have the time to evaluate and assist each student individually in each of the individual skills.

There is a need for a method and an apparatus for teaching through assessment-directed individualized instruction using a series of interrelated interactive lessons on a computer or computer network.

### SUMMARY OF THE INVENTION

The need for customized lesson plans for each student is generally solved or circumvented, and technical advantages are generally achieved, by preferred embodiments of the present invention which provides a system and method for teaching through assessment-directed individualized instruction using a series of interrelated interactive on a computer or computer network.

Embodiments of the present invention provide a computer program product for teaching a subject to a student. The computer program performs a teaching cycle to teach one or more skills to a student. The teaching cycle may be followed by an independent practice, which acts as an interactive assessment. The student's interactions and/or results of the assessment are stored in a knowledge base for determining a skill level for one or more of the skills presented. For skills in which the skill level is below an acceptable level, a re-teach cycle may be performed. In this manner, the routing of the student through successive lessons is dynamically determined and a lesson plan is customized based upon each student's needs.

Accordingly, embodiments of the present invention account for the differences in how each individual child learns. For a child that can master all skills as they are presented, the sequence of skills may be predetermined. Because the children generally learn at different rates, in different manners and have different levels of prior knowledge, however, predetermined routing logic is altered so that lesson order is dynamically determined based upon student interaction so as to individualize each child's instruction. In embodiments of the present invention, the routing logic is based on an evaluation of a child's interactions stored in the knowledge base, including score, level, type, and the like, and an algorithm or a series of algorithms that apply weightings to student interactions and identify patterns of error.

Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a network diagram embodying features of the present invention;

FIG. 2 is a network diagram embodying features of the present invention;

FIG. 3 is a flow diagram illustrating steps to teach a student in accordance with an embodiment of the present invention;

FIG. 4 is a flow diagram of an applied skills teaching cycle in accordance with an embodiment of the present invention;

FIG. 5 is a flow diagram of a teaching cycle cluster in accordance with an embodiment of the present invention;

FIG. 6 is a flow diagram of a unit teaching cycle in accordance with an embodiment of the present invention;

FIGS. 7a and 7b illustrate an example of skill transference in accordance with an embodiment of the present invention;

FIG. 8 illustrates types of information that may be recorded in a knowledge base in accordance with an embodiment of the present invention;

FIG. 9 is a data flow diagram of a disability diagnostic process in accordance with an embodiment of the present invention; and

FIG. 10 is a data flow diagram of a notification process in accordance with an embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention provides a system and a method for teaching one or more skills to a student. The skill may include any skill, sub-skill, concept, rule, or the like. The present invention will be described broadly so as to enable one to apply embodiments of the present invention to any subject or skill that is to be taught. Specific examples will be given with respect to embodiments in a specific context, namely an interactive educational application that teaches students to read in English while assisting students with a limited vocabulary and/or English language learners with English language acquisition, for illustrative purposes only. The invention may also be applied to teaching other subjects, such as math, science, language arts, social studies, foreign languages, corporate training, home schooling, distance learning, professional development, games, and the like.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless otherwise indicated.

Generally, embodiments of the present invention provide a method and apparatus for individualizing instruction and ensuring subject matter, such as reading, math, science, subsets thereof, or the like, are learned through data directed instruction of a specific scope using a sequence or sequences of interactive lessons. The sequences comprise interrelated skills or concepts presented through scaffolding (e.g., defining dependencies between skills and prerequisite skills) and may be ordered dynamically based upon student interaction and assessment data generated through use of the interactive lessons and by routing logic and the like.

The dependency definitions may include a specification of the level of mastery (e.g., level of understanding) of predecessor skills required to advance to successor skills. The specifications of the skills may include different aspects of the skills such as demonstrated ability to use the skill in isolation or application based on short-term memory or long-term memory.

An embodiment of the present invention defines a knowledge base, or repository, to store student interaction and assessment data and defines routing logic based on the evaluation of specific student interactions, assessments, evaluations, dependencies, and/or interrelationships as well as specific broader assessments and/or evaluations made using collective student interactions and assessment data contained in the knowledge base for purposes such as determining lesson order, the type and level of lesson presentation and the manner of presentation.

For a child that can master all skills as they are presented, the sequence of skills is predetermined. However, this is not the manner in which children typically learn. Children learn at different rates, in different manners and have different levels of prior knowledge. As a result, in embodiments of the present invention, the predetermined routing logic is altered so that lesson order is dynamically determined based on student interaction so as to individualize each child's instruction. In embodiments of the present invention, the routing logic is based on an evaluation of a child's interactions stored in the knowledge base, including score, level, type, and the like, and an algorithm or a series of algorithms that apply weightings to student interactions and identify patterns of error.

Based on specific skills, interrelationships between skills, combinations of skills, and/or scaffolding to be taught, computer-based interactive lessons may incorporate concept and/or skill explanations, guided practices that provide opportunities to apply concepts and/or skills, assessable independent practices that require students to demonstrate their understanding of concepts and/or skills, and assessments and evaluations to determine extent of learning of concepts, skills and scaffolding, and the like.

Embodiments of the present invention incorporate, but are not limited to, interactive concept and skill explanations, guided practices, independent practices and assessments and evaluations that use semantic memory strategies and emphasize different learning styles, such as visual, auditory, and tactile styles to enhance learning. Embodiments of the present invention also build a student's confidence and engage and motivate them through game-like interactivity, positive reinforcement, and immediate, contextually appropriate responses while reducing the risk of failure by teaching the students at their appropriate pace and to their zone of proximal development.

The preferred embodiment of the invention incorporates multiple levels, as needed, of concept and skill explanations, guided practices, independent practices, assessments and evaluations for each specific skill, interrelationship between skills, and/or combination of skills necessary to adequately understand the overall subject matter. An embodiment of the present invention teaches, assesses and evaluates skills and concepts, interrelationships between skills, combinations of skills, and scaffolding of skills and stores student interactions and assessment data in the knowledge base. The student interaction and assessment data may relate to concept and skill knowledge and scaffolding based on, for example, in isolation from short-term memory, in isolation from long-term memory, in application and/or context from short-term memory, and in application and/or context from long-term memory.

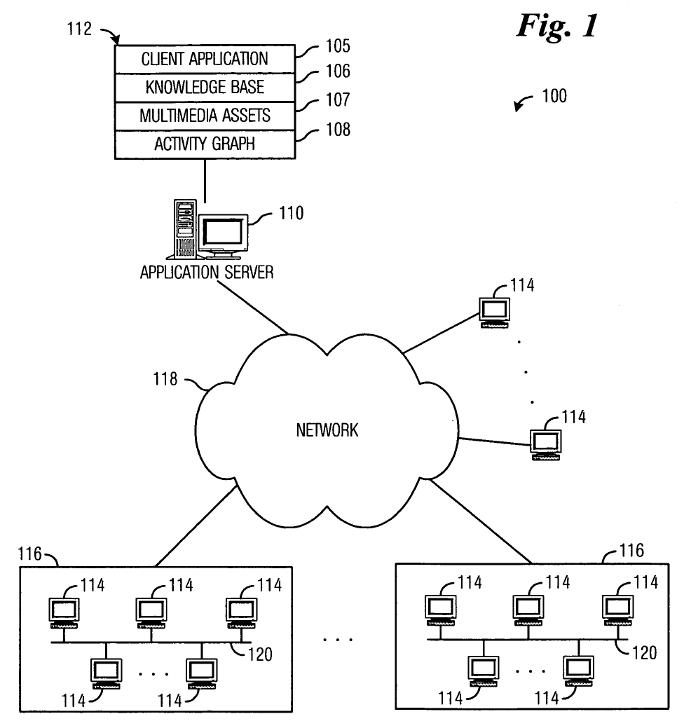

Referring now to FIG. 1, reference numeral 100 designates a network diagram that may be used in an embodiment of the present invention. An application server 110 is communicatively coupled to a database 112 and one or more clients 114 and groups of clients 116 (referred to hereinafter as “groups 116”). Preferably, the application server 110 is communicatively coupled to the clients and groups of clients via a network 118. The network 118, such as the Internet, a local-area network (LAN), a wide-area network (WAN), Public-Switched Telephone Network (PSTN), wireless communications network, or the like, provides communication services between the application server 110 and the clients 114 and groups of clients 116. The clients 114 and groups 116, however, may be directly connected to the application server 110 via a direct connection or a dial-up connection.

The clients 114 may be any suitable access device such as a wireline phone, wireless phone, laptop computer, desktop computer, tablet personal computer, Personal Data Assistant (PDA), or the like. It is noted that a user (not shown) operates the clients 114, and accordingly, clients 114 include a user providing input to the clients 114 and receiving output from the clients 114. The clients 114 are configured to provide network access to the application server 110 and to perform the functions described herein.

Preferably, a plurality of clients 114 may be grouped together to form groups 116. In an embodiment, the clients 114 within the groups 116 are communicatively coupled together via a group network 120, such as a LAN, WAN, PSTN, wireless communications network, or the like, and communicatively coupled to the network 118. Furthermore, each client 114 of the group 116 may have a link to the network 118, or a plurality of clients 114 in the group 116 may share a link to the network 118. The group network 120 may include a group server (not shown).

The database 112 may include a client application 105, a knowledge base 106, one or more multi-media assets 107, and an activity graph 108. The database 112 may be a relational database, such as an Oracle database, an Informix database, a Sybase database, a DB2 database, or the like, a text file, a binary data file, some combination thereof, or the like, configured to store user information and application information.

The client application 105 may be a software application that is written in a portable software language and downloaded as either one or more executables or as one or more code modules. Alternatively, the client application 105 may be a document, a series of documents, viewer files, or the like. For example, the client application may be an executable module obtained from compiling and building a software program written in Visual BASIC, Visual C++, C, C++, or the like. Alternatively, the client application may be a program written in an interpretive language such as Java, hyper-text markup language (HTML), extended markup language (XML), or the like that is downloaded and executed as source code. In the preferred embodiment, however, a language that compiles to native code, such as C++, is used. However, a portable language, such as JAVA, that has been modified to remove features and capabilities that are not required by the application is utilized in the role of a script language. A script language allows instructions to be performed that are easier to update than instructions in a native executable. In this manner, the size of the client application may be further reduced. Additionally, it may be desirable to separate the client application into one or more downloadable portions. In particular, separate downloadable portions may be particularly useful for large applications by reducing the download time and the space required on the clients 114.

The knowledge base 106 represents the user-specific data regarding the use of the system by a specific user or a specific group of users. In an embodiment in which the present invention is utilized for an automated teaching system, the knowledge base 106 contains detailed information regarding lessons performed by each student, student grade level, student interactions, the results of assessments, the attempts made by each student for each lesson, and the like. Furthermore, the knowledge base 106 may optionally include subscription information that indicates which goods and services a particular client 114 or group 116 may access and subscriber information that indicates the status of a client 114 or a group 116.

The multi-media assets 107 define how objects are to be presented to the user, such as presenting objects to the user via audio, graphics, a combination thereof, or the like. The multi-media files may be, for example, a bitmap file, a JPEG file, an MPEG file, a picture file, an audio file, or the like.

The activity graph 108 defines the activities and the sequence of a curriculum, such as activities in which the user is expected to partake. Generally, the activity graph 108 includes a series of nodes and relationships between those nodes. The nodes define an activity or action and the relationship between the nodes represents the sequence of nodes. The activity graph 108 is preferably designed to apply to groups of users such as a class, first graders, and the like.

The details of the client 114, the application server 10, the knowledge base 106, the client 14, the group 116, and the network 118 are well known to a person of ordinary skill in the art and, therefore, will not be discussed in further detail, except to the extent necessary to enable one of ordinary skill in the art to make and use the present invention.

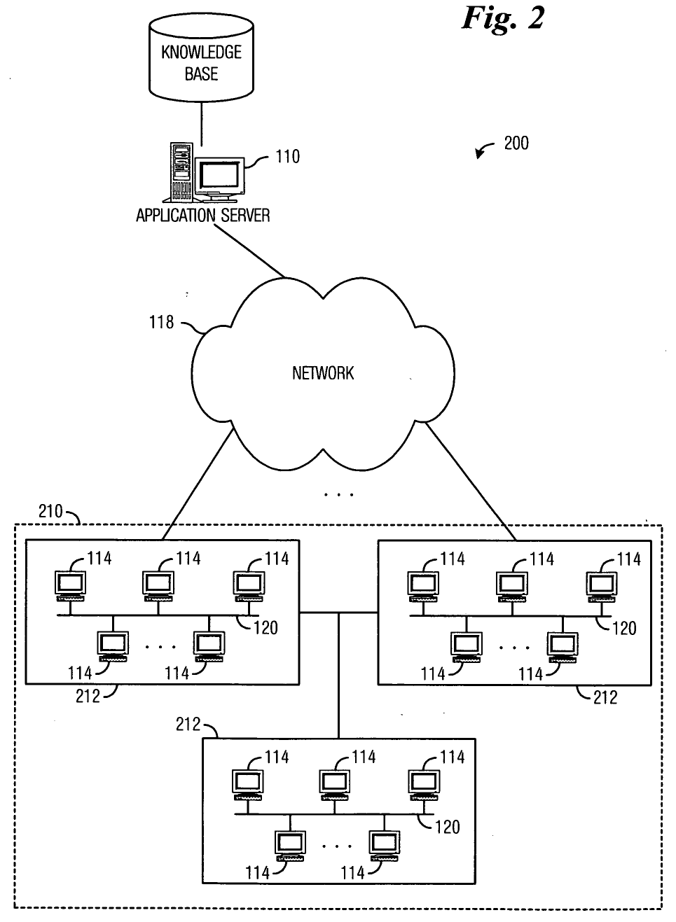

FIG. 2 is a network diagram in which reference numeral 200 designates a network environment embodying features in accordance with an embodiment of the present invention, wherein like reference numerals refer to like elements in FIG. 1. In this scenario, a group 210 includes subgroups 212, wherein each subgroup 212 may have one or more clients, such as clients 114. Each client 114 of each subgroup 212 is preferably connected to a group network 120 as described above. In addition, however, each subgroup 212 is communicatively coupled to one or more other subgroups 212. In the preferred embodiment, each subgroup 212 is communicatively coupled to each of the other subgroups 212 via a wide-area network or the like. Most preferably, each client 114 of each subgroup 212 is communicatively coupled to clients 114 contained in other subgroups 212.

For example, many school districts provide students, faculty, and administrators with computers configured to access a network such as the Internet. Within a school, such as an elementary, middle, or high school, computers are typically connected to a LAN, thereby providing access to other computers within the school. Furthermore, the computers are frequently able to gain access to clients or servers located in other schools, such as another elementary school within the same or different school district. Many times, a dedicated link is provided between schools.

Preferably, the method and apparatus described herein are embodied in a computer networking environment such that the teaching method may be distributed and utilized to a plurality of students easily and efficiently. One particular networking environment that may be utilized to implement the present invention is a networking environment that utilizes peer-to-peer knowledge base and application update technology. This particular type of networking environment allows a client computer to share or download the application and/or the application data (such as program data, e.g., bit maps, audio files, movie clips, and the like, knowledge base data, e.g., user subscription information, user status data, detailed user interactions and results of assessments and the like) on an as-needed basis. The client predicts the resources that the application will need and fetches the resource. Preferably, the client fetches the resources from another client, i.e., a peer, or an application server, such as a web server.

A description of one example of such a network and system, including the use of activity graphs, that is suitable for use with the present invention is described in the U.S. patent application Ser. No. 10/634,609, entitled “Method and Apparatus for Information Distribution and Retrieval,” which is incorporated herein by reference.

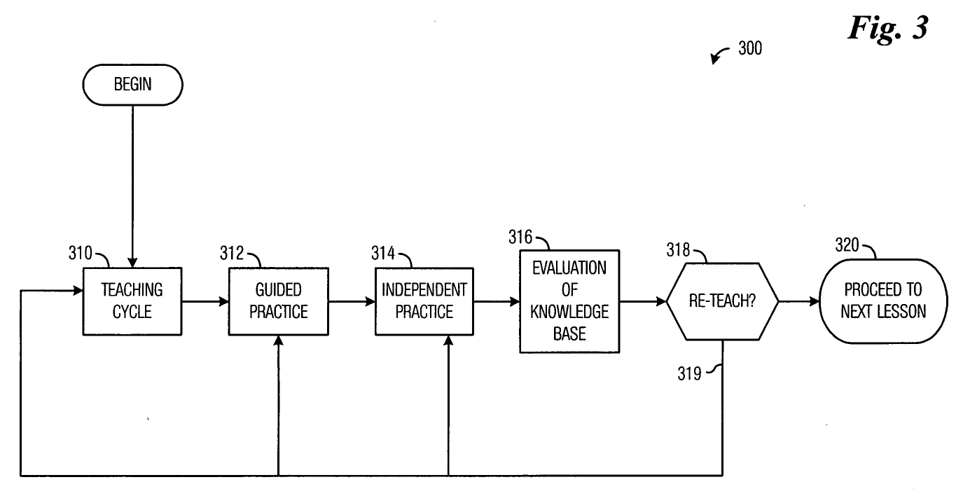

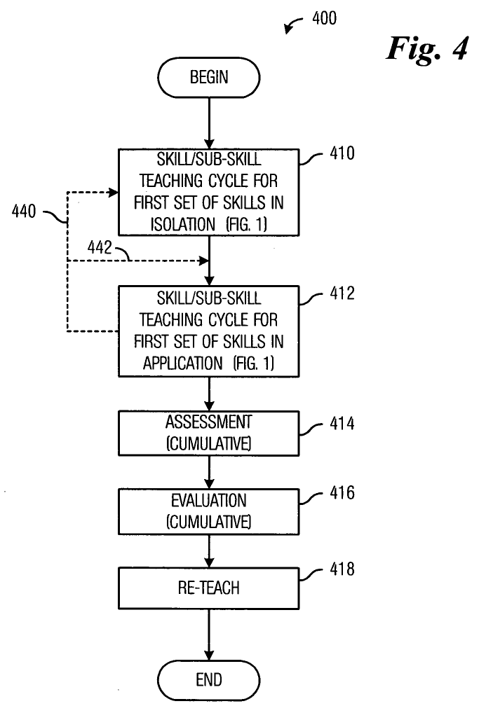

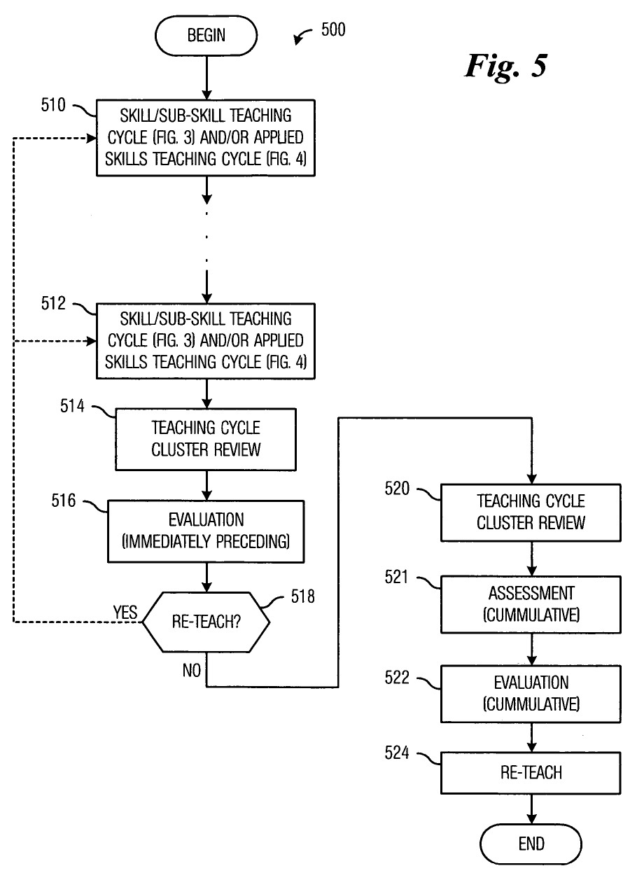

FIG. 3 is a diagram illustrating a skill/sub-skill teaching cycle 300 in accordance with an embodiment of the present invention. Generally, the skill/sub-skill teaching cycle 300 is used to teach and assess knowledge of a single skill, which may comprise one or more skills, sub-skills, rules, concepts, or the like, in order to reduce cognitive load and avoid confusion. It should be appreciated that through the use of a skill/sub-skill teaching cycle 300 to teach and assess a smaller group of skills, the system and method of teaching is able to isolate and determine skill levels of each skill. This allows the sequence of skills to be customized dynamically for each student.

For example, in an embodiment in which the present invention is used to teach English reading skills, a skill/sub-skill teaching cycle 300 may include instruction in skills that are similar in concept and do not require a predetermined level of understanding of other new skills. These are nondependent skills and include skills such as letter identification, sound symbol correspondence, site word identification, the identification of initial, medial and final letter sound and the like. In an embodiment of the present invention, teaching the sound that the letter “A” makes is a teach of a nondependent skill. This skill may be taught for every letter of the alphabet without any prior alphabetic knowledge.

Additionally other skills may be presented within each skill/sub-skill teaching cycle 300 that have dependencies on previously taught skills. These are dependent skills and include skills such as blending letter sounds with common vowel spelling patterns to read words and decoding by using all letter sounds within a word to read a word and the like. In an embodiment of the present invention, teaching the student to blend or combine the individual letter sounds of “m,” “a,” and “p” to make the word “map” is a teach of a dependent skill. This skill may only be taught if the student has a prior knowledge of letter sound correspondence.

In an embodiment, a skill/sub-skill teaching cycle 300 comprises one or more of a teach 310, a guided practice 312, and/or an independent practice 314. An evaluation of the knowledge base 316 and a re-teach 318 may also be performed. The teach 310 includes activities specifically designed to teach or explain one or more skills to the student. In an embodiment of the present invention, each concept may be taught using various formats and combinations with other concepts, some of which the student may have already demonstrated an understanding, thereby giving the student a stronger foundation on which to build.

Optionally, a guided practice 312 may be performed to provide an opportunity to reinforce the concepts presented in the teach 310. At this stage, it is preferred that the student be guided through the necessary practice sessions. Accordingly, it has been found that a tri-modal approach is particularly effective, especially in teaching reading. The tri-modal approach involves a hear phase (the teach), a see phase (the guided practice), and a do phase (the independent practice). In the hear phase, a sound, such as a long or short vowel, a blended sound, or the like, is played to the student to allow the student to hear the skill being taught. The hear phase may also involve the student being explained a concept. The see phase includes showing the graphical representation, if any, to the student to allow the student to visually distinguish the skill from other objects. Finally, the do phase allows the student to practice distinguishing, preferably verbally and visually, the object from other objects.

The independent practice 314 comprises an interactive assessment to determine the student's level of understanding of the concepts presented in the teach 310 and/or the guided practice 312. In an embodiment, the independent practice 314 comprises a structured exercise in which the student is asked to perform specific tasks, such as reading short stories, playing interactive games, practicing skills, and the like. For example, the student may be presented a short story or words containing the skills presented in the skill/sub-skill teaching cycle 300 and asked to identify specific letters, words, or combinations.

In a preferred embodiment, the independent practice 314 is an interactive assessment of the student's knowledge of the skills taught and/or practiced in the immediately preceding teach 310 and/or guided practice 312. In an alternative embodiment, however, any assessment and/or evaluation may include an assessment and/or evaluation of one or more previously presented skills.

Following the independent practice 314, an evaluation of the knowledge base 316 may be performed. In a preferred embodiment, the student's interactions, including interactions in each of the teach 310, guided practice 312, and/or independent practice 314, are recorded in the knowledge base 106 (FIG. 1). The knowledge base 106 may include skills taught, populations used, date-time stamps, and forms of input used in teaches, guided practices, and independent practices as well as discriminations made and scores and levels attained in independent practices and each of those elements from re-teach cycles and in situ re-teaches, teaches and exposures (discussed later), if any. The evaluation of the knowledge base 316 examines the knowledge base 106 to determine the student's skill level of one or more skills presented to the student. In a preferred embodiment, the evaluation 316 analyzes the knowledge base regarding skills and/or commonly related skills assessed in the immediately preceding assessment, e.g., independent practice 314.

Based upon the independent practice 314 (e.g., an assessment) and/or the evaluation 316, a determination may be made whether or not a re-teach should be performed, as indicated by step 318. As discussed above, the results of the assessment and/or the evaluation is an indication of the student's knowledge of the skills. In situations in which the student's knowledge of the skills is below an acceptable level, then it may be preferable to re-teach one or more of the skills to the student. As indicated by line 319, the re-teach may include performing one or more of a teach 310, a guided practice 312, and an independent practice 314.

A determination of whether or not to perform a re-teach may also be based upon the number of times a particular skill has been presented to the student. It has been found that presenting a skill multiple times in succession to a student frequently frustrates and discourages the student. Therefore, the re-teach may be performed once, and thereafter, the student may be allowed to proceed to a new skill. Other factors may also be used to determine whether or not to perform a re-teach.

If a determination is made in step 318 that a re-teach is not to be performed, then processing may proceed to a new skill, as indicated by block 320. The routing to a next lesson is preferably dynamically determined based upon either an assessment (e.g., a review or an independent practice), an evaluation of the knowledge base, or a combination thereof. In some circumstances, however, it may be desirable to proceed to a new skill regardless of the skill level or level of understanding attained by the student, referred to as static routing. One circumstance in which this has been found to be useful is the situation in which one or more re-teach cycles have been performed on a dependent skill or group of skills, but the student has yet to attain the desired threshold of understanding. It should be noted, however, that in these situations the routing may be predetermined or static, but skip a lesson for which the student is not prepared or alternatively move the student forward to provide practice using the skill in an application to facilitate skill transference and mapping skills into multiple paths of the brain.

It should also be noted that one or more of the teach 310, guided practice 312, and independent practice 314 may be multi-leveled. Multi-leveled components allow skills to be presented and practiced at different skill levels, e.g., different levels of understanding. For example, a student having difficulty learning a skill may be presented skills at an easy level, and another student that has exhibited an ability to quickly learn new skills may be presented skills at a more advanced level. The level at which skills are presented or practiced may be based on any relevant measurement. In an embodiment, the level is based at least in part on scores obtained by students in past sessions (related or unrelated), assessments, evaluations, number of times a skill has been presented, or the like. One of ordinary skill in the art will appreciate that in this manner the system and method dynamically adjusts for each student's abilities. This also presents material at a level that maintains the student's interest.

In situ teaches, re-teaches, and/or exposures (not shown) may be presented at any time, including during a teach 310, guided practice 312, an independent practice 314, an assessment or the like. An in situ re-teach provides an immediate teach of a skill. For example, during an independent practice 314, it may be detected that the student has repeatedly illustrated difficulty in one or more skills and that it may be beneficial to provide the re-teaches of the relevant skills during the independent practice 314. This re-teach, referred to as an in situ re-teach because it occurs during the independent practice, has the benefit of providing immediate feedback to the student, thereby enhancing the effect of the teaching system. In situ re-teaches may, for example, be used to clarify why a response was incorrect or to review one or more skills, why an answer or another answer is correct, or the like. For example, if the student is asked to “Click on the letter P” and the student answers incorrectly, a bubble may appear on the screen with the letter “P” in it and the instruction is “This is the letter P.”

An in situ teach comprises an in-the-moment teach related to a skill not currently being assessed as a result of an incorrect response. For example, if the student is asked to “Click on the letter P” and the student answers incorrectly, a bubble may appear on the screen and the instruction may be “No that is not correct. This is the letter B.”

An in situ exposure comprises an in-the-moment brief exposure to a skill not currently being assessed as a result of an incorrect response. For example, if the student is asked to “Click on the letter P” and the student answers incorrectly, the name of the incorrect letter clicked on is spoken, e.g., “B” is spoken.

FIG. 4 is a data flow diagram of an applied skills teaching cycle 400 in accordance with an embodiment of the present invention. In a preferred embodiment, the applied skills teaching cycle 400 comprises a first skill/sub-skill teaching cycle 410 and a second skill/sub-skill teaching cycle 412. The first skill/sub-skill teaching cycle 412 teaches one or more rule-based skills in isolation in order to reduce cognitive load, avoid confusion, and improve the ability to isolate and determine the associated skill level. The second skill/sub-skill teaching cycle 412 is used to teach how to apply the new skill or skills in an application. The first teaching cycle 410 and the second teaching cycle 412 may be performed similar to the skill/sub-skill teaching cycle 300 discussed above in reference to FIG. 3. Other embodiments, however, may be used.

For example, the first skill/sub-skill teaching cycle 410 may be used to teach the student how to identify the uppercase and lowercase letter “R” in isolation (with few or no other letters present). Afterwards, the second skill/sub-skill teaching cycle 412 may be used to teach the student how to identify the uppercase and lowercase letter “R” in application, such as identifying the letter “R” in the word “RED.” In application, other letters or skills may be present and may require the student to apply the skills in conjunction with other skills.

In another example, the first skill/sub-skill teaching cycle 410 may be used to teach the student the rule-based vowel spelling pattern of long vowel “a” spelled as “ai.” Afterwards, the second skill/sub-skill teaching cycle 412 may be used to teach the student to apply the rule-based vowel spelling pattern with other known skills to blend letter sounds together to form a word such as “tail” or “mail.” In application, other letters or skills may be present and may require the student to apply the skill in conjunction with other skills.

Applied skills teaching cycle 400 records interactions in the knowledge base 106. The interactions may include skills taught and assessed in isolation and application, nondependent skills applied in rule-based dependent skills in isolation and in application, populations used, date-time stamps, forms of input used in teaches, guided practices, and independent practices, discriminations made and scores and levels attained in independent practices, re-teach cycles performed, in situ re-teaches, teaches and exposures performed, and the like.

It should be noted that within each of the first skill/sub-skill teaching cycle 410 and the second skill/sub-skill teaching cycle 412 assessments, evaluations, and re-teaches may be performed as discussed above. In the preferred embodiment, the re-teach of the first skill/sub-skill teaching cycle 410 is limited to re-teaching skills presented in isolation, and the re-teach cycle of the second skill/sub-skill teaching cycle 412 include skills in isolation (represented by the dotted line 440) and/or skills in application (represented by the dotted line 442). In this manner, the student may be given additional instruction on the particular skills in isolation in which the student has demonstrated difficulty in applying in application.

For example, the second skill teaching cycle 412 may include an evaluation of the knowledge base to evaluate performance of the skill in application, such as identifying the letter “R” in words such as “RED,” “RAT,” and the like. If performance was less than expected or desired, the second skill teaching cycle 412 may include a second knowledge base evaluation to determine the student's student performance in identifying the letter “R” in isolation. If the student's performance was less than expected or desired, the re-teach cycle of the second skill teaching cycle 412 may include both skills in isolation (represented by line 440) and skills in application (represented by line 442). If the student performance in the first skill/sub-skill teaching cycle did not fall below an acceptable level, the re-teach cycle may include only skills in application (represented by line 442). However, a third evaluation may be performed and include a search for pattern of error, in this instance letters that the student consistently incorrectly identified in application as the letter “R.” The re-teach cycle may present different discriminations if a pattern of error was detected.

Thereafter, an assessment 414 and/or an evaluation 416 may be performed to assess and evaluate the student's cumulative knowledge of previously presented skills and skill transference. Whereas it is preferred that the assessments and evaluations performed within each of the first skill/sub-skill teaching cycle 410 and the second skill/sub-skill teaching cycle 412 assess and evaluate the knowledge of the skills presented within each of the respective teaching cycle, it is preferred that periodic assessments and evaluations be performed to assess the student's cumulative knowledge of the previously presented skills. Accordingly, the assessment 414 preferably comprises an interactive assessment of skills presented in each of the first skill/sub-skill teaching cycle 410 and the second skill/sub-skill teaching cycle 412 as well as other skills previously presented, and the evaluation 416 preferably comprises an analysis of the knowledge base regarding skills presented in each of the first skill/sub-skill teaching cycle 410 and the second skill/sub-skill teaching cycle 412 as well as other skills previously presented.

A re-teach 418 may be performed for any skill in which the results of the assessment 414 and/or the evaluations 416 indicate that the student does not have an acceptable level of understanding. Whereas each of the first skill/sub-skill teaching cycle 410 and the second skill/sub-skill teaching cycle 412 may include a re-teach that re-teaches skills presented in the respective teaching cycle, the re-teach 418 preferably provides a cumulative re-teach that may re-teach any skill presented in any of the first skill/sub-skill teaching cycle 410 or the second skill/sub-skill teaching cycle 412 or any other previously presented skill.

FIG. 5 is a data flow diagram of a teaching cycle cluster 500 in accordance with an embodiment of the present invention. The teaching cycle cluster 500 illustrates how skill/sub-skill teaching cycles and/or applied skills teaching cycles may be grouped together to facilitate teaching of closely related and/or common skills. In an embodiment of the present invention, a teaching cycle cluster may be used to teach closely related skills such as letter identification and sound symbol correspondence for a letter such as “M” or “A” or any letter of the alphabet. Each letter of the alphabet has a capital letter form, a lowercase letter form, and a sound that is created by that letter. Learning is facilitated by learning all of a letters' attributes in a logical sequence.

Teaching similar rule-based vowel spelling patterns in a sequence is another example of a teaching cycle cluster. Teaching the rule-based spelling pattern for long vowel “a,” spelled as “ai,” and the rule-based spelling pattern for long vowel “o,” spelled as “oa,” in a sequence facilitates learning of the rule. Learning how the rule applies to the vowel “ai,” where the letter “a” says its name and the letter “i” is silent is facilitated by learning that the same rule applies to the vowel “oa.”

Accordingly, the teaching cycle cluster 500 includes performing one or more skill/sub-skill teaching cycles (discussed above with reference to FIG. 3) and/or applied teaching cycles (discussed above with reference to FIG. 4), as indicated by reference numerals 510 and 512, in which common or related skills are taught. Thereafter, a teaching cycle cluster review 514 may be performed to evaluate learning for one or more of the skills that were taught in steps 510-512. In the preferred embodiment, the teaching cycle cluster review 514 is an interactive assessment of the student's knowledge of any skill, in either isolation or application, presented in the current teaching cycle cluster 500. It should be noted, however, that the teaching cycle cluster review 514 may assess or evaluate the student's knowledge of previously taught skills, as well. Preferably, the results of the teaching cycle cluster review 514 are added to the knowledge base. The results may include skills assessed, date-time stamps, forms of input, populations used, discriminations made, and scores and levels attained and the like.

In step 516, an evaluation of the knowledge base is performed. The evaluation is preferably an evaluation of the results of the teaching cycle cluster review 514, i.e., an evaluation of the student's knowledge of skills presented in the current teaching cycle cluster. As discussed above, the evaluation 516 analyzes the knowledge base to determine the student's skill level for one or more of the skills. The evaluations 516, which may be used for routing and/or notification purposes, may factor, for example, score or success rate on interactive activities included in the teaching cycle cluster such as skill/subskill teaching cycles, applied teaching cycles or a pre-teaching inventory, level of difficulty of discriminations, knowledge of closely related or common skills, the number of times that the skill has been presented and the like to calculate skill level for one or more skills.

A re-teach cycle 518 may be performed for any skill in which the evaluation indicated that the skill level of the student is below an acceptable level of understanding. The re-teach cycle may present common skills to reinforce given skills, present the same skills in a new manner, or the like. It should be noted that while the re-teach cycle 518 is graphically illustrated as looping back to a previous step, the re-teach cycle 518 involves dynamic routing and multi-leveled lessons. The re-teach cycle 518 may also perform teaches, guided practices, or independent practices at a different level (e.g., an easier or more difficult level) or present skills in a different manner.

For example, if a review for letter “A” skills is provided, after its completion, the knowledge base would be evaluated first for level of performance on the review. If performance on each skill evaluated met the required threshold level of understanding, the student would move forward in the sequence of lessons. If performance on one or more skills did not meet this threshold, a second level of evaluation may occur for each such skill. If for instance, a student's level of understanding of letter “A” phonemic awareness (the ability to identify and isolate the sound the letter “A” makes in a word) was less than desired, performance on the letter “A” phonemic awareness independent practices and demonstrated knowledge of letter “A” sound symbol correspondence would first be evaluated. If the student completed the most difficult level of phonemic awareness independent practice and passed the threshold of required knowledge for a closely related skill, sound symbol correspondence, on the review, no additional instruction may be required. In this instance, knowledge of how humans learn is factored into the design of the evaluation and routing system. A student's understanding of sound-symbol correspondence will increase the likelihood that the student will master phonemic awareness skills over time with additional practice using letter and sound knowledge. If these conditions are not met, a re-teach cycle may be presented or additional evaluations of the knowledge base may occur. The additional evaluations of the knowledge base may be performed to determine a pattern of error, in this instance letter sounds consistently incorrectly identified as “A” or consistently incorrectly identifying the letter “A” in the initial, medial, or final position, or to calculate a cumulative score for letter “A” phonemic awareness activities. As a result of these evaluations, the re-teach cycle may present different discriminations or new activities designed to address the type and level of additional learning required by each student.

In this embodiment in which a re-teach cycle is performed, it is preferred that the teaching cycle cluster review 520 be re-presented. It should be noted that the teaching cycle cluster review 520 may review additional skills or review the same skills in a different manner. The knowledge base is updated accordingly.

Thereafter, an assessment 521 and/or an evaluation 522 may be performed in which the student's cumulative knowledge of previously presented skills and skill transference is determined. The assessment 521 and evaluation 522 may evaluate knowledge of any skill previously presented in a skill/sub-skill teaching cycle 300, applied skills teaching cycle 400, and/or teaching cycle cluster 500.

The routing to a present a next lesson, e.g., by performing a basic skills teaching block, applied skills teaching block, teaching cycle, or the like, is preferably dynamically determined based upon either an assessment (e.g., a review, an independent practice), an evaluation of the knowledge base, or a combination thereof. In some circumstances, however, it may be desirable to proceed to a new skill regardless of the skill level or level of understanding attained by the student, referred to as static routing. One circumstance in which this has been found to be useful is the situation in which one or more re-teach cycles have been performed, but the student has yet to attain the desired threshold of understanding. It should be noted, however, that in these situations, the routing may be static, but skip a lesson for which the student is not prepared or alternatively move the student forward to provide practice using the skill in an application to facilitate skill transference and mapping skills into multiple paths of the brain.

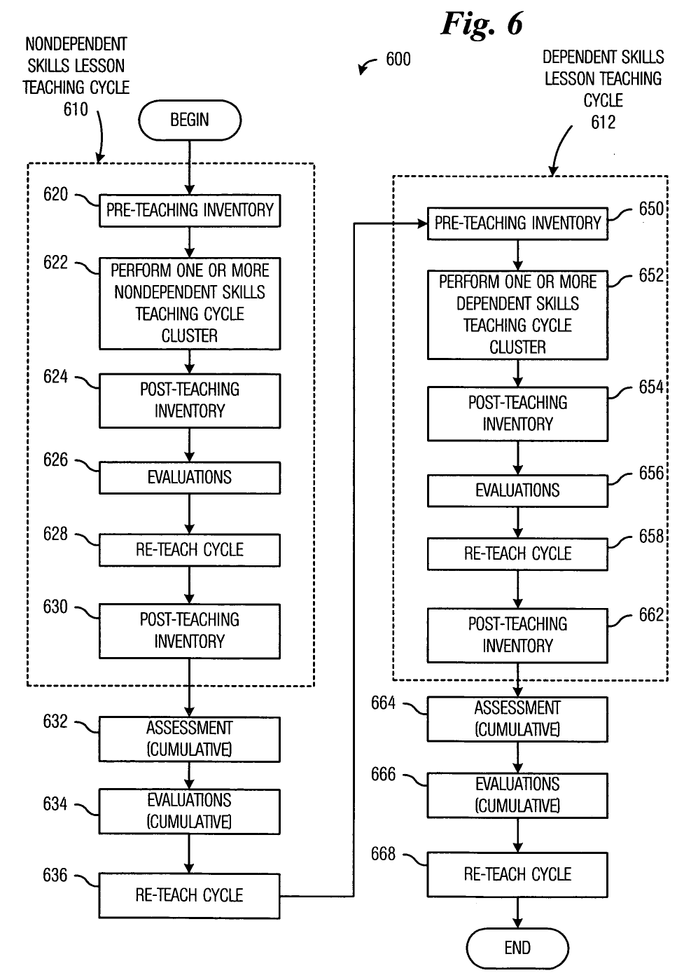

FIG. 6 is a data flow diagram illustrating a unit teaching cycle 600 in accordance with an embodiment of the present invention. The unit teaching cycle 600 may comprise any combination of one or more skill/sub-skill teaching cycles (FIG. 3), applied skills teaching cycles (FIG. 4), teaching cycle clusters (FIG. 5), or the like. A unit teaching cycle may consist of a series of intermingled dependent and nondependent skills. Generally, however, it is preferred that the unit teaching cycle include one or more nondependent skills lesson teaching cycles 610 and/or one or more dependent skills lesson teaching cycles 612 that progressively teach and build upon skills that relate to a central topic of a specific domain of the subject. The unit teaching cycle 600 preferably begin teaching relatively easy cycles of nondependent skills, progressing to teaching rule-based skills that are dependent upon the ability to apply previously-taught nondependent skills and previously-taught rule-based dependent skills in application and in context.

As discussed above, nondependent skills represent skills that may be taught and learned without requiring a predetermined level of understanding of other new skills. In this manner, multiple skills that do not necessarily rely upon each other may be taught, giving the student a feeling of accomplishment and progress. In some embodiments, the nondependent skills may reinforce similar concepts, further enhancing the benefits of the system.

For example, teaching closely related skills such as letter identification and sound symbol correspondence across a group of letters such as “M,” “A,” “P,” and “C” may be a nondependent skill teaching cycle. Each letter of the alphabet has conceptually similar attributes including a capital letter form, a lower case letter form and a sound that is created by that letter. Learning the attributes of letter “M” is facilitated by learning that other letters of the alphabet have those same attributes.

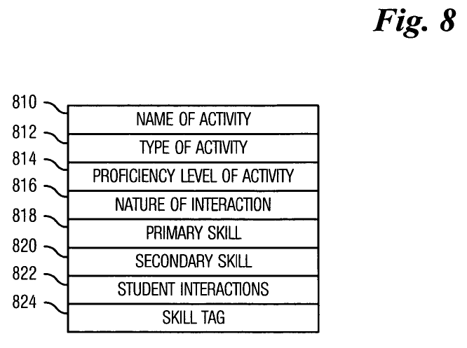

Furthermore, teaching the rule-based vowel spelling pattern for long “a,” spelled as “a_e,” for long “o,” spelled as long “o_e,” for long “i,” spelled as “i_e,” and for long “u,” spelled as “u_e,” across multiple units of the scope and sequence maybe a dependent unit teaching cycle. Each of the rule-based spelling patterns may, for example, be presented in an applied teaching cycle. Learning how the rule applies to the vowel “a_e,” where the letter “a” says its name and the letter “e” at the end of a word is silent is facilitated by learning that the same rule applies to the vowel patterns, “o_e,” “i_e,” and “u_e.” This is referred to as skill transference and is discussed in greater detail below with reference to FIGS. 8a and 8b.

Referring back to FIG. 6, a pre-teaching inventory 620 may be performed to determine and record in the knowledge base prior knowledge of skills to be taught within a nondependent skills lesson teaching cycle 610. When a pre-teaching inventory 620 is given, the results of the pre-teaching inventory in conjunction with routing logic are generally used to determine initial routing into nondependent skills teaching block 622. When a pre-teaching inventory is not given, each teaching cycle in the nondependent skills teaching block 622 is generally routed through in accordance with a predetermined sequence, dynamically adjusted and reordered based upon student interactions, assessments, evaluations and the like.

The nondependent skills teaching cycle 622 may comprise one or more of each of a skill/sub-skill teaching cycle (discussed in reference to FIG. 3), an applied skills teaching cycle (discussed in reference to FIG. 4), a teaching cycle cluster (discussed in reference to FIG. 5), or the like, that generally teach related and/or common skills that have little or no dependencies with each other that would hamper independent learning of a given skill. Generally, it is preferred that related skills are taught within a teaching cycle cluster and multiple teaching cycle clusters are used to teach common nondependent skills.

Using teaching cycle clusters to teach related and/or common skills facilitates learning by continuing to teach common and/or related skills while teaching new skills around the previously introduced, but not necessarily mastered, common and/or related skills. For example, a teaching cycle cluster might use the letter “A” to teach that all letters of the alphabet have common attributes including a name, a capital and lower case form, a sound the letter makes, etc., while other functionally similar teaching cycle clusters may be used to teach the common attributes for “B,” then “C,” etc.

Following the nondependent skills teaching cycle 622, a post-teaching inventory 624 may be performed. The post-teaching inventory 624 is preferably a multi-leveled interactive assessment that assesses learning for one or more of the skills taught in nondependent skills teaching cycle 622. The results, such as skills assessed, date-time stamps, forms of input, populations, discriminations made and scores and levels attained, are preferably added to the knowledge base such that the results may be used in evaluations for routing purposes.

An evaluation 626 may also be performed for re-teach routing. In the preferred embodiment, the evaluation 626 analyzes the results of the post-teaching inventory 624 as well as results from previously performed activities or assessments included in the nondependent skills teaching cycle such as pre-teaching inventories, assessments, reviews, teaches, guided practices and independent practices, knowledge of closely related or common skills and the like.

A re-teach cycle 628 may be performed to re-present skills that an assessment (e.g., post-teaching inventory) and/or the evaluation 626 indicated that the skill level of the student was below an acceptable threshold. The acceptable threshold is an indication of a level of understanding that it has been determined that a student should achieve prior to being exposed to new concepts. In an embodiment, however, the re-teach cycle 628 is only performed a predetermined number of times. Mastery of every nondependent skill discussed is not required prior to lessons in dependent skills, and not every nondependent skill must be learned to the same level of understanding initially. For example, the first skill learned may be required to be understood at a minimal level. As the student progresses and skills are built upon each other, the required level of understanding may increase to reflect the greater exposure to the skill. For example, learning the attributes of the letter “M” is facilitated by learning that the letter “A” has the same attributes, a lowercase form, a capital form, and sound that its form makes.

The re-teach cycle 628 may include one or more of a teach, a guided practice, an independent practice, or the like. The skills re-presented in the re-teach cycle 628 may include any previously presented skill, and the skills may be re-presented in the same or a different manner. An evaluation of the knowledge base and/or an assessment may be performed again after the re-teach cycle 628. For example, if a nondependent skill cycle post-teaching inventory is provided, after its completion an evaluation of the knowledge base would occur and a re-teach cycle would be presented for any skill or skills that the evaluation indicated fell below an acceptable threshold. In addition to the results of the post-teaching inventory, the evaluation for each skill may factor for example, score or success rate on interactive activities included in the nondependent teaching cycle cluster such as independent practices, reviews or a pre-teaching inventory, level of difficulty of discriminations, knowledge of closely related or common skills, the number of times that the skill has been presented and the like to calculate skill level for one or more skills.

For example, if a post-teaching inventory for the letters “M,” “A,” “P,” and “C” is provided, after its completion the knowledge base would be evaluated first for level of performance on the post-teaching inventory. If performance on each skill evaluated met the required threshold level of understanding, the student would move forward in the sequence of lessons. If performance on one or more skills did not meet this threshold, a second level of evaluation may occur for each such skill. If for instance, a student's performance on capital “P” identification fell below an acceptable level, an evaluation of performance related to capital “P” identification in other activities, possibly a “M,” “A,” “P,” and “C” pre-teaching inventory, letter recognition independent practices, and letter review included in the “M,” “A,” “P,” and “C” nondependent skill teaching cycle may be performed. A score may be calculated that would weight the most recent interactions from long-term memory more than those recorded earlier in the scope and sequence or from short-term memory and would weight more difficult interactions more than those that require a lesser order of thinking. If this calculation produces a score that falls below an acceptable level, a re-teach cycle may be presented or additional evaluations of the knowledge base may occur. An additional evaluation of the knowledge base may be performed to determine a pattern of error, in this instance letters consistently incorrectly identified as the letter “P.” The re-teach cycle presented may contain new and different discriminations or include previously learned nondependent skills if a pattern of error was identified. The presentation of the re-teach cycle may present the concepts in a different manner or format, depending on the results of the knowledge base evaluation and the level of knowledge demonstrated by the student.

A post-teaching inventory 630 is preferably repeated after the re-teach cycle 628. The post-teaching inventory 630 preferably assesses the skills assessed in the post-teaching inventory 624 to update the knowledge base after the re-teach cycle 628.

Thereafter, an assessment 632 and/or evaluation 634 may be performed that takes into consideration the student's cumulative knowledge of previously presented skills and skill transference. The assessment 632 and/or the evaluation 634 takes into consideration skills presented in the current unit teaching cycle 600 and other skills previously presented in a skill/sub-skill teaching cycle 300, an applied skills teaching cycle 400, a teaching cycle cluster 500, or the like. In this manner, the teaching system takes into consideration short-term and long-term knowledge of the skills presented. A reteach cycle 636 may be performed to re-teach any of the skills previously presented in which the assessment 632 and/or evaluation 634 indicated the student had a level of understanding below an acceptable level. The re-teach cycle 636 may re-present the skills in a same or different manner. Alternatively, the evaluation 634 may indicate that the student would benefit from additional practice on specific previously taught nondependent skills or dependent skills before advancement to teaching new rule-based skills that are dependent upon the ability to apply previously taught nondependent and dependent skills in application. An independent practice or practices may be presented, in isolation and/or application, with in situ re-teaches presented as necessary to facilitate additional learning. The independent practice may provide for practice of the skills in a same or different manner, may be multi-leveled and may present discriminations that are reflective of the student's identified learning weaknesses.

The dependent skills lesson teaching cycle 612 may begin with a pre-teaching inventory 650 to determine and record in the knowledge base prior knowledge of skills to be taught and applied within the current lesson. When a pre-teaching inventory 650 is given, results from the pre-teaching inventory 650 are used to determine initial routing into dependent skills lesson teaching cycle 612. When a pre-teaching inventory 650 is not given, however, each teaching cycle in the Dependent Skills Lesson Teaching Cycle is routed through in accordance with a predetermined sequence of skills, dynamically adjusted and reordered based upon student interactions, assessments, evaluations and the like.

One or more skill/sub-skill teaching cycles, applied skills teaching cycles, teaching cycle clusters, and the like may be used to form the dependent skills teaching cycle 652 to teach rule-based skills that generally have dependencies on the ability to apply skills that were previously taught within one or more nondependent skills lesson teaching cycles 610 and/or the current or previous dependent skills lesson teaching cycles 612.

Generally, it is preferred to use applied skills teaching cycle clusters to teach rule-based skills through a series of dependent skills lesson teaching cycles 612 that may span multiple unit teaching cycles. Generally, dependent skills lesson teaching cycles 612 become progressively more challenging within the current lesson and subsequent lessons and unit teaching cycles as new rule-based skills are added while continuing to build on applications of current and previous nondependent skills, dependent skills and applications of dependent skills.

A multi-level post-teaching inventory 654 may be performed to assess learning of one or more of the skills that were taught in the dependent skills teaching cycle 652. The results of the post-teaching inventory 654 are preferably added to the knowledge base to be used in evaluations. The results may include, for example, skills taught and assessed in isolation and in application, nondependent skills applied in rule-based dependent skills in isolation and in application, date-time stamps, forms of input, populations, discriminations made and scores and levels.

An evaluation 656 may also be performed for re-teach routing and notification purposes. The evaluation 656 may be based, for example, on scores and levels of common or related skills attained in an assessment (e.g., a post-teaching inventory), skill/sub-skill teaching cycle, applied skills teaching cycles, teaching cycle cluster reviews, or the like.

A re-teach cycle 658 may be performed to re-present any of the skills previously presented in which an assessment and/or evaluation indicated the student had a level of understanding below an acceptable level. The re-teach cycle 658 may re-present the skills in the same or different manner. In an embodiment, however, the re-teach cycle 658 is only performed a pre-determined number of times. For example, if a student repeatedly fails to achieve an acceptable level of understanding, the re-teach cycle will not be performed and the student will be allowed to proceed to a new skill, preventing the student from becoming discouraged and disinterested. The student may be re-presented with the skill not mastered at a later time. Following the re-teach cycle 658, a post-teaching inventory 660 is preferably repeated. The post-teaching inventory 660 preferably assesses the skills assessed in the post-teaching inventory 654 to update the knowledge base after the re-teach cycle 628.

For example, if a dependent cycle post-teaching inventory is provided, after its completion an evaluation of the knowledge base may occur and a re-teach cycle may be presented for any skill or skills that the evaluation indicated fell below an acceptable threshold. In addition to the results of the post-teaching inventory, the evaluation, which may be used for routing purposes for each skill, may factor for example, score or success rate on interactive activities included in the dependent teaching cycle clusters, scores or success rate on a pre-teaching inventory, level of difficulty of discriminations, the number of times that the skill has been presented and the like to calculate skill level for one or more skills.

For example, if a post-teaching inventory for rule based long vowel rule spelling patterns with a silent “e” at the end of a word (“a_e,” “o_e”, “i_e,” and “u_e”) is provided, after its completion the knowledge base would be evaluated first for level of performance on the post-teaching inventory. If performance on each vowel pattern evaluated met the required threshold level of understanding, the student may move forward in the sequence of lessons. If performance on one or more of the patterns did not meet this threshold, a second level of evaluation may occur. The second level of evaluation may identify vowel spelling pattern(s) that the student's level of understanding fell below an acceptable level. For each vowel spelling pattern, performance on activities included in the dependent teaching cycle may be evaluated and may include performance on a pre-teaching inventory and performance on independent practices in both isolation and application. A score would be calculated that will weight the most recent skill applications in context from long term memory more than in context interactions from short term memory and in isolation applications from short or long term memory. An example of an in context application of skill would be the student's identification of words in a book with the rule based vowel spelling pattern. For example, in an embodiment of the current provision, after a student has read a decodable reader, the student may be asked to find the words “gate,” “home,” “kite,” “June,” and the like in the book. If this calculation produces a score that falls below an acceptable level, a re-teach cycle may be presented or additional evaluations of the knowledge base may occur.

An additional evaluation of the knowledge base may be performed to determine a pattern of error for each vowel pattern that the student's knowledge has fallen below an acceptable level. Pattern of error in this instance would include an evaluation of the target words in interactive lessons not correctly identified by the student and if distracters/discriminations were used, the student's incorrect responses. Pattern of error would be the consistent misapplication of letter sounds, consonant blends, digraphs, diphthongs or other vowel patterns and the like. For example, for a given vowel pattern, a student may consistently answer questions on words that begin or end with a particular letter sound incorrectly, such as the “r” sound at the beginning of “rode” and “rope” or the “t” sound at the end of “late” and “gate.” Similarly, students may consistently answer questions on words that begin with a consonant blends incorrectly, such as “smile” and “slide.” This evaluation may use decodable word tags for the vowel pattern stored in the knowledge base, including CVCe, CCVCe and CCCVCe and the like where C is a consonant, V is vowel, e is the silent e and CC and CCC represent consonant blends. After a potential pattern of error is identified from target words in interactive lessons not correctly identified by the student, a second pattern of error evaluation would occur. This evaluation will analyze the student's incorrect choices and will serve two purposes. First to verify a pattern of error and second to analyze incorrect responses for new patterns of error. Decodable word tags may also be used for this analysis. For example, a student provided a group of words, “rode,” “red,” “cod” and “dress” and asked to identify the word “rode,” a choice of “red” would not be indicative of an error in identifying either the “r” or “d” sounds, but rather a problem in applying the long vowel “o” spelling pattern of “o_e.” However, if the student chose “cod” in this example and also chose “soap” instead of “rope” in the same activity, it would be indicative of a potential weakness in decoding with the letter “r.” A further analysis of incorrect responses may identify new patterns of error. For example, for the words “rope,” “pole,” and “note,” a student incorrectly chose “rain,” “pail,” and “nail,” could indicate a weakness with the rule based long a vowel pattern “ai.” After all knowledge base evaluations are complete, a re-teach would be presented that may be of a different kind, format or include new discriminations based upon identified patterns of error. In addition, re-teaches may be presented on either previously learned nondependent or dependent skills if the pattern of error so warrants. The type and level of reteach would be determined by the student's demonstrated cumulative skill knowledge.

Thereafter an assessment 664 and/or evaluation 666 be performed that takes into consideration the student's cumulative knowledge of previously presented skills and skill transference. The assessment 664 and the evaluation 666 takes into consideration skills presented in the current unit teaching cycle 600 and other skills previously presented in a skill/sub-skill teaching cycle 300, an applied skills teaching cycle 400, a teaching cycle cluster 500, or the like. In this manner, the teaching system takes into consideration short-term and long-term knowledge of the skills presented. A re-teach cycle 668 may be performed to re-teach any of the skills previously presented in which an assessment 664 and/or evaluation 666 indicated the student had a level of understanding below an acceptable level. The re-teach cycle 668 may re-present the skills in a same or different manner. Alternatively, an evaluation 668 may indicate that the student would benefit from additional practice on specific previously taught nondependent skills or dependent skills before advancement to teaching new nondependent skills that when applied with previously taught nondependent and dependent skills may further confuse or frustrate the child. An independent practice or practices may be presented, in isolation and/or application, with in situ re-teaches presented as necessary to facilitate additional learning. The independent practice may provide for practice of the skills in a same or different manner, may be multi-leveled and may present discriminations that are reflective of the student's identified learning weaknesses.

One or more unit teaching cycles are generally organized to form a subject matter teaching cycle. The subject matter teaching cycle uses a series of unit teaching cycles to progressively teach and build upon related topics of the domain based on a scope and sequence of skills as well as dependencies and applications of skills while progressively teaching new skills and their dependencies and their applications to develop subject mastery.

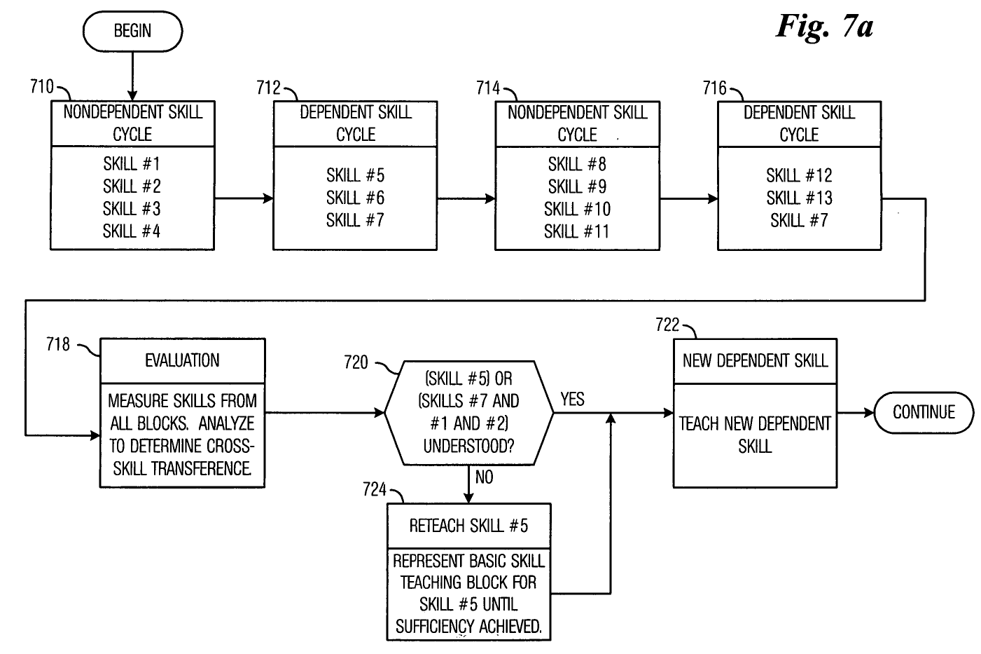

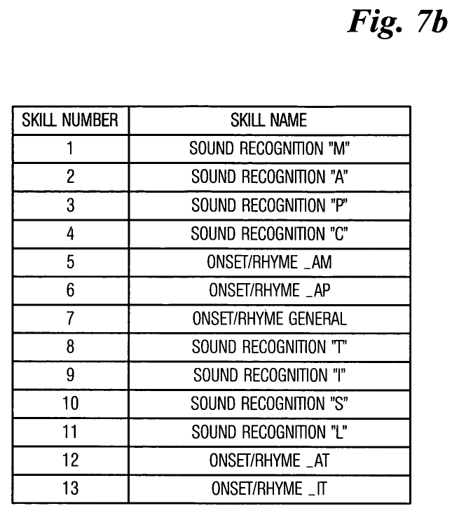

FIGS. 7a and 7b illustrate an example of skill transference in accordance with an embodiment of the present invention. It should be appreciated that embodiments of the present invention provides a method of assessing and evaluating skill transference. Generally, skill transference is the ability to learn one skill while or by learning another related skill(s) or concept(s). By providing a method of defining a subject matter into separate and identifiable skills and of identifying the interrelationships between those skills, embodiments of the present invention allows the transference of skills to be assessed and evaluated, thereby taking advantage of the various ways a student may learn specific skills. FIGS. 7a and 7b provide a further example of the skill transference.

In particular, FIG. 7a illustrates steps that may be performed including an assessment, and FIG. 7b illustrates examples of the skills corresponding to the steps illustrated in FIG. 7a. The process begins in step 710 of FIG. 7a, wherein a unit nondependent skill cycle is presented to the student. In the example illustrated in FIG. 7a, the nondependent skill cycle 710 teaches the concepts of skills #1-4. Examples of skills #1-4 include the sound recognition of the letters “M,” “A,” “P,” and “C,” respectively.

Similarly, unit dependent skill cycle 712 teaches onset/rime “_AM,” “_AP,” and general onset/rime concepts; nondependent skill cycle 714 teaches sound recognition of the letters “T,” “I,” “S,” and “L;” and dependent skill cycle 716 teaches onset/rime “_AT,” “_IT,” and general onset/rime concepts. Next, in step 718, an evaluation is performed to determine the student's understanding of each of the skills presented to the student.

It should be noted that the skills presented and method used to present the skills in each nondependent and dependent skill cycle may be altered based upon the knowledge base. As discussed above, as students interact with the teaching system (e.g., how the student performs during interactive practices and assessments for each of the skills) the knowledge base is updated. Thus, the knowledge base contains an indication of the students understanding of each of the presented skills. Furthermore, the knowledge base contains an indication of what new skills the student is likely to easily understand or have difficulty understanding. Thus, the knowledge base may be evaluated to further customize the teaching system for each particular student's needs and understanding level.

For example, the knowledge base may indicate that the student has a very good understanding of onset rime concepts. The knowledge base may also indicate that the student had a good understanding of the onset rime “_AT.” Based on this, the lessons may be modified to present the onset rime “IT” in an abbreviated manner so as not to bore the student, maintaining the student's interest and enhancing the student's learning experience. In this manner, it should be appreciated that each student's lessons are customized and that each student may be presented different lesson plans and each lesson plan may be presented in a different manner, thereby creating a highly integrated and customized teaching system.

In step 720, a determination is made whether or not the student has obtained a sufficient level of understanding of the dependent skills to proceed. In this example, the dependent skill is skill #5, namely the skill onset/rime of “_AM.” However, because of skill transference, skill #5 may be determined to be sufficiently understood if the student sufficiently understands skills #1, 2, and 7, i.e., sound recognition of “M,” sound recognition of “A,” and general onset/rime concepts where general onset/rime may include letter sounds learned in the current and prior units, respectively. Thus, if the evaluation indicates that the student does not sufficiently understand the skill #5, then the student may still be able to proceed to the new concepts if the evaluation indicated that the student understood skill #1, 2, and 7.

Furthermore, skills may be presented to the student using different letters or letter combinations. For example, scaffolding may be structured such that the letters “A” and “T” are presented and at some later time the letter “I” is presented. In this case, onset rime skills may be taught initially with the “_AT.” If the student does not completely comprehend the onset rime skills, the onset rime skills may be presented again later with the letter “I,” e.g., the onset rime “_IT.” In this manner, skills may be presented in multiple formats and helps reinforce the student's understanding of each concept.

Accordingly, if a determination is made in step 720 that the assessment indicated the student understood either skill #5 or the combination of skill #1, 2, and 7, then processing proceeds to step 722, wherein new skills and concepts are presented. Otherwise, processing proceeds to step 724, wherein the skills and concepts are re-presented to the student and another assessment is performed prior to continuing to new skills and concepts.

FIG. 8 illustrates information that may be recorded in the knowledge base in accordance with an embodiment of the present invention. Generally, it is preferred that activity-based information and interaction-based information be stored in the knowledge base and be available for evaluations. It should be noted that the fields illustrated in FIG. 8 are provided for illustrative purposes only. Additional or fewer fields may be used as required by any particular application. Furthermore, each field may comprise a combination of sub-fields.

Activity-based information refers to information related to the activities the student has performed and may include, for example, information such as a name of the activity field 810, a type of activity field 812, and a proficiency level of the activity field 814. For example, the type of the activity field 812 may include “teach,” “guided practice,” “independent practice,” or “assessment.” As discussed above, teach refers to the explicit explanation/instruction of a skill to the student and usually includes an introduction, statement of purpose, and limited modeling of the task. Guided practice is preferably an interactive follow-me activity in which the student is shown how to do a task and then asked to do a similar task. An independent practice refers to a practice session that the student may perform on his/her own, similar to a test or a quiz. An assessment may be any type of interactive activity designed for assessing the student's knowledge of a skill or group of skills. For example, an assessment may be a pre-teaching inventory, an independent practice, a review, a post-teaching inventory, or the like.

The proficiency level of the activity field 814 indicates the level of proficiency required for the student to complete the activity. This may be as simple as levels designated as easy, medium, or difficult assigned to an independent practice or other multi-level activity or levels assigned to books or any other descriptor that will indicate whether the student's interactions in the activity should be given less or more weight than others because the level of thinking required is greater or less based upon input given to the student.

For example, if the student is given extra input such as the target word or letter appearing on the screen in a bubble or some other capacity as a clue while the student is asked to identify that letter or word from a group of letters or words, the activity becomes a matching exercise. Even if the activity is not leveled, this makes the activity much easier than others, and information in the knowledge base will reflect this. On the other hand, if a student identifying the requested letter from a screen full of text without any assistance, the activity may be considered a medium or difficult level and will be reflected in the knowledge base accordingly.

Another example is the use of decodable skill books having different skill levels. A level “A” book may be a single-skill reader that provides practice for a single skill; a level “B” book may be an easy mixed-skill reader that provides practice for at least 2 skills; a level “C” book may be a medium mixed-skill reader that provides practice for all skills in a unit or group of skills; and a level “D” book may be a challenging mixed-skill reader that provides practice on cumulative skills. Each of these type of books can be further categorized as to level of difficulty based upon factors such as number of words in the book, number of times words are repeated, number of singletons, number of high-frequency words or sight words, etc. An A.1 book may be easier than an A.2 book.

Interaction-based information may include a nature of interaction field 816, a primary skill field 818, a secondary skill field 820, student interaction fields 822, and a skill tag field 824. The nature of interaction field 816 may indicate whether or not the interaction is in isolation, in context or from pre-knowledge. Pre-knowledge may be used in pre-teaching inventories when a student has never been in the program before or was not exposed to the instruction on the specific skill in the prior year.

The nature of interaction field 816 may also indicate whether or not the interaction is based upon short-term or long-term knowledge. As discussed above, date-time stamps (not shown) may be collected in each activity and for each interaction, and may include information such as when the activity began, when a question was asked, when the student responded/answered, when a in situ re-teaches, in situ teaches, reinforcements, and in situ exposures were provided, when a question was re-asked (after an initial incorrect response), when the question was re-answered, when the activity was completed, and the like.

The primary skill field 818 identifies the primary skill being assessed at any given point. For example, in an embodiment in which the present invention is used to teach reading the primary skill may include six major categories: book and print awareness, phonemic awareness, phonics, vocabulary, comprehension, and fluency. Book and print awareness may include parts of a book (title, author illustrator, table of contents, etc.), capitalization and punctuation, directionality, letter/word discrimination, and the like. Phonemic awareness may include initial sound, medial sound, final sound, and rhyming. This information may be stored by letter of the alphabet and by word family. Phonics may include letter identification (capital letter identification and lowercase letter identification), sound/symbol correspondence, and decoding (short vowels, long vowels, 2 vowels go walking and silent e rules, “1” controlled vowels, “r” controlled vowels, diagraphs, consonant blends, variant vowels, etc.). This information may be stored by a letter of the alphabet, by a vowel, by a consonant blend, by a diagraph, and the like and how it will be stored will be based upon what is being taught at the time.

The vocabulary category may include word identification (High frequency words), compound words, multi-syllable words, prefix, suffix, roots, antonyms, homonyms, synonyms, and the like. This information may be stored by word, by type of prefix, by type of suffix, by type of root, etc. The comprehension category includes listening comprehension and reading comprehension, which may be further broken down into specific comprehension skills (character and setting, factual recall, summarization, cause/effect, problem/solution, inference, etc.). The fluency category may include rapid-letter naming, rapid-word naming, rapid-text reading, and the like. For rapid-letter naming and word naming, this information may be stored by letter and word name.

The secondary skill field 820 may include any secondary skill being taught, practiced or assessed. The categories may be similar to those discussed above with reference to the primary skill field 818.

The student interactions field 822 comprises a record of the student's interactions with the teaching system and may include, for example, the question asked, the word, letter, or object the student clicked on, whether the initial response to the question was correct or incorrect, what populations or discriminations were associated with the question asked, any additional instruction provided to the student as a result of a correct or incorrect answer, the skill or skills being assessed, whether the skill was assessed in isolation or in application, whether the skill being assessed was from short-term or long-term memory as determined by date and time stamps, whether the skill may be further categorized, and the like. The additional instruction may include, for example, whether an in situ re-teach, an in situ teach, and in situ exposure, or reinforcement were given.

The skill tag field 824 is a tag associated with the skill or concept that was presented. For example, words may be tagged to indicate which dependent skills are required. A tag may be represented as CVC, CVVC, CVCe, CCVC, CCCVC, CCVVC, CCVVCC, CCVCe, CCCVCe and the like where C is consonant, V is vowel, e is a silent e, and CC and CCC represent consonants that can be blended letter to letter. Additional word tags may be used for digraphs, diphthongs, variant vowels and the like.

Information recorded in the knowledge base may be evaluated and used in routing and notifications at any point in which dynamic routing or notification is desirable such as after completion of an assessment, review, post teaching inventory, a teaching cycle cluster, a nondependent skill teaching cycle, a dependent skill teaching cycle, a unit teaching cycle and the like. These evaluations may include one or more previously presented skills. At any point that an evaluation of the knowledge base indicates that skill levels are below acceptable levels, electronic notification of areas of weakness including individual and/or small group lesson recommendations may be sent. Individual and small group instruction recommendations, such as suggested lesson plans and lessons correlated to the specific weaknesses exhibited through interactions with various teaching cycles, may also be sent. Individual instruction recommendations may be made (rather than small group instruction recommendations) when the system is unable to correlate similar weakness across more than one individuals' knowledge base evaluation.

Preferably, the evaluation of the knowledge base determines a weighted value in which weightings are greatest for assessment results that require the successful application of nondependent skills and dependent rule-based skills in applications using long-term memory, followed by assessments of nondependent and dependent skills using short-term memory, followed by assessments of nondependent and dependent skills in isolation from long-term memory, followed by assessments of nondependent and dependent skills in isolation from short-term memory. In general, more difficult and recent discriminations of nondependent skills and applications of nondependent skills in dependent skills are weighted more heavily than earlier assessments, easier discriminations, and skills in isolation.

Isolation refers to the ability of a student to understand a concept when presented with the concept by itself, and application refers to the ability of a student to apply a concept when presented in context. For example, if the concept involved is the ability to blend CVC words with the rule based vowel spelling pattern of long a, spelled as ai, then in isolation the student may be presented with words containing previously learned nondependent skills (identified as C's) and the rule based vowel spelling pattern for ai (identified as V). An application assessment may present these same type words in sentences or phrases.

Short-term refers to the ability of the student to recall and understand the concepts presented in the most recent concept-teaching activity, and long-term refers to the ability of the student to recall and understand the concepts presented in previous concept-teaching activities. To determine whether an activity, e.g., independent practice or other assessment, results reflect short-term or long-term memory, date-time stamps may be used to calculate the elapsed time between teaching, practicing, and/or re-teaching of skills and assessments of the those skills.

In an embodiment of the present invention, each combination (long-term/isolation, long-term/application, short-term/isolation, and short-term/application) is assessed and a measured value is determined. A total assessment value may be calculated by determining a weighted average of the combinations of assessments. Because application and long-term are considered more important, the total assessment may be calculated as a weighted value in which the long-term values are weighted heavier than the short-term values and application values are weighted heavier than isolation values. These values may be used to determine which concepts are to be presented, or re-presented, to the student next.

Because, in general, the initial skill independent practice date-time stamps would be close to their teaches and guided practices, the independent practice results would be determined to reflect short-term memory. The same would likely hold true for each of the skills in each of the initial teaching cycles because the initial teaching, guided practice, independent practice, and re-teach cycles for each of those rules, skills, and sub skills would generally occur close together as determined using date time stamps. Nonetheless, skills may be classified as being assessed from long-term memory should the elapsed time between the assessment of a skill and a teach or re-teach of the skill be of sufficient duration as determined using date time stamps.

In general, evaluations that take into consideration multiple assessments of related and/or common skills are better gauges of learning and skill level by reducing the impact of any given assessment, particularly outliers from inattention that may not reflect actual skill level. In addition, evaluations that take into consideration multiple assessments of related and/or common skills help show if progress is being made learning those types of skills and sub skills.

As a result, initial evaluations will more frequently involve skills classified as being from short-term memory. As the student progresses through the scope and sequence, however, the assessments and evaluations will begin to measure long-term memory. For example, reviews and post-teaching inventories will generally involve long-term memory because reviews and post-teaching inventories may assess skills taught over a period of time and the likelihood that some of those skills will not have been taught for days or even weeks.

Whether the skill being assessed was from short-term or long-term knowledge indicates whether the student's knowledge was being tested from short-term memory or long-term memory. Whether or not the student's interactions were short term or long term may be effected by how long it has been since the student was last exposed to the skill via a teach, guided practice, in situ teach, in situ re-teach, or the like. For example, if a teach occurred in the last four days or a guided practice occurred in the last four days, or an in situ teach or re-teach occurred in the last eight hours, the interaction may be deemed short term.

As another example, if a student answers a question incorrectly and receives an in situ re-teach, from that point forward in the activity all responses to questions on the same skill could be considered short term and all responses on the same skill to questions in other activities for a period of time (e.g., 8 hours) could be considered short term as well. Prior responses to questions on the same skill and activity (prior to the in situ re-teach) may be scored as long term if enough time has elapsed since a teach or guided practice on the particular skill.

At each assessment and/or evaluation point in the scope and sequence, algorithms may calculate a pattern of knowledge and trends that are developing within a calculated degree of confidence for each student. Based on the patterns, decisions may be dynamically made to determine whether or not the student should be presented with the next activity in the scope and sequence, how the next lesson should be presented, what type of intervention or re-teach is required, and the like. One way that has been found useful to determine these patterns is to use a series of weighting factors for different areas. In this manner, customized lessons may be created dynamically based on each individual student's needs at any particular point in time.

In determining whether a student should be presented with an activity, how the activity should be presented or whether the student should receive additional practice or instruction in the activity, the student's interactions related to certain skills will be weighted. The factors effecting weighting may include the grade level of the student, type of interaction, short-term or long-term application of skills, when the interactions occurred, the type of activity, the difficulty of activity, and patterns. Regarding the grade level of the student, a student in first grade may be expected to have a higher level of understanding of nondependent and dependent skills than a student in kindergarten and a higher weight may be put on knowledge of nondependent skills from long-term memory in isolation. Regarding the type of interaction, it is preferred that skills in application and application in context are weighted more heavily than skills in isolation.

Furthermore, long-term application of skills in context is preferably weighted more heavily than short-term applications in context or isolation. Short-term and long-term applications may be determined based upon date-time stamps and the last occurrence a teach, guided practice, in situ teach, or in situ re-teach has been performed on the skill being assessed. For example, in its simplest form, in a situation in which a student achieved an average score of all short term in isolation applications of skill of 50% (from initial experience), an average score of all long term in isolation applications of skill of 70%, an average score of all short term in context applications of skill of 70%, an average score of all long term in context applications of skill of 80%, and weighting factors of 40% for long term in application, 25% for short term in application, 20% for short term in isolation, and 15% for short term in isolation, then the resulting score would be 72%. If the minimum level of achievement was 70%, no additional instruction would be provided.

When the interactions occurred may also be a factor in the weighting. For example, an average of the more recent interactions may be weighted heavier. If a student has demonstrated difficulty with a skill in context previously using long-term knowledge, but has just recently shown the ability to apply the skill in context with long-term knowledge, no additional instruction may be provided. This recognizes that a student's understanding progresses as they move through the program and that assessments performed long ago may not reflect current knowledge. For example, in its simplest form, if a student achieved an average score of all interactions in long-term application of a skill of 50%, an average score of the five most recent long-term applications of the skill of 85%, a weighting factor of 75% for the most recent and 25% to all interactions results in a weighted score of 76.25%. If the minimum level of achievement for this skill was 70%, no additional instruction would be provided.

Similarly, success in later units of instruction may be weighted more heavily than in earlier units where student are asked to apply a broad range of knowledge of nondependent skills to increasingly complex dependent skills. For example, assume records indicated the following interactions occurred:

1. Cat, a correct answer in Unit 2 to a short vowel a decoding question in a post-teaching inventory.

2. Cute, a correct answer in Unit 6 to a long vowel u decoding questions in a post-teaching inventory.

In this case, knowledge of letter c and t sound symbol correspondence may be weighted more heavily from answering cute correctly than cat.

Another factor in weighting may be the activity itself. Weighting can be applied by activity types such as independent practice, reviews, post-teaching inventories, or the like. Generally, assessment activities that are more difficult and require higher-order thinking will be weighted more heavily. Discriminations in reviews typically have a higher degree of difficulty than independent practices. Post-teaching inventories may be considered more difficult than reviews because like skills for a group of letters rather than a single letter are assessed.

For example, in its simplest form, if a student achieved a score on an uppercase “M” letter identification activity in an independent practice considered from short term in isolation of 80%, score on uppercase “M” letter identification activity in a review considered from short term in isolation of 60%, and weighting factors of 60% and 40%, respectively, then a weighted score of 68% is attained. If a minimum score was 70%, additional instruction would be provided.

Another factor that may be used in weighting is the difficulty of the activity. Weighting can be applied based upon the required level of thinking by a student to complete the activity. Difficulty can be based upon discriminations or the difficulty of completing the task (such as reading a book).

For example, in its simplest form, if a student achieved a score of 100% on an easy-level independent practice of a letter in initial sound phonemic awareness activity, a score of 80% on a mid-level independent practice of a letter in initial sound phonemic awareness activity, a score of 42% on a difficult-level independent practice of a letter in initial sound phonemic awareness activity, and weighting factors of 25%, 35%, and 40% are used, respectively, then a weighted score of 70% would be attained.

As another example, assume a student achieved a score of 100% on a level A.1 book having a weighting factor of 15%, a score of 67% on a level B.1 book having a weighting factor of 22%, a score of 67% on a level C.1 book having a weighting factor of 28%, and a score of 33% on a level A.1 book having a weighting factor of 35%, then the result is a weighted score of 61%.

Another factor that may be used is patterns, such as outliers and patterns of knowledge of similar or related skills across multiple activities and/or units, and the like. Outliers are responses or values outside an expected range of values. For example, if a student consistently achieves high marks, but for one reason or another scores low on one activity, it may be desirable to remove or reduce the weight of the one low score. One method of achieving this is to apply weightings to student responses using any, all, or a combination of the above factors to calculate a range of expected scores as the student moves through the program within calculated confidence levels. If the confidence level is very low (e.g., scores are up and down with no pattern over time), there may be no outliers. If there is a reasonable level of confidence that the student should score within a calculated range, any scores outside of that range may be excluded.

Similar skills/multiple activities patterns look for patterns over like skills in multiple activities and/or units. This may be performed similar to the outliers, except that the process may be repeated for a group of similar skills. Examples of similar skills are sound symbol correspondence for all letters of the alphabet, all short vowels, all long vowels with the silent e rule. If the range of expected scores across a group of similar skills meets or falls within an acceptable range of scores and the pattern indicates that the expected scores are improving as the student progresses through the program, no additional instruction may be provided on the skills and the student will be allowed to move on to higher-order dependent skills. Similarly, based upon prior performance an expected range of scores may be calculated for letter sound symbol correspondence. If the student starts to experience some difficulty with this skill on one letter, it should not move the score out of its expected range. If the student continues to show difficulty, the scores will fall out of the expected range and reflect a decreasing level of knowledge of a critical nondependent skill. The student may not be allowed to continue until they can show improvement in this skill. Further analysis may be performed to determine for which letters additional instruction might be provided. It is preferred that a student not be allowed to move forward to new dependent skills without additional instruction or practice on nondependent skills that may limit their ability to apply previously taught or new dependent skills.

The above weightings may be used to determine if a student should move forward in the curriculum. For example, after the first nondependent skill teaching cycle, trends and scores related to sound symbol correspondence may be evaluated, a key skill in the student's ability to decode words. If the scores fall within an acceptable predetermined range and confidence level, the student may move forward to word play activities where they will be exposed to dependent skills.

After a second letter nondependent skill teaching cycle, trends and scores related to sound symbol correspondence across both the current and the previous nondependent skill teaching cycle may be examined. If the scores continue to fall within a predetermined range and confidence level, the student may be able to move forward. If an upward trend is emerging, but the student's scores do not fall within the predetermined range, they may be able to proceed. Subsequent evaluations will identify changes in the trend that might warrant a re-teach. Similarly, if a downward trend is emerging but the student's scores fall within the predetermined range, they may be able to proceed. Again, subsequent evaluations will identify a continued downward that may result in a re-teach.

Another example involves short vowels. After completion of a dependent skill teaching cycle that may include applied teaching cycles for both short “a” and short “i” vowel patterns, trends for both short “a” and short “i” decoding skills may be evaluated. The range of acceptable scores may be slightly lower if this is the first dependent skill to which the student has been exposed. After completion of another applied teaching cycle that may include the short “o” vowel pattern, cumulative trends for short “a,” short “i,” and short “o” decoding skills may be evaluated. If the scores do not fall within an acceptable range or do not show an upward trend, the student may not be allowed to move on without a reteach of previously presented skills. A notification of the child's progress may be sent to the teacher, principal and/or parent.

As discussed above, the weightings may also be used to determine lesson order. For example, if a student's pattern of responses indicates that they are having difficulty with a skill, the order of presentation of activities may be modified. Typically, the medium level of an independent practice will be presented first. If a student is struggling with a concept, the easy level may be presented first.

As another example, if a student's pattern of responses indicates that they are having difficulty reading decodable skill readers by themselves, additional help will be provided to the student. The student preferably has the ability to click on words to hear them sounded out and possibly hear the entire page read out loud to them.

As another example, if a student's pattern of understanding indicates that an intervention or some type of re-teach is required, the type of re-teach presented may vary based upon the student's demonstrated cumulative knowledge and predetermined ranges of scores. Assuming a minimum score of 70, an actual score of 68 may invoke a re-teach considered as a refresher. On the other hand, an actual score of 50 may invoke a more in-depth re-teach that may include a teach and independent practice with minimum levels of proficiency required before advancement. If an actual score of 40 is obtained, then a yet more in-depth re-teach cycle with a teach, guided practice, and multi-leveled independent practice may be presented. Minimum levels of proficiency may be required before advancement.

The weightings may also determine if an intervention of a re-teach should occur. These decisions can be as simple as applying the weighting factors to a single independent practice or as complex as analyzing a common skill across multiple units. As the student progresses through the program, evaluations and assessments predict with a reasonable degree of confidence that student has demonstrated mastery of the skills necessary to become fluent readers.

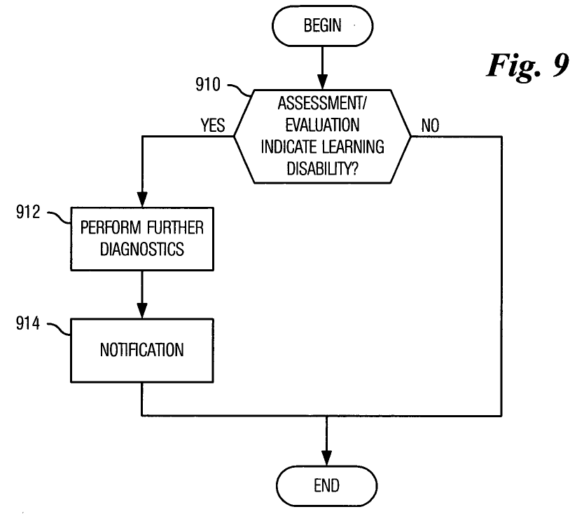

FIG. 9 is a data flow diagram of a process that may be used to provide a disability diagnostic in accordance with an embodiment of the present invention. A learning disability diagnostic may be performed after any assessment, evaluation, teach, guided practice, independent practice, or other interaction that indicates a learning disability may exist. The process begins in step 910 in which a determination is made whether or not an assessment and/or evaluation indicated that a learning disability may exist. The assessment and/or evaluation may indicate a learning disability if, for example, when one or more skills are evaluated below specified levels or a pattern of error is indicative of a disability. For example, continued poor performance in phonemic awareness activities where the child practices isolating a letter sound at the beginning, middle or end of a word.

In this situation, the process proceeds to step 912 wherein a learning disability diagnostic may be presented to attempt to diagnose potential learning disabilities from patterns of error inherent in interactions with the learning disability diagnostic and/or teaching cycles. The learning disability diagnostic may be, for example, one or more sets of specifically designed interactive assessments in which specific patterns are evaluated for known disabilities. For example, for a child whose patterns of error indicate dyslexia, a series of practice activities in initial and final consonant substitution, vowel substitution and phoneme segmentation and rapid word naming would be provided to diagnose the disability. These activities may provide for practice of the skills in a same or different manner, may be multi-leveled and may present discriminations that are reflective of the student's identified learning weakness.

Electronic notification of areas of weakness, the results of any assessment or disability diagnostic including a recommend plan of action such as lesson plan or individualized instruction, and the like may be provided to teachers and/or principals and/or parents, as indicated by step 914.

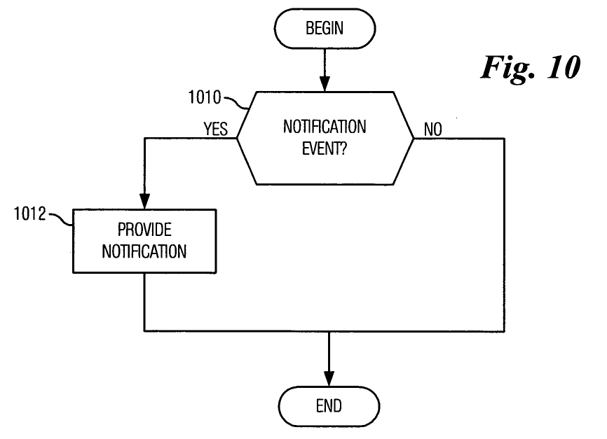

FIG. 10 is a data flow diagram of a notification procedure that may be used to provide notifications in accordance with an embodiment of the present invention. The notification procedure may be performed after any assessment, evaluation, teach, guided practice, independent practice, or any other interaction that may indicate a notification of an event or a situation is desirable. For example, in a preferred embodiment, assessment data about each student in the knowledge base is periodically evaluated to identify a student or group of students having difficulties with common, similar, and/or related skills or concepts (and/or interrelationships between skills), then sending a notification to the appropriate personnel (e.g., teachers, administrators, and parents). Similarly, notifications may also be sent to appropriate personnel related to a student or group of students that have mastered common, similar and/or related skills or concepts.

The process begins in step 1010 in which a determination is made whether or not a notification event exists. As discussed above, the notification event may be any event in which it is desirable that a person or group be notified. Examples of notification events include detection of areas of difficulties for a student, detection of areas of difficulties for a group of students, detection of lack of progress or use by a student or group of students, detection of students that have mastered skills and need new more challenging activities so that they can move forward at a faster pace and the like. Notifications may also be sent periodically to report, for example, progress of a student or a group of students.

If a notification event exists, then processing proceeds to step 1012 wherein a notification stating recommendations or information is sent to the appropriate personnel. For example, the notification may include recommended lesson plans and lessons, such as specific small group or individual activities, online books, lesson plans, lessons, online lessons, books, lesson plans and/or lessons in third party reference materials or educational textbooks, or the like, progress of a student or group of students, or the like. Further, for students that are progressing at a rapid pace through the program, additional lessons that will challenge them and help them to move forward faster may be provided. The notification may be sent, for example, via email, web site postings, facsimile, other electronic means, or the like.

Another feature of the present invention is the ability to provide detailed reports of each student's progress and understanding of each skill. By recording interactions in the knowledge base, reports may be created that identifies each of the skills presented to a student and the student's level of understanding of each of those skills. In a preferred embodiment, the information is presented in an electronic format that allows a teacher or another authorized individual to “drill down” from a high level to a detailed level.

For example, a report may be generated that provides a high level view of the student's understanding of the skills presented in each of several units. If desired the teacher may click or otherwise designate a specific skill for which detailed information is desired. As a result, a report providing the results of the nondependent and dependent skills lesson teaching cycle is provided. The process may be repeated until the interactions regarding each individual skill is provided. A preferred method of providing such a report is via an interactive web page.

Reports may also be provided that provide a high level view of progress through the scope and sequence. If desired the teacher may click or otherwise designate a specific unit of instruction and “drill down” to the students individual interactions in those activities.

It should be appreciated that such a teaching and reporting system provides teachers and administrators visibility into each student's understanding of specific skills, such as phonemic awareness, phonics rules, and the like. Teachers may use this information to provide assistance to students in those specific areas in which students require additional teaching. This system also allows teachers to effectively track the progress of each student.

The following discussion provides an example of an embodiment of the present invention in which a computer or computer network-based interactive education application teaches students to read in English while assisting students with a limited vocabulary, and/or English language learners with English language acquisition by following a specific scope and sequence. In this case, the “scope” is teaching students to read and assisting with English language acquisition, and the “sequence” is a scaffolding of interrelated skills controlled by routing logic and a set of predetermined rules that together with a student's interaction with the interrelated teaching of skills, concept explanations, guided practices, independent practices, assessments, and resulting detailed data including among others skills taught, practiced and assessed, difficulty level, populations and questions presented, discriminations made, date time stamps, scores and correct and incorrect responses, and collective assessment data contained in the knowledge base, results in students learning to read in English while improving their ability to use the English language.

The sequence of skills that this illustrative example uses is based on introducing students to the alphabet and the attributes of individual letters. After students have been introduced to each of the letters in the alphabet, students are taught and their learning assessed in blocks of four-letters in nondependent skills such as letter recognition, sound symbol correspondence, phonemic awareness and capital and lowercase recognition among others. Those letters are then used in wordplay lessons to teach and assess the student's ability to apply those letter skills to broader rule-based dependent skills, such as decoding skills (e.g., blending, phonics, onset and rime, short and long vowels, letter to letter blending, blends, consonant clusters, diphthongs, digraphs, variant vowels or the like) and spelling patterns and to new applications of previously taught letters and skills. Wordplay lessons may also teach and assess high frequency word recognition, book and print awareness, vocabulary and explicit and implicit oral and reading comprehension among other things.

In an embodiment, a sequence of skills is divided into a series of Units are used that incorporate letters grouped into four-letter blocks called Nondependent Skills Lesson Teaching Cycles that teach and assess nondependent skills using Skill/Sub Skill Teaching Cycles and Teaching Cycle Clusters followed by wordplay lessons called Dependent Skills Lesson Teaching Cycles that require the nondependent skills previously taught to be applied in dependent rule-based skills using Skill/Sub skill Teaching Cycles, Applied Skills Teaching Cycles and Teaching Cycle Clusters.

For each letter in a four-letter block, nondependent skills such as letter recognition, sounds that the letters make, the ability to segment or identify the sound the letter makes at the beginning of words and capital and lowercase discrimination of the letters are taught and assessed. Other skills, such as how to print the letter on lined paper, type the letter on a keyboard, meaning of vocabulary words beginning with and/or using the target letters, or the like, may be taught and assessed.

After a four-letter block has been taught, those letters and vocabulary using those letters and previously taught letters are used in wordplay lessons that teach and assess progress in learning to apply those and previously taught nondependent letter skills and vocabulary in wordplay lessons using rule-based dependent skills such as decoding skills initially in isolation then in context such as reading connected text. Other skills taught in wordplay lessons include book and print awareness, high frequency words, and explicit and implicit oral and written comprehension among others.

A Unit One Nondependent Skills Lesson Teaching Cycle four-letter block comprising the letters “M,” “A,” “P,” and “C,” may be taught by beginning teaching the letter “M.” As students interact with the concept explanations, guided practices, independent practices, and assessments for the letter “M,” the system uses its predetermined rules and routing logic to develop a knowledge base for each student. The knowledge base for the letter “M” may include data for each time the letter was taught or re-taught, practiced or assessed including a level of discrimination ability in letter “M” recognition, sound “M” recognition, capital “M” and lowercase “M” recognition, vocabulary that begins with the letter “M,” and the like.

For each of the skills for the letter “M,” multiple levels of interactive concept and/or skill explanations, guided practices, independent practices, and assessments are presented and detailed records for each stored in the knowledge base. Specific level data such as difficulty, populations presented, discriminations made, date time stamps, scores and correct and incorrect responses for each student are also stored in the knowledge base under the control of predetermined rules and routing logic that ensure each skill is taught, assessed, and learned in a basic form before being made progressively more difficult through leveling and/or new interactive lessons to simplify and enhance the learning process.

After the letter “M” skills have been taught, practiced and progress learning those skills has been assessed and detailed data stored in the knowledge base under the control of the rules and routing logic, the letter “A” is introduced following a similar sequence as the letter “M.” In this illustrative example, the letter “A” may be introduced even if there may still be significant gaps in skill knowledge of the letter “M” as evidenced by a student's performance in the multiple levels of concept and/or skill explanations, guided practices, independent practices, and assessments for the letter “M.” This is done because in an embodiment of the invention, knowledge of how humans learn is factored into the design of the interrelated concept and/or skill explanations, guided practices, independent practices and assessments, and in this particular instance, skill transference. Skill transference is when learning takes place across multiple related skills. In this case, learning how the letter “M” looks or sounds is facilitated by learning that the letter “A,” or, for that matter, the letters “P” and “C” all have conceptually similar attributes including a capital letter form, a lowercase letter form, words that begin with or incorporate that letter, and sounds created by that letter that can be identified at the beginning of words and within words.

After a student has been through the Unit One Nondependent Skills Lesson Teaching Cycle “M,” “A,” “P,” and “C” four-letter block under the control of the rules, routing logic and assessments, their knowledge of each of the skills taught in the block is contained in their knowledge base as reflected by their experience and performance in the multiple levels of concept and/or skill explanations, guided practices, independent practices and assessments of the “M,” “A,” “P,” and “C” four-letter block.

Once the student has been through the Unit One Nondependent Skills Lesson Teaching Cycle “M,” “A,” “P,” and “C” four-letter block, the knowledge base is evaluated to ensure a predetermined level of skill knowledge has been attained before advancing on to the Unit One Dependent Skills Lesson Teaching Cycle. The evaluation may be based on predetermined rules regarding individual skill assessments, related skill assessments, and/or collective skill assessments and is used in conjunction with predetermined routing logic to re-present material in the “M,” “A,” “P,” and “C” four-letter block. In addition, the evaluation may result in a Learning Disability Diagnostic being presented to one or more students to attempt to determine if a learning disability such as dyslexia may be affecting performance. The evaluations may also result in electronic notification of problem areas including results from a Learning Disability Diagnostic, if any, and specific recommendations for individual and small group instruction for individual students and groups of students that may be experiencing problems. Following the re-presentation of material from the Unit One Nondependent Skills Lesson Teaching Cycle “M,” “A,” “P,” and “C” four-letter block based on the evaluation, a new evaluation of the knowledge base may be performed.

In this illustrative example, the student is subsequently advanced to the Unit One Dependent Skills Lesson Teaching Cycle wordplay associated with the Unit One Nondependent Skills Lesson Teaching Cycle “M,” “A,” “P,” and “C” four-letter block even if there may still be significant gaps in skill knowledge of the “M,” “A,” “P,” and “C” four-letter block as evidenced by the last evaluation of the student's performance in the multiple levels of concept and/or skill explanations, guided practices, independent practices and assessments for the “M,” “A,” “P,” and “C” four-letter block. After the Nondependent Skills Lesson Teaching Cycle has been routed through, a Dependent Skills Lesson Teaching Cycle may then be performed using wordplay to teach the integration and application of the various skills taught in the four-letter block. Dependent Skills Lesson Teaching Cycles may be presented using one or more Skill/Sub Skill Teaching Cycles, Applied Skills Teaching Cycles or Teaching Cycle Clusters.

In this manner, the knowledge of how humans learn is factored into the design of the interrelated concept and/or skill explanations, guided practices, independent practices and assessments, and in this particular instance, mapping of skills into multiple paths in the brain. For example, in the “M,” “A,” “P,” and “C” wordplay lessons, the letters “M,” “A,” “P,” and “C” the student has recently been taught and now has some prior knowledge of are used in decodable words, high frequency words and vocabulary words, strengthening the understanding of the need for letter knowledge, as well as providing additional practice using letter knowledge, thereby increasing the likelihood the student will master letter knowledge and reading skills that make use of letter knowledge.

As skills in “M,” “A,” “P,” and “C” wordplay that require letter knowledge are introduced, practiced and assessed, the knowledge base is updated with detailed data to reflect skills taught, practiced and assessed including demonstrated letter knowledge and the current ability to use that letter knowledge in isolation from short-term memory and/or long-term memory as well as the ability to apply that letter knowledge including onset rime and letter to letter blending to read words using “M,” “A,” “P,” and “C”.

In the preferred embodiment, the “M,” “A,” “P,” and “C” wordplay teaches and assesses letter to letter blending, onset rime, book and print awareness, high frequency words, and explicit and implicit oral comprehension. One example of incorporating wordplay may be to incorporate user-made books to provide narrated read-aloud opportunities and to teach vocabulary. Decodable books using the letters “M,” “A,” “P,” and “C” may also be used to provide the initial scaffolding for decodable books that may be presented in later letter blocks and associated wordplays using multiple levels of interactive concept and/or skill explanations, guided practices, independent practices and assessments. Detailed teaching, practice and assessment records from the word plays are stored for each student in the knowledge base.

Once the student has been through Unit One including the “M,” “A,” “P,” and “C” four-letter block and associated wordplay, the knowledge base is evaluated to ensure a predetermined level of skill knowledge has been attained before advancing on to Unit Two. The evaluation may be based on predetermined rules regarding individual skill assessments, related skill assessments, and/or collective skill assessments and is used in conjunction with predetermined routing logic to re-present material in the “M,” “A,” “P,” and “C” four-letter block and its associated wordplay. In addition, the evaluation may result in a Learning Disability Diagnostic being presented to one or more students to attempt to determine if a learning disability such as dyslexia may be affecting performance. The evaluations may also result in electronic notification of problem areas including results from a Learning Disability Diagnostic, if any, and specific recommendations for individual and small group instruction for individual students and groups of students that may be experiencing problems. Following the re-presentation of material from Unit One based on the evaluation, a new evaluation of the knowledge base may be performed.

In this illustrative example, the system proceeds to Unit Two even if there may still be some gaps in skill knowledge of Unit One's “M,” “A,” “P,” and “C” four-letter block and associated wordplay as evidenced by the last evaluation. This is preferred because how humans learn is factored into the design of the interrelated concept and/or skill explanations, guided practices, independent practices, and assessments. For example in the Unit Two four letter block, students will learn new letters and their associated letter skills facilitating skill transference. In addition, the letters “M,” “A,” “P,” and “C” may be re-taught using Evaluation Aware Re-Teaching Assessments. Further, in Unit Two's wordplay lessons, the letters “M,” “A,” “P,” and “C” are used in decodable words that utilize the same skills as were taught in the “M,” “A,” “P,” and “C” wordplay. In this manner, decoding skills using knowledge from Unit One such as onset and rime and letter to letter blending and the like, continue to be practiced increasing the likelihood skill transference will take place and the student will master Unit One letter knowledge and reading skills. As skills that require prior letter knowledge are introduced, practiced, and assessed, the knowledge base is updated with detailed data to reflect skills taught, practiced and assessed including current letter knowledge and the ability to use letter knowledge in isolation as well as the ability to apply letter knowledge to the process of reading, such as the ability to use decoding skills, recognize high frequency and vocabulary words, and the like.

Following the second Unit One evaluation, the student proceeds to Unit Two's letter block, e.g., a four-letter block comprising “T,” “I,” “S,” and “L.” The process teaching and assessing concepts presented in the second letter block may be performed similarly to the first letter block, but may contain fewer or additional types of concepts and/or skill explanations, guided practices, independent practices, and assessments specific to the skills and concepts of the second letter block. In addition, the process may include teaching and assessing letter knowledge of the letters “M,” “A,” “P,” and “C,” in isolation from short-term and/or long-term memory using Evaluation Aware Re-Teaching Assessments to ensure those letter skills are mastered.

Once the student has been through the entire “T,” “I,” “S,” and “L” four-letter block under the control of the rules and routing logic, their experience learning and knowledge of each of the skills taught or re-taught in the “T,” “I,” “S,” and “L” four-letter block has been added to their knowledge base as reflected by their experience and performance in the multiple levels of concept and/or skill explanations, guided practices, independent practices, and assessments of the “T,” “I,” “S,” and “L” four-letter block.

Once the student has been through the Unit Two Nondependent Skills Lesson Teaching Cycle “T,” “I,” “S,” and “L” four-letter block, the knowledge base is evaluated to ensure a predetermined level of skill knowledge has been attained before advancing on to the Unit Two Dependent Skills Lesson Teaching Cycle. The evaluation may be based on predetermined rules regarding individual skill assessments, related skill assessments, and/or collective skill assessments and is used in conjunction with predetermined routing logic to re-present material in the “T,” “I,” “S,” and “L” four-letter block. In addition, the evaluation may result in a Learning Disability Diagnostic being presented to one or more students to attempt to determine if a learning disability such as dyslexia may be affecting performance. The evaluations may also result in electronic notification of problem areas including results from a Learning Disability Diagnostic, if any, and specific recommendations for individual and small group instruction for individual students and groups of students that may be experiencing problems. Following the re-presentation of material following the Unit Two Nondependent Skills Lesson Teaching Cycle “T,” “I,” “S,” and “L” four-letter block evaluation, a new evaluation of the knowledge base may be performed.

In this illustrative example, the system proceeds to the Unit Two wordplay associated with the “T.” “I,” “S,” and “L” four-letter block even if there may still be some gaps in skill knowledge of the “T,” “I,” “S,” and “L” four-letter block as evidenced by the last evaluation for a student. Like the “M,” “A,” “P,” and “C” four-letter block, this is preferred because how humans learn is factored into the design of the interrelated concept and/or skill explanations, guided practices, independent practices, and assessments. For example in the “T,” “I,” “S,” and “L” wordplay lessons, the letters “M,” “A,” “P,” “C,” “T,”“I,” “S,” and “L,” the student has recently been taught, and has some prior knowledge of, are used to create decodable and high frequency words. Decodable words utilize letters for which the student has some letter knowledge to blend letter sounds to form words and teach vocabulary. In this manner, decoding skills, such as onset and rime, recognition of the “A” and “I” short vowel sounds in the middle of words, and the like, provide additional practice using letter knowledge to increase the likelihood the student will master letter knowledge and reading skills. As skills that require letter knowledge are introduced, practiced, and assessed, the knowledge base is updated with detailed data to reflect skills taught, practiced and assessed including current letter knowledge and the ability to use letter knowledge in isolation as well as the ability to apply letter knowledge to the process of reading, such as the ability to use decoding skills, recognize high frequency and vocabulary words, and the like.

In the preferred embodiment of the invention, Unit Two's wordplay teaches and assesses learning in book and print awareness, high frequency and vocabulary words and explicit and implicit oral and reading comprehension, short vowel sounds for “A” and “I” and identification and segmentation of those sounds in the middle of words, letter to letter blending including consonant blends and onset and rime for the letters “M,” “A,” “P,” “C,” “T,”“I,” “S,” “L,” and incorporates user-made books to provide narrated read aloud opportunities and to teach vocabulary. Wordplay may use decodable books to provide additional practice and assessment for teaching and applying decoding skills in context all of which may be presented using multiple levels of linear and/or interactive concept and/or skill explanations, guided practices, independent practices and assessments. Detailed teaching, practice and assessment data for each skill for each student is added to the knowledge base.

Once the student has been through Unit Two including the “T,” “I,” “S,” and “L” four-letter block and associated wordplay, the knowledge base is evaluated based on predetermined rules regarding individual skill assessments, related skill assessments, and/or collective skill assessments to ensure a predetermined level of skill knowledge has been attained for each skill and/or interrelationships between skills and/or combination of skills before advancing on to Unit Three. The evaluation is used in conjunction with predetermined routing logic to re-teach any prior skills the evaluation determines need additional practice including re-presenting material from the “T,” “I,” “S,” and “L” four-letter block and its associated wordplay. In addition, the evaluation may result in a Learning Disability Diagnostic being presented to one or more students to attempt to determine if a learning disability such as dyslexia may be affecting performance. The evaluations may also result in electronic notification of problem areas including results from a Learning Disability Diagnostic, if any, and specific recommendations for individual and small group instruction for individual students and groups of students that may be experiencing problems. Following the re-presentation of material based on the Unit Two evaluation, a new evaluation of the knowledge base may be performed.

In this illustrative example, the system proceeds to Unit Three even if there may still be some gaps in skill knowledge as evidenced by the last evaluation. This is preferred because how humans learn is factored into the design of the interrelated concept and/or skill explanations, guided practices, independent practices, and assessments. For example in Unit Three's four letter block, students will learn new letters and their associated letter skills facilitating skill transference. In addition, the letters “M,” “A,” “P,” “C,” “T,” “I,” “S,” and “L” may be re-taught using Evaluation Aware Re-Teaching Assessments to ensure those letter skills are mastered. In addition, in Unit Three's wordplay lessons, the letters “M,” “A,” “P,” “C,” “T,” “I,” “S,” and “L” are used in decodable words that utilize the same skills as were taught in the “M,” “A,” “P,” and “C”, and “T,” “I,” “S,” and “L” wordplay. In this manner, decoding skills using knowledge from Unit One and Unit Two such as onset and rime, letter to letter blending including consonant blends and short vowels and the like, continue to be practiced increasing the likelihood skill transference will take place and the student will master Unit One and Unit Two letter knowledge and reading skills. As skills that require prior letter knowledge are introduced, practiced, and assessed, the knowledge base is updated with detailed data to reflect skills taught, practiced and assessed including current letter knowledge and the ability to use letter knowledge in isolation as well as the ability to apply letter knowledge to the process of reading, such as the ability to use decoding skills, recognize high frequency and vocabulary words, and the like.

The Unit Three's Nondependent Skills Lesson Teaching Cycle letter block may comprise the letters “R,” “O,” “N,” and “D.” As students interact with the concept and/or skill explanations, guided practices, independent practices, and assessments contained within the “R,” “O,” “N,” and “D” four-letter block, the system uses its predetermined rules and routing logic to teach related skills and concepts. The process may be similar to and include differences from the process described above regarding the “M,” “A,” “P,” and “C” letter block and the “T,” “I,” “S,” and “L” letter block. The process may include, for example, teaching and assessing vocabulary and letter knowledge of the letters “M,” “A,” “P,” “C,” “T,” “S,” and “L” in isolation from short-term and/or long-term memory as well as using the letters “M,” “A,” “P,” “C,”“T” “I,” “S,” and “L” in application from long-term memory for skills, such as book and print awareness, high frequency and vocabulary word recognition, explicit and implicit oral and reading comprehension, letter to letter blending, onset and rime, and the ability to identify the short vowel “A” in the middle of words. The results are added to the knowledge base for each student based on the multiple levels of interactive concept and/or skill explanations, guided practices, independent practices and assessments that are presented and the specific level data attained for each student. Once the student has been through the entire “R,” “O,” “N,” and “D” four-letter block under the control of the rules and routing logic, the results of the teaching process of each of the skills taught in the “R,” “O,” “N,” and “D” four-letter block may be added to the knowledge base.

Once the student has been through the Unit Three Nondependent Skills Lesson Teaching Cycle “R,” “O,” “N,” and “D” four-letter block, the knowledge base is evaluated to ensure a predetermined level of skill knowledge has been attained before advancing on to the Unit Three Dependent Skills Lesson Teaching Cycle. The evaluation may be based on predetermined rules regarding individual skill assessments, related skill assessments, and/or collective skill assessments and is used in conjunction with predetermined routing logic to re-present material in the “R,” “O,” “N,” and “D” four-letter block. In addition, the evaluation may result in a Learning Disability Diagnostic being presented to one or more students to attempt to determine if a learning disability such as dyslexia may be affecting performance. The evaluations may also result in electronic notification of problem areas including results from a Learning Disability Diagnostic, if any, and specific recommendations for individual and small group instruction for individual students and groups of students that may be experiencing problems. Following the re-presentation of material based on the Unit Three Nondependent Skills Lesson Teaching Cycle “R,” “O,” “N,” and “D” four-letter block evaluation, a new evaluation of the knowledge base may be performed.

In this illustrative example, the system proceeds to the Unit Three Dependent Skills Lesson Teaching Cycle wordplay associated with the “R,” “O,” “N,” and “D” four-letter block even if there may still be some gaps in skill knowledge as evidenced by the last evaluation for a student. In the “R,” “O.” “N,” and “D” wordplay lessons, letters the student has recently been taught including from prior units and now has some prior knowledge of are used to create decodable words and high frequency vocabulary words strengthening the understanding of the need for letter knowledge as well as providing additional practice using letter knowledge and decoding skills. This increases the likelihood the student will master letter knowledge, decoding skills and reading skills that make use of letter knowledge resulting in skill transference and the mapping of those skills into multiple paths in the brain. In the case of decoding skills, the “R,” “O,” “N,” and “D” letter skills and previously taught letter skills are used to practice previously learned decoding skills, such as letter to letter blending including consonant blends and using onset and rime to form words, and to recognize vowel sounds in the middle of words. Because those decoding skills have been previously taught, using newly introduced letters in conjunction with those decoding skills results in skill transfer as the ability to use those decoding skills with the newly learned letters is learned. At the same time, both letter knowledge and decoding skills are mapped into multiple paths in the brain. As skills that require letter knowledge are introduced, practiced, and assessed, the knowledge base is updated with detailed data to reflect skills taught, practiced and assessed including current letter knowledge and the ability to use that letter knowledge from short-term and/or long-term memory in isolation, as well as the ability to apply that letter knowledge to the process of reading including decoding words in connected text, recognizing high frequency and vocabulary words, and oral and reading comprehension, in isolation and application in short-term and long-term memory.

In the preferred embodiment of the invention, “R,” “O,” “N,” and “D” wordplay teaches and assesses learning in book and print awareness, high frequency and vocabulary words and oral and reading comprehension, short vowels sounds for “O” and long vowel sounds “A,” “I,” using the two vowels go walking rule, and how to identify and segment vowel sounds in the middle of words, letter to letter blending including consonant blends and onset and rime for the letters “M,” “A,” “P,” “C,” “T,”“I,”“S,” “L,” and “R,” “O,” “N,” and “D”, and incorporates user-made books to provide narrated read aloud opportunities to teach fluency and build vocabulary and uses decodable books to provide additional practice for decoding skills using multiple levels of linear and/or interactive concept and/or skill explanations, guided practices, independent practices, and assessments. Detailed teaching, practice and assessment data attained for each skill for each student is stored in the knowledge base under the control of predetermined rules and routing logic based on scaffolding that uses specific assessments and broader assessments contained in the knowledge base in order to ensure each skill is taught and learned in its most basic form before being made progressively more difficult to simplify and enhance the learning process.

Once the student has been through Unit Three including the “R,” “O,” “N,” and “D” four-letter block and associated wordplay, the knowledge base is evaluated to ensure a predetermined level of skill knowledge has been attained before advancing on to Unit Four. The evaluation may be based on predetermined rules regarding individual skill assessments, related skill assessments, and/or collective skill assessments and used in conjunction with predetermined routing logic to re-teach any prior skills the evaluation determines need additional practice including to re-present material in the “R,” “O,” “N,” and “D” four-letter block and its associated wordplay. In addition, the evaluation may result in a Learning Disability Diagnostic being presented to one or more students to attempt to determine if a learning disability such as dyslexia may be affecting performance. The evaluations may also result in electronic notification of problem areas including results from a Learning Disability Diagnostic, if any, and specific recommendations for individual and small group instruction for individual students and groups of students that may be experiencing problems. Following the re-presentation of material based on the Unit Three based evaluation, a new evaluation of the knowledge base may be performed.

Additional Units including Nondependent Skills Lesson Teaching Cycles and Dependent Skills Lesson Teaching Cycles with their letter blocks and associated wordplays for a “F,” “E,” “H,” and “G” letter block, and “B” a “U,” “J,” and “W” letter block, a “Z,” “K,” “V,” and “Y” letter block, and a “Q” and “X” letter block may follow similar progressions. Each letter block, however, may include skills and concepts specific to the letters contained in the current block and previous blocks. For example, letter blocks may be customized to include, for example, soft consonants vs. hard consonants, rules controlling short vs. long vowels, high frequency words, vocabulary, verbs, phonics and decoding skills (e.g., blending, onset and rime, blends, consonant clusters, diphthongs, digraphs and variant vowels), new applications of previously taught letters and skills, rules for spelling patterns, lessons that teach and assess and explicit and implicit oral and reading comprehension from short-term memory in isolation and application and long-term memory in isolation and application, or the like.

After all the Units have been completed in accordance with the routing logic, scaffolding, and predetermined rules including the minimum level of working knowledge required for each skill to advance, the knowledge base is evaluated based on predetermined rules regarding nondependent and dependant skill knowledge and the ability to use nondependent and dependant skill knowledge in conjunction with skill rules. Based on that evaluation, nondependent and dependant skill lessons, such as, but not limited to, consonant sounds, vowel sounds and sounds that blends make as well as skill rule lessons that have not been mastered will be re-presented until the skills necessary to read in English are mastered. In addition, the evaluation may result in a Learning Disability Diagnostic being presented to one or more students to attempt to determine if a learning disability such as dyslexia may be affecting performance. The evaluations may also result in electronic notification of problem areas including results from a Learning Disability Diagnostic, if any, and specific recommendations for individual and small group instruction for individual students and groups of students that may still be experiencing problems.

As yet another of an embodiment of the present invention, the following discussion provides a discussion how embodiments of the present invention may be utilized to teach a subject to a student. It should be appreciated that a preferred embodiment of its method and apparatus for teaching subjects to mastery is based on defining a scope, or overall subject matter to be taught, and a sequence, (i.e., the order and scaffolding between skills), for a subject and dividing it into groups of overlapping and contiguous interactive teaching cycles that teach, provide practice, assess learning and re-teach rules, skills and sub skills in isolation and application in isolation and in context using short-term and long-term memory. Routing through the teaching cycles is controlled by routing logic that uses evaluations of skill knowledge and takes into consideration how many times skills have been taught, practiced, assessed and re-taught in a given teaching cycle to maximize learning while minimizing boredom.

Teaching Cycles

Skill/Sub Skill Teaching Cycles

The most basic teaching cycle is the Skill/Sub Skill Teaching Cycle. It is made up of one or more linear or interactive Teaches that introduce rules and/or concepts and/or skill/sub skills, and may include one or more linear or interactive “follow me” Guided Practices that may be multi-leveled that demonstrates the steps necessary to perform the rules and/or concepts and/or skill/sub skills, that may use a tri-modal approach (hear, see, do), and interactive Independent Practices, that may be multi-leveled, to assess skill level for one or more of the rules and/or concepts and/or skill/sub skills and may provide for In Situ Re-Teaches that occur during Independent Practices for incorrect responses that are used to clarify why an answer was incorrect, what the correct answer was and why, and generally includes a Re-Teach Cycle, that may be multi-leveled, that uses scores and skill level attained in Independent Practice and routing logic that also factors in the number of times a skill has been taught or re-taught in the current Skill/Sub Skill Teaching Cycle to determine whether and which elements of the Teaches, Guided Practices and Independent Practices to re-present and/or may present one or more new Skill/Sub Skill Teaching Cycles for the rules and/or concepts and/or skills/sub skills.

Frequently, Skill/Sub Skill Teaching Cycles are used to teach and assess knowledge of a single rule and/or concept and/or skill/sub skill, to the extent practicable, in order to reduce cognitive load, avoid confusion and improve the Independent Practice's ability to isolate and determine skill level

Skill/Sub Skill Teaching Cycles record their interactions in the Knowledgebase including rules and/or skills/sub skills taught, populations used, date time stamps and forms of input used in Teaches, Guided Practices and Independent Practices as well as discriminations made and scores and levels attained in Independent Practices and each of those elements from Re-Teach Cycles and In Situ Re-teaches, if any.

Applied Skills Teaching Cycles

Applied Skills Teaching Cycles are designed to introduce skills in isolation then apply the skills in an application using two Skill/Sub Skill Teaching Cycles. The first Skill/Sub Skill Teaching Cycle is used to teach a rule-based skill or skills in isolation to the extent practicable, in order to reduce cognitive load, avoid confusion and improve the Independent Practice's ability to isolate and determine skill level. The second Skill/Sub Skill Teaching Cycle is used to teach how to apply the new skill or skills in an application. The first Skill\Sub Skill Teaching Cycle's Re-Teach Cycle routs normally, however, when the Independent Practice results from the second Skill/Sub Skill Teaching Cycle are evaluated below specified levels, the Re-Teach generally routes back through the first Skill/Sub Skill Teaching Cycle before routing back through the second Skill/Sub Skill Teaching Cycle and/or may present one or more new Applied Skills Teaching Cycles and/or Skill/Sub Skill Teaching Cycles for the rule-based skills and sub skills and/or the application of the rules, skills and sub skills should the routing logic that also factors in the number of times a skill has been taught or re-taught in the current Applied Skills Teaching Cycle dictate.

Applied Skills Teaching Cycles record their interactions in the Knowledgebase including rules, skills and sub skills taught and assessed in isolation and in application, nondependent skills applied in rule-based dependent skills in isolation and in application, populations used, date time stamps and forms of input used in Teaches, Guided Practices and Independent Practices as well as discriminations made and scores and levels attained in Independent Practices and each of those elements from Re-Teach Cycles and In Situ Re-teaches, if any.

Teaching Cycle Clusters

Skill/Sub Skill Teaching Cycles and/or Applied Skill/Sub Skill Teaching Cycles are frequently grouped together into Teaching Cycle Clusters to facilitate teaching closely related and/or common rules, skills and sub skills.

After all of the teaching cycles in the Teaching Cycle Cluster are routed through, a Teaching Cycle Cluster Review, that may be multi-leveled, may be given to evaluate learning for one or more of the rules, skills and sub skills that were taught in the Teaching Cycle Cluster and, when given, adds the results to the Knowledgebase including rules, skills and sub skills assessed, date time stamps, forms of input, populations used, discriminations made and scores and levels.

Following the Teaching Cycle Cluster Review, if given, or following each of the teaching cycles in the Teaching Cycle Cluster when a Teaching Cycle Cluster Review is not given, an evaluation of skill level may be performed.

When a Teaching Cycle Cluster Review is given and evaluations are performed, generally, evaluations of skill level for routing and/or notification purposes will be based on scores and levels for one or more of the rules, skills and sub skills from the Teaching Cycle Cluster Review, however, evaluations for routing and/or notification purposes may factor in closely related or common rules, skills and sub skills from the Pre-Teaching Inventory, if given, Skill/Sub Skill Teaching Cycles and Teaching Cycle Cluster Reviews, to calculate skill level for one or more of the rules, skills and sub skills taught in the Teaching Cycle Cluster.

When a Teaching Cycle Cluster Review is not given, but an evaluation is performed, generally, evaluations for routing and/or notification purposes will factor in closely related or common rules, skills and sub skills from the Pre-Teaching Inventory, if given, Skill/Sub Skill Teaching Cycles and Teaching Cycle Cluster Review, if given in another Teaching Cycle Cluster, to calculate skill level for one or more of the rules, skills and sub skills taught in the Teaching Cycle Cluster.

When evaluations of skill levels are performed, generally, any rule, skill and/or sub skill level evaluated below specified levels results in a Re-Teach Cycle for skills below the specified levels. The Re-Teach Cycle re-presents rules, skills and sub skills from the Teaching Cycle Cluster and/or may present one or more new Skill/Sub Skill Teaching Cycles, Applied Skills Teaching Cycles and/or Teaching Cycle Clusters for rules, skills and skill/sub skills taught in the Teaching Cycle Cluster should the routing logic that also factors in the number of times a skill has been taught or re-taught in the current Teaching Cycle Cluster dictate.

Following the Re-Teach Cycle when a Teaching Cycle Cluster Review is given, the Teaching Cycle Cluster Review is generally re-presented for rules, skills and sub skills that were re-taught and the Knowledgebase updated accordingly. Generally, routing will proceed to the next teaching cycle even if one or more skill evaluations following the re-presentation of the Teaching Cycle Cluster Review are below specified levels. This is done since, generally, a later evaluation of the Knowledgebase will provide additional re-teaches, if needed, and in the meantime, related and/or common skills and sub skills in upcoming teaching cycles will provide additional teaching support for the skills.

Nondependent Skills Lesson Teaching Cycles

Nondependent Skills Lesson Teaching Cycles may begin with a Pre-Teaching Inventory to determine and record in the Knowledgebase prior knowledge of rules, skills and sub skills to be taught within the lesson. When a Pre-Teaching Inventory is given, the results of the Pre-Teaching Inventory in conjunction with routing logic are generally used to determine initial routing into Nondependent Skills Lesson Teaching Cycles. When a Pre-Teaching Inventory is not given, each teaching cycle in the Nondependent Skills Lesson Teaching Cycle is generally routed though.

One or more Skill/Sub Skill Teaching Cycles and/or Teaching Cycle Clusters are generally organized into Nondependent Skills Lesson Teaching Cycles that generally teach related and/or common skills and sub skills that do not have dependencies with each other that would significantly hamper independent learning of a given skill or sub skill. In general, related skills are taught within a Teaching Cycle Cluster and multiple Teaching Cycle Clusters are used to teach common nondependent skills and sub skills.

Using Teaching Cycle Clusters to teach related and/or common rules, skills and sub skills facilitates learning by continuing to teach common and/or related rules, skills and sub skills while teaching new skills around the previously introduced, but not necessarily mastered common and/or related rules, skills and sub skills. (For example, a Teaching Cycle Cluster might use the letter A to teach that all letters of the alphabet have common attributes including a name, a capital and lower case form, a sound the letter makes, etc., while other functionally identical Teaching Cycle Clusters would be used to teach the common attributes for B, then C, etc. or perhaps using a Teaching Cycle Cluster to teach the number sense of 1, then 2, then 3, etc.)

Following completion of the teaching cycles that are routed to in the Nondependent Skills Lesson Teaching Cycle, a Post Teaching Inventory that may be multi-leveled may be given. When given, a Post Teaching Inventory assesses learning for one or more of the rules, skills and sub skills that were taught in the Nondependent Skills Lesson Teaching Cycle and adds the results to the Knowledgebase including rules, skills and sub skills assessed, date time stamps, forms of input, populations, discriminations made and scores and levels.

Following the Post Teaching Inventory, if given, or following completion of the teaching cycles that are routed to in the Nondependent Skills Lesson Teaching Cycle when a Post Teaching Inventory is not given, an evaluation for re-teach routing and notification purposes may be performed.

In general, if a Post Teaching Inventory is given, the evaluation is based on the scores and levels from the Post Teaching Inventory, but, nonetheless could factor in closely related or common rules, skills and sub skills from the Pre-Teaching Inventory, if given, Skill/Sub Skill Teaching Cycles, Teaching Cycle Cluster Reviews, if given, and the Post Teaching Inventory.

Generally, if a Post Teaching Inventory is not given, evaluations may factor in closely related or common rules, skills and sub skills from the Pre-Teaching Inventory, if given, and Skill/Sub Skill Teaching Cycles and Teaching Cycle Cluster Reviews, if given.

When evaluations of skill levels are performed, generally, any rule, skill and/or sub skill level evaluated below specified levels results in a Re-Teach Cycle for skills below the specified levels.

The Re-Teach Cycle re-presents rules, skills and sub skills from the Nondependent Skills Lesson Teaching Cycle and/or may present one or more new Skill/Sub Skill Teaching Cycles and/or Teaching Cycle Clusters for rules, skills and sub skills taught in the Nondependent Skills Lesson Teaching Cycle should the routing logic that also factors in the number of times a skill has been taught or re-taught in the current Nondependent Skills Lesson Teaching Cycle dictate.

Following the teaching cycles routed through as a result of the Nondependent Skills Lesson Teaching Cycle evaluation, if performed, the Post Teaching Inventory, if previously given, will be re-presented for rules, skills and sub skills that were re-taught and the Knowledgebase updated accordingly.

Following the re-presentation of the Post Teaching Inventory, if given, or if a Post Teaching Inventory was not given, the teaching cycles routed through as a result of the last evaluation, an evaluation of skill knowledge may again be performed.

Following any evaluation when one or more rules, skills and/or sub skills are evaluated below specified levels, a Learning Disability Diagnostic may be presented to attempt to diagnose potential learning disabilities from patterns of error inherent in interactions with the Learning Disability Diagnostic and Teaching Cycles. In addition, notification of areas of weakness with individual and/or small group instruction recommendations including the results from the Learning Disability Diagnostic, if any, may be sent.

Following any evaluation when skills are evaluated at or above specified levels, electronic notification may be used to make lesson recommendations for individual and/or small group instruction in support of upcoming interactive skill lessons.

Dependent Skills Lesson Teaching Cycles

Dependent Skills Lesson Teaching Cycles may begin with a Pre-Teaching Inventory to determine and record in the Knowledgebase prior knowledge of rules, skills and sub skills to be taught and applied within the lesson. When a Pre-Teaching Inventory is given, results from the Pre-Teaching Inventory are used to determine initial routing into the Dependent Skills Lesson Teaching Cycle. When a Pre-Teaching Inventory is not given, each teaching cycle in the Dependent Skills Lesson Teaching Cycle is routed though.

One or more Skill/Sub Skill Teaching Cycles, Applied Skills Teaching Cycles and Teaching Cycle Clusters are frequently used in Dependent Skills Lesson Teaching Cycles to teach rule-based skills and sub skills that generally have dependencies on the ability to apply rules, skills and sub skills that were previously taught within one or more Nondependent Skills Lesson Teaching Cycles and/or the current Dependent Skills Lesson Teaching Cycle and/or previous Dependent Skills Lesson Teaching Cycles.

Generally, Applied Skills Teaching Cycle Clusters are used to teach rule-based skills and sub skills through a series of Dependent Skills Lesson Teaching Cycles that generally span multiple Unit Teaching Cycles. Generally, Dependent Skills Lesson Teaching Cycles become progressively more challenging within the current lesson and subsequent lessons and Unit Teaching Cycles as new rule-based skills are added while continuing to build on applications of current and previous nondependent skills, dependent skills and applications of dependent skills.

After a Dependent Skills Lesson Teaching Cycle's teaching cycles have been presented, a Post Teaching Inventory that may be multi-leveled may be given. When given, a Post Teaching Inventory assesses learning for one or more of the rules, skills and sub skills that were taught in the Dependent Skills Lesson Teaching Cycle and adds the results to the Knowledgebase including rules, skills and sub skills taught and assessed in isolation and in application, nondependent skills applied in rule-based dependent skills in isolation and in application, date time stamps, forms of input, populations, discriminations made and scores and levels.

Following the Post Teaching Inventory, if given, or following completion of the teaching cycles that are routed to in the Dependent Skills Lesson Teaching Cycle when a Post Teaching Inventory is not given, an evaluation for re-teach routing and notification purposes may be performed.

In general, if a Post Teaching Inventory is given, the evaluation is based on the scores and levels from the Post Teaching Inventory, but, nonetheless could factor in closely related or common rules, skills and sub skills from the Pre-Teaching Inventory, if given, Skill/Sub Skill Teaching Cycles, Applied Skills Teaching Cycles, Teaching Cycle Cluster Reviews, if given, and the Post Teaching Inventory.

Generally, if a Post Teaching Inventory is not given, the evaluation factors in closely related or common rules, skills and sub skills from the Pre-Teaching Inventory, if given, and Skill/Sub Skill Teaching Cycles, Applied Skills Teaching Cycles and Teaching Cycle Cluster Reviews, if given.

When evaluations of skill levels are performed, generally, any rule, skill and/or sub skill level evaluated below specified levels results in a Re-Teach Cycle for skills below the specified levels.

The Re-Teach Cycle re-presents rules, skills and sub skills from the Dependent Skills Lesson Teaching Cycle and/or may present one or more new Skill/Sub Skill Teaching Cycles and/or Applied Skills Teaching Cycles and/or Teaching Cycle Clusters for rules, skills and sub skills taught in the Dependent Skills Lesson Teaching Cycle should the routing logic that also factors in the number of times a skill has been taught or re-taught in the current Dependent Skills Lesson Teaching Cycle dictate.

Following the teaching cycles routed through as a result of the Dependent Skills Lesson Teaching Cycle evaluation, if performed, the Post Teaching Inventory, if previously given, will be re-presented for rules, skills and sub skills that were re-taught and the Knowledgebase updated accordingly.

Following the re-presentation of the Post Teaching Inventory, if given, or if a Post Teaching Inventory was not given, the teaching cycles routed through as a result of the last evaluation, an evaluation of skill knowledge may again be performed.

Following any evaluation when one or more rules, skills and/or sub skills are evaluated below specified levels, a Learning Disability Diagnostic may be presented to attempt to diagnose potential learning disabilities from patterns of error inherent in interactions with the Learning Disability Diagnostic and Teaching Cycles. In addition, notification of areas of weakness with individual and/or small group instruction recommendations including the results from the Learning Disability Diagnostic, if any, may be sent.

Following any evaluation when skills are evaluated at or above specified levels, electronic notification may be used to make lesson recommendations for individual and/or small group instruction in support of upcoming interactive skill lessons.

Unit Teaching Cycles

Unit Teaching Cycle's can be made from any combination of one or more Skill/Sub Skill Teaching Cycles and/or one or more Applied Skills Teaching Cycles and/or one or more Teaching Cycle Clusters and/or one or more Nondependent Skills Lesson Teaching Cycles and/or one or more Dependent Skills Lesson Teaching Cycles. For example, Unit Teaching Cycles may be used to teach, practice and assess intermingled nondependent and dependent skills.

Nonetheless, Unit Teaching Cycles are frequently organized into Nondependent Skills Lesson Teaching Cycles and Dependent Skills Lesson Teaching Cycles that progressively teach and build upon rules, skills and sub skills that relate to a central topic of a specific domain of the subject. Unit Teaching Cycles typically begin teaching relatively easy cycles of rules, nondependent skills and sub skills, then progress to teaching rule-based skills and sub skills that are dependent on the ability to apply previously taught nondependent skills and sub skills and then teaches the previously taught rule-based dependent skills and sub skills in application(s) that generally become progressively more challenging within a given Unit Teaching Cycle and later Unit Teaching Cycles.

Unit Teaching Cycles generally end with an evaluation of the Knowledgebase that provides additional Re-Teaches Cycles for rules, skills and sub skills from previous Nondependent Lesson Teaching Cycles and Dependent Skills Lesson Teaching Cycles that the evaluation of the Knowledgebase and routing logic dictate.

Following any evaluation when one or more rules, skills and/or sub skills are evaluated below specified levels, a Learning Disability Diagnostic may be presented to attempt to diagnose potential learning disabilities from patterns of error inherent in interactions with the Learning Disability Diagnostic and Teaching Cycles. In addition, notification of areas of weakness with individual and/or small group instruction recommendations including the results from the Learning Disability Diagnostic, if any, may be sent.

The Subject Matter Teaching Cycle

One or more Unit Teaching Cycles are generally organized into a series of Unit Teaching Cycles that collectively make up the Subject Matter Teaching Cycle. The Subject Matter Teaching Cycle uses a series of Unit Teaching Cycles to progressively teach and build upon related topics of the domain based on a scope and sequence of rules, skills and sub skills as well as dependencies and applications of rules, skills and sub skills while progressively teaching new rules, skills, sub skills and their dependencies and their applications to develop subject mastery.

Routing and Skill Evaluation

Evaluations for routing and notification purposes can be as simple as routing based on skill levels attained in a Pre-Teaching Inventory or level scores and level attained in an Independent Practice to as complex as using data stored in the Knowledgebase to factor in populations and discriminations made from multiple Teaches, Guided Practices, Independent Practices and Re-Teaches along with their date time stamps and scores and levels from each time a rule, skill, sub skill or related skills were taught and/or applied and/or assessed and/or re-taught including factoring results from Pre-Teaching Inventories, Independent Practices, Teaching Cycle Cluster Reviews, Nondependent Skills Lesson Teaching Cycle Post Teaching Inventories, and Dependent Skills Lesson Teaching Cycle Post Teaching Inventories and the number of times skills are taught, practiced and re-taught and applying greater or lesser weightings to various of their aspects.

Weightings used in Evaluations for Routing and Notification Purposes

In general, weightings for evaluations used in routing and notifications tend to be greater for assessment results that require the successful application of nondependent skills in dependent rule based skills that are assessed in application using long-term memory, followed by assessments of applied skills in application using short-term memory, followed by assessments of nondependent skills in isolation from long-term memory, followed by assessments of nondependent skills in isolation from short-term memory.

In general, more difficult and recent discriminations of nondependent skills and applications of nondependent skills in dependent skills are weighted more heavily than earlier assessments, easier discriminations and skills in isolation.

Unit One Teaching Cycle Evaluation and Routing

Evaluations for routing purposes frequently begin with a Pre-Teaching Inventory for the first Nondependent Skills Lesson Teaching Cycle in the first Unit Teaching Cycle. Following the Pre-Teaching Inventory, when given, routing logic evaluates pre-existing skill knowledge in the Knowledgebase from the Pre-Teaching Inventory to determine which teaching cycles in the Nondependent Skills Lesson Teaching Cycle to route through and in what order. If a Pre-Teaching Inventory is not given, all teaching cycles in the Nondependent Skills Lesson Teaching Cycle will generally be routed through.

Initial Nondependent Skill's Taught and Assessed in Isolation using Short-Term Memory

Initially, nondependent skills are generally taught in isolation and assessed from short-term memory to avoid confusion with other skills and reduce cognitive load using one or more Skill/Sub Skill Teaching Cycles and/or Teaching Cycle Clusters that each provide Teaches, Guided Practices, Independent Practices and, if need be, as determined by evaluation of performance in the corresponding Independent Practices, re-teaches, frequently, all in one period of interaction.

Use of Date/Time Stamps to Determine Short-term vs. Long-term Memory

To determine whether Independent Practice results reflect short-term or long-term memory, date time stamps are used to calculate the elapsed time between teaching, practicing or re-teaching of skills and assessments of the those skills.

Since, in general, the initial nondependent skill's Independent Practice date time stamps would be close to their Teaches and Guided Practices, the Independent Practice results would be determined to reflect short-term memory. The same would likely hold true for each of the skills in each of the initial teaching cycles since, the initial Teaching, Guided Practice, Independent Practice and Re-teach Cycles for each of those rules, skills and sub skills would generally occur close together as determined using date time stamps.

Nonetheless, skills may be classified as being assessed from long-term memory should the elapsed time between the assessment of a skill and a teach or re-teach of the skill be of sufficient duration as determined using date time stamps.

Initial use of Weightings in Evaluations for Routing Purposes

When Teaching Cycle Clusters are used, following completion of each of the Skill/Sub Skill Teaching Cycles in a Teaching Cycle Cluster, a Teaching Cycle Cluster Review that evaluates the rules, skills and sub skills taught in the Teaching Cycle Cluster may be given. Generally, when a Teaching Cycle Cluster Review is given the evaluations for routing purposes are based on the scores and levels from the Teaching Cycle Cluster Review, but nonetheless evaluations for re-teach routing purposes could weight skill level using closely related or common rules, skills and sub skills from the Pre-Teaching Inventory, if given, Independent Practices and Teaching Cycle Cluster Reviews.

When Teaching Cycle Cluster Reviews are not given, evaluations for re-teach routing purposes may factor in closely related and/or common rules, skills and sub skills from the Pre-Teaching Inventory, if given, and Skill/Sub Skill Teaching Cycles.

In general, evaluations that take into consideration multiple assessments of related and/or common skills and sub skills are frequently better gages of learning and skill level by reducing the impact of any given assessment, particularly outliers from inattention that may not reflect actual skill level. In addition, evaluations that take into consideration multiple assessments of related and/or common skills and sub skills help show if progress is being made learning those types of skills and sub skills.

For skills the evaluations determined to be below specified levels, Skill/Sub Skill Teaching Cycles will generally be re-presented and/or new Skill/Sub Skill Teaching Cycles that teach, provide practice, assess learning and, if needed, re-teach skills below specified levels may be presented.

As new nondependent skills are introduced in new Skill/Sub Skill Teaching Cycles and/or Teaching Cycle Clusters, they may contain related and/or common skills and sub skills taught in previous Skill/Sub Skill Teaching Cycles and/or Teaching Cycle Clusters.

When Teaching Cycle Clusters are used, evaluations following the second Teaching Cycle Cluster Review may factor in related and/or common skills and sub skills from Skill/Sub Skill Teaching Cycles, Teaching Cycle Cluster Reviews, if given, and the Pre-Teaching Inventory, if given.

When Teaching Cycle Clusters are not used, evaluations may factor in related and/or common skills and sub skills from Skill/Sub Skill Teaching Cycles and the Pre-Teaching Inventory, if given.

Individual and Small Group Instruction Recommendations

For student's that are learning new skills without much difficulty as determined by an evaluation, electronic notification may be used to make lesson recommendations for individual and/or small group instruction in support of upcoming interactive skill lessons.

When skill levels are below specified levels, electronic notification of areas of weakness including individual and/or small group lesson recommendations may be sent.

Individual and small group instruction recommendations may be suggested lesson plans and lessons correlated to the specific weaknesses exhibited through interactions with various Teaching Cycles.

Individual instruction recommendations are made, rather than small group instruction recommendations, when the system is unable to correlate similar weakness across more than one individuals' Knowledgebase evaluation.

The first Nondependent Skills Lesson Cycle Post Teaching Inventory and Long-term Memory

Following completion of the teaching cycles that are routed to in the Nondependent Skills Lesson Teaching Cycle, a Post Teaching Inventory may be given. Following the Post Teaching Inventory, if given, or following completion of the teaching cycles that are routed to in the Nondependent Skills Lesson Teaching Cycle when a Post Teaching Inventory is not given, an evaluation of nondependent skills for re-teach routing and notification purposes may be performed.

In general, if a Post Teaching Inventory is given, the evaluation is based on the scores and levels from the Post Teaching Inventory but nonetheless could factor in closely related or common rules, skills and sub skills from the Pre-Teaching Inventory, Skill/Sub Skill Teaching Cycles, Teaching Cycle Cluster Reviews and/or Post Teaching Inventory.

Generally, if a Post Teaching Inventory is not given, the evaluation factors in closely related or common rules, skills and sub skills from the Pre-Teaching Inventory, if given, and Skill/Sub Skill Teaching Cycles and Teaching Cycle Cluster Reviews.

Teaching cycles for skills the evaluation determined to be below specified levels will generally be re-presented and/or new teaching cycles that teach, provide practice, assess learning and, if needed, re-teach skills, may be presented.

Beginning with the first Nondependent Skills Lesson Teaching Cycle Post Teaching Inventory when given, evaluations will more frequently involve skills classified as being from long-term memory. This is due to the Post Teaching Inventory assessing all skills taught up to that point and the likelihood that some of those skills will not have been taught for days or even weeks.

Evaluations using Weightings for Routing, Diagnostic and Notification Purposes Following the first Nondependent Skills Lesson Teaching Cycle Post Teaching Inventory

Following the Nondependent Skills Lesson Teaching Cycle including the Post Teaching Inventory, when given, evaluations for re-teach routing will generally begin factoring in long-term assessments of skills taught in isolation as well as short-term assessments of skills taught in isolation based on appropriate combinations of the Pre-Teaching Inventory, Skill/Sub Skill Teaching Cycles, Teaching Cycle Cluster Reviews and the Post Teaching Inventory.

If evaluations determine that the skills are being learned, electronic notification may be used to make lesson recommendations for individual and/or small group instruction in support of upcoming interactive skill lessons.

If one or more evaluations are below specified levels, a Learning Disability Diagnostic may be presented to attempt to diagnose potential learning disabilities from patterns of error inherent in interactions with the Learning Disability Diagnostic and Teaching Cycles.

In addition, notification of the areas of weakness with individual and/or small group instruction recommendations including the results from the Learning Disability Diagnostic, if any, may be sent electronically.

Also, teaching cycles for the skills the evaluation determined to be below specified levels will generally be re-presented and/or new teaching cycles that teach, provide practice, assess learning, and if needed, re-teach skills may be presented.

Post Teaching Inventory Re-Presentation and Evaluation following the Nondependent Skills Lesson Teaching Re-Teach Cycle

Following the Teaching Cycles routed to as a result of the Nondependent Skills Lesson Teaching Cycle evaluation, the Post Teaching Inventory, if previously given, will be re-presented for the skills that were shown in the previous evaluation to be below specified levels.

Following the re-presentation of the Post Teaching Inventory, if given, or if a Post Teaching Inventory was not given, the teaching cycles routed as a result of the last evaluation, an evaluation of skill knowledge will again be performed.

If evaluations determine that the skills are being learned, electronic notification may be used to make lesson recommendations for individual and/or small group instruction in support of upcoming interactive skill lessons may be presented to attempt to diagnose potential learning disabilities from patterns of error inherent in interactions with the Learning Disability Diagnostic and Teaching Cycles.

In addition, notification of areas of weakness with individual and/or small group instruction recommendations including the results from the Learning Disability Diagnostic, if any, may be sent.

Pre-Teaching Inventory for the Initial Dependent Skills Lesson Teaching Cycle and Associated Routing

Generally, routing will proceed to the Pre-Teaching Inventory, if available, or the first teaching cycle of the first Dependent Skills Lesson Teaching Cycle if a Pre-Teaching Inventory is not given, even if the last evaluations in the Nondependent Lesson Teaching Cycle were below specified levels. This is done since, generally, the Unit Teaching Cycle evaluation will provide additional re-teaches, if needed, and in the meantime, the Dependent Skills Lesson Teaching Cycle will provide additional teaching support for the nondependent skills that will be applied in the Dependent Skills Lesson Teaching Cycles.

Following the Pre-Teaching Inventory, if given, routing logic evaluates pre-existing skill knowledge based on the results of the Pre-Teaching Inventory from the Knowledgebase to determine which teaching cycles in the Dependent Skills Lesson Teaching Cycle to route through and in what order. In the event that a Pre-Teaching Inventory is not given, all teaching cycles within the Dependent Skill Lesson Teaching Cycle will be routed through. Dependent Skills taught in Isolation and Application Applying Previously Taught Nondependent Skills using Short-term and Long-term Memory

Generally, in the initial Dependent Skills Lesson Teaching Cycle, one or more rule-based dependent skills are taught using one or more Teaching Cycle Clusters each containing one or more Skill/Sub Skill Teaching Cycles and/or Applied Skills Teaching Cycles to teach rule-based skills and sub skills that generally have dependencies on the ability to apply rules, skills and sub skills that were previously taught within one or more Nondependent Skills Lesson Teaching Cycles and/or the current Dependent Skills Lesson Teaching Cycle.

Generally, Skill/Sub Skill Teaching Cycles and/or Applied Skills Teaching Cycles are used to initially teach rule-based dependent skills in isolation to avoid confusion with other skills and reduce cognitive load. After a rule-based dependent skill has been taught, practiced, assessed and, if needed, re-taught in isolation, it is taught, practiced and assessed, and, if needed, re-taught in application.

In the Dependent Skills Lesson Teaching Cycle, the Knowledgebase is updated with results from rule-based dependent skills including the ability to apply previously taught nondependent skills in dependent skills, and following the first dependent skill, potentially, the ability to apply previously taught dependent skills in new dependent skills.

Following the first application of rule-based skills applying nondependent skills, evaluations for routing purposes and notification purposes may begin factoring in nondependent and dependent skills taught in isolation and assessed in isolation from short-term and/or long-term memory, nondependent and dependent skills taught in application and assessed in application while isolated and in application while in context from short-term memory, and potentially, based on elapsed time as calculated using date/time stamps, nondependent and dependent skills taught in application and assessed in application from long-term memory.

Dependent Skills Lesson Teaching Cycle Post Teaching Inventory and Evaluations

Following completion of the teaching cycles that are routed to in the Dependent Skills Lesson Teaching Cycle, a Post Teaching Inventory may be given. When given, the Post Teaching Inventory assesses one or more of the rules, skills and sub skills that were taught in the Dependent Skills Lesson Teaching Cycle as well as the ability to apply previously taught nondependent and dependent skills used in dependent skills.

Following the Post Teaching Inventory, if given, or following completion of the teaching cycles that are routed to in the Dependent Skills Lesson Teaching Cycle when a Post Teaching Inventory is not given, an evaluation of dependent skills for re-teach routing and notification purposes may be performed. When an evaluation of dependent skills is not performed, routing would generally proceed to the Unit Teaching Cycle evaluation.

In general, if a Post Teaching Inventory is given, the evaluation is based on the scores and levels from the Post Teaching Inventory but nonetheless could factor in closely related and/or common rules, skills and sub skills from the Pre-Teaching Inventory, Skill/Sub Skill Teaching Cycles, Applied Skills Teaching Cycles, Teaching Cycle Cluster Reviews and/or Post Teaching Inventory.

Generally, if a Post Teaching Inventory is not given, evaluations may factor in closely related and/or common rules, skills and sub skills from the Pre-Teaching Inventory, if given, and Skill/Sub Skill Teaching Cycles, Applied Skills Teaching Cycles and Teaching Cycle Cluster Reviews.

Teaching cycles for skills the evaluations determined to be below specified levels will generally be re-presented and/or new teaching cycles that teach, provide practice, assess learning and, if needed, re-teach skills, may be presented.

Following the teaching cycles routed to as a result of the Dependent Skills Lesson Teaching Cycle evaluation, the Post Teaching Inventory, if previously given, will be re-presented for the skills that were shown in the previous evaluation to be below specified levels. Generally, routing will proceed to the Unit Teaching Cycle evaluation following the re-presentation of the Post Teaching Inventory, if given, or the teaching cycles routed through as a result of the prior evaluations if a Post Teaching Inventory is not given. This is done since the Unit Teaching Cycle evaluation will provide additional re-teaches for all skills taught up to that point, if needed.

The First Unit Teaching Cycle Evaluation, Patterns of Error and Re-Teach Cycle

Following the Dependent Skills Lesson Teaching Cycle Re-Teach Cycle, evaluations of skill level using accumulated skill data from the Knowledgebase is used to weight skill level for each of the rules, skills and sub skills taught in both the Nondependent and Dependent Skills Lesson Teaching Cycles.

In addition, evaluations will look for patterns of error using nondependent skills in dependent skills as well as specific weakness in nondependent skills and dependent skills. To simplify finding patterns of error each decoding skill that is assessed in isolation or application whether in isolation or context will include a tag that indicates which dependent skills are required. A tag for a consonant cluster would be CC or CCC for example, where the C's represent consonants that can be blended letter to letter. Tags for decodable words might include CVC, CCVCe, CCCVCe or CVVC where C's represent consonants that can be blended letter to letter, V's represent vowels and the small e represents the silent E rule. In the case of CVC, the V represents short vowels and in the case of CVVC, the two V's represent the two vowels go walking rule. By looking at all misses that required decoding skills, weaknesses in use of specific letters and rules will be made evident and are referred to as patterns of error. An example of this would be finding that missed decoding operations frequently contained the letter “R” in them. If the words run, strive, screen and rate were missed in various discriminations while other similar discriminations such as fin, hive, greed and gate were correct, the pattern of error would indicate weakness in the ability to blend words using the letter “R”. The evaluation having determined a skill deficiency for the letter “R” would provide re-teaches for the letter “R” as needed to teach letter “R” skills to mastery.

Beginning with nondependent skills then progressing to dependent skills, any rules, skills and/or sub skills level below specified levels results in a Re-Teach Cycle for skills below the specified level. Generally, the Re-Teach Cycle re-presents rules, skills and sub skills from first the Nondependent Skills Lesson Teaching Cycle and then the Dependent Skills Lesson Teaching Cycle and/or may present one or more new Skill/Sub Skill Teaching Cycles and/or Applied Skill Teaching Cycles for skills/sub skills and/or rules and/or concepts taught in the Nondependent and/or the Dependent Skills Lesson Teaching Cycle.

Following the Teaching Cycles routed to as a result of the Unit Teaching Cycle Knowledgebase evaluation an evaluation of skill knowledge may again be performed. If one or more weightings are below specified levels, a Learning Disability Diagnostic may be presented to attempt to diagnose potential learning disabilities from patterns of error inherent in interactions with the Learning Disability Diagnostic and Teaching Cycles.

In addition, notification of the areas of weakness with individual and/or small group instruction recommendations including the results from the Learning Disability Diagnostic, if any, may be sent electronically.

Second Unit Teaching Cycle Routing and Evaluation

Initial Routing for the Second Unit Teaching Cycle Nondependent Skills Lesson Teaching Cycle

Generally, routing will proceed to the first Nondependent Skills Lesson Teaching Cycle of the second Unit Lesson Teaching Cycle even if the last evaluations in the prior Unit Teaching Cycle were below specified levels. This is done since, generally, the Nondependent and Dependent Skills Lesson Teaching Cycle's of the second Unit Teaching Cycle will provide additional teaching support for the nondependent and dependent skills that were taught in the first Unit Teaching Cycle. In addition, the second Nondependent Skills Lesson Teaching Cycle evaluation and the second Unit Teaching Cycle evaluation will generally provide additional re-teaches for previously taught nondependent and dependent skills and sub skills that are below specified levels.

Second Unit Teaching Cycle Nondependent Skills Lesson Teaching Cycle Evaluations and Routing

Following the Pre-Teaching Inventory, if given, routing logic evaluates pre-existing skill knowledge based on the results of the Pre-Teaching Inventory in the Knowledgebase to determine which teaching cycles in the second Unit Teaching Cycle's Nondependent Skills Lesson Teaching Cycle to route through and in what order. If a Pre-Teaching Inventory is not given, all teaching cycles in the Nondependent Skills Lesson Teaching Cycle will generally be routed through.

The second Unit Teaching Cycle's Nondependent Skills Lesson Teaching Cycle generally teaches new nondependent skills and sub skills that will be used in subsequent Dependent Skills Lesson Teaching Cycles while re-teaching skills from prior Nondependent Skills Lesson Teaching Cycles, if needed, using Evaluation Aware Re-Teaching Assessments.

Evaluation Aware Re-teaching Assessments

Evaluation aware Re-teaching Assessments are used to re-teach and assess skills and sub skills previously taught in the current and/or prior Nondependent Skills Lesson Teaching Cycles based on an evaluation of skill knowledge for specific nondependent skills below specified levels.

Evaluations following the first Teaching Cycle Cluster Review of the second Unit Teaching Cycle's Nondependent Skills Lesson Teaching Cycle

Evaluations following the second Nondependent Lesson Teaching Cycle Teaching Cycle Cluster Reviews may factor into evaluations weightings for multiple skills and sub skills and/or common skills and sub skills from all Skill/Sub Skill Teaching Cycles, Teaching Cycle Cluster Reviews, Pre-Teaching Inventories and Post Teaching Inventories.

The Second Unit Teaching Cycle's Nondependent Skills Lesson Teaching Cycle Post Teaching Inventory and Evaluations

Following completion of the teaching cycles that are routed to in the Second Unit Teaching Cycle's Nondependent Skills Lesson Teaching Cycle, a Post Teaching Inventory may be given. Following the Post Teaching Inventory if given, or following completion of the teaching cycles that are routed to in the Nondependent Skills Lesson Teaching Cycle when a Post Teaching Inventory is not given, an evaluation of nondependent skills for re-teach routing and notification purposes may be performed. In general, if a Post Teaching Inventory is given, the evaluation is based on the scores and levels from the Post Teaching Inventory but nonetheless could factor in closely related or common rules, skills and sub skills from any Pre-Teaching Inventory, Skill/Sub Skill Teaching Cycle, Applied Skills Teaching Cycles, Teaching Cycle Cluster Review and/or Post Teaching Inventory. Generally, if a Post Teaching Inventory is not given, the evaluation factors in closely related or common rules, skills and sub skills from any prior Pre-Teaching Inventory, Skill/Sub Skill Teaching Cycle, Applied Skills Teaching Cycles, Teaching Cycle Cluster Review and/or Post Teaching Inventory.

As in the first Nondependent Skills Lesson Teaching Cycle, teaching cycles for the skills the evaluation determined to be below specified levels will generally be re-presented and/or new teaching cycles that teach, provide practice, assess learning and, if needed, re-teach skills, may be presented.

If evaluations determine that the skills are being learned, electronic notification may be used to make lesson recommendations for individual and/or small group instruction in support of upcoming interactive skill lessons may be presented to attempt to diagnose potential learning disabilities. In addition, notification of the areas of weakness with individual and/or small group instruction recommendations including the results from the Learning Disability Diagnostic, if any, may be sent electronically.

Second Unit Teaching Cycle's Nondependent Skills Lesson Teaching Cycle Re-Teach Cycle Post Teaching Inventory Re-Presentation and Evaluation

Following the teaching cycles routed to as a result of the Nondependent Skills Lesson Teaching Cycle evaluation, the Post Teaching Inventory, if previously given, will re-present skills for assessment that were shown in the previous evaluation to be below specified levels.

Following the re-presentation of the Post Teaching Inventory, or if a Post Teaching Inventory was not given, the Teaching Cycles routed through as a result of the prior evaluation, an evaluation of skill knowledge will again be performed.

Generally, the evaluation factors in closely related or common rules, skills and sub skills from prior Pre-Teaching Inventories, if any, Skill/Sub Skill Teaching Cycles, Teaching Cycle Cluster Reviews and/or Post Teaching Inventories, if any.

If evaluations determine that the skills are being learned, electronic notification may be used to make lesson recommendations for individual and/or small group instruction in support of upcoming interactive skill lessons may be presented to attempt to diagnose potential learning disabilities. In addition, notification of the areas of weakness with individual and/or small group instruction recommendations including the results from the Learning Disability Diagnostic, if any, may be sent electronically.

The Second Unit Teaching Cycle's Dependent Skills Lesson Teaching Cycle, Pre-Teaching Inventory and Routing

Generally, routing will proceed to the Pre-Teaching Inventory of the second Unit Teaching Cycle's Dependent Skills Lesson Teaching Cycle, if available, or the first teaching cycle of the second Unit Teaching Cycle's Dependent Skills Lesson Teaching Cycle if a Pre-Teaching Inventory is not given, even if the last evaluations in the Nondependent Lesson Teaching Cycle were below specified levels. This is done since, generally, the Unit Teaching Cycle evaluation will provide additional re-teaches, if needed, and in the meantime, the Dependent Skills Lesson Teaching Cycle will provide additional teaching support for the nondependent skills to be applied in the Dependent Skills Lesson Teaching Cycles.

Following the Pre-Teaching Inventory, if given, routing logic evaluates pre-existing skill knowledge based on the results of the Pre-Teaching Inventory from the Knowledgebase to determine which teaching cycles in the Dependent Skills Lesson Teaching Cycle to route through and in what order. In the event that a Pre-Teaching Inventory is not given, all teaching cycles within the Dependent Skill Lesson Teaching Cycle will be routed through.

The Second Unit Teaching Cycle's Dependent Skill Lesson Teaching Cycle

Generally, the second Unit Teaching Cycle's Dependent Skills Lesson Teaching Cycle teaches one or more dependent rule-based skills and sub skills that were taught in the first Unit Teaching Cycle with an emphasis on applying new nondependent skills from the second Unit Teaching Cycle's Nondependent Skills Lesson Teaching Cycle and a secondary emphasis on applying nondependent skills from the first Unit Teaching Cycle's Nondependent Skills Lesson Teaching Cycle.

In addition, new dependent rule-based skills and sub skills are taught that generally build on previously taught rule-based dependent skills and sub skills again with an emphasis on applying new nondependent skills from the second Unit Teaching Cycle's Nondependent Skills Lesson Teaching Cycle and a secondary emphasis on applying nondependent skills from the first Unit Teaching Cycle's Nondependent Skills Lesson Teaching Cycle (e.g., using blending and vowel rules previously taught in single syllable words in multi-syllabic words).

During the second Unit Teaching Cycle's Dependent Skills Lesson Teaching Cycle, the Knowledgebase is updated with results from its teaching cycles including the ability to apply all previously taught nondependent skills in new and previously taught dependent skills including the ability to apply new and previously taught dependent skills in application.

The Second Unit Teaching Cycle's Dependent Skills Lesson Teaching Cycle Evaluations and Post Teaching Inventory

Following completion of the teaching cycles that are routed to in the Dependent Skills Lesson Teaching Cycle, a Post Teaching Inventory may be given. When given, the Post Teaching Inventory assesses each of the rules, skills and sub skills that were taught in the Dependent Skills Lesson Teaching Cycle in application including, when appropriate, the ability to apply previously taught nondependent and dependent skills.

Following the Post Teaching Inventory, if given, or following completion of the teaching cycles that are routed to in the Dependent Skills Lesson Teaching Cycle when a Post Teaching Inventory is not given, an evaluation of dependent skills for re-teach routing and notification purposes may be performed.

In general, if a Post Teaching Inventory is given, the evaluation is based on the scores and levels from the Post Teaching Inventory but nonetheless could factor in closely related and/or common rules, skills and sub skills from all Pre-Teaching Inventories, if given, Skill/Sub Skill Teaching Cycles, Applied Skills Teaching Cycles, Teaching Cycle Cluster Reviews and/or Post Teaching Inventories.

Generally, if a Post Teaching Inventory is not given, evaluations may factor in closely related and/or common rules, skills and sub skills from Pre-Teaching Inventories, Skill/Sub Skill Teaching Cycles, Applied Skills Teaching Cycles, Teaching Cycle Cluster Reviews and the first Unit Teaching Cycle's Post Teaching Inventory as appropriate.

Any rule, skill and/or sub skill level evaluated below specified levels may result in Re-Teach Cycles for skills below specified levels. The Re-Teach Cycle re-presents rules, skills and sub skills from the Dependent Skills Lesson Teaching Cycle and/or may present one or more new Skill/Sub Skill Teaching Cycles and/or Applied Skill Teaching Cycles for skills/sub skills and/or rules and/or concepts taught in the Dependent Skills Lesson Teaching Cycle.

Following the teaching cycles routed to as a result of the Dependent Skills Lesson Teaching Cycle evaluation, the Post Teaching Inventory, if previously given, will be re-presented for the skills that were shown in the previous evaluation to be below specified levels. Generally, routing will proceed to the Unit Teaching Cycle evaluation following the re-presentation of the Post Teaching Inventory, if given, or the teaching cycles routed through as a result of the prior evaluations if a Post Teaching Inventory is not given. This is done since the Unit Teaching Cycle evaluation will provide additional re-teaches for all skills taught up to that point, if needed.

The Second Unit Teaching Cycle Evaluation, Patterns of Error and Re-Teach Cycle

Following the Dependent Skills Lesson Teaching Cycle, evaluations for routing and notification purposes may factor in nondependent and dependent skills taught in isolation and assessed in isolation from short-term and/or long-term memory, nondependent and dependent skills taught in application and assessed in isolated application or in context application from short-term memory and long-term memory using accumulated skill data from the Knowledgebase to weight skill level for each of the rules, skills and sub skills taught in both Unit Teaching Cycle's Nondependent and Dependent Skills Lesson Teaching Cycles.

In general, evaluations following the second Unit Teaching Cycle's Dependent Skills Lesson Teaching Cycle may factor in results from new rule-based skills and sub skills taught in the second Unit Teaching Cycle's Dependent Skills Lesson Teaching Cycle applying nondependent skills taught in the first and second Unit Teaching Cycle's Nondependent Skills Lesson Teaching Cycles and previously taught rule-based skills from the first and second Unit Teaching Cycle applying nondependent skills taught in the first and second Unit Teaching Cycle's Nondependent Skills Lesson Teaching Cycles and previously taught rule-based skills from the first Unit Teaching Cycle's Dependent Skills Lesson Teaching Cycle applying nondependent skills taught in the first Unit Teaching Cycle's Nondependent Skills Lesson Teaching Cycle.

In addition, evaluations will look for patterns of error using nondependent skills in dependent skills and patterns of error using dependent skills when decoding words with multiple dependent skills as well as specific weakness in nondependent skills and dependent skills. An example of finding patterns of error when decoding words with multiple dependent skills would be finding that missed decoding frequently contained two vowels together. If the words boat, sail, scream and day were missed in various discriminations while other words were successfully decoded, the pattern of error would indicate weakness in the ability to blend words using the two vowels go walking rule. The evaluation having determined a skill deficiency for the two vowels go walking rule would provide re-teaches for the rule as needed to teach the two vowels go walking rule. Similarly, weaknesses in variant vowels, diphthongs and diagraphs among other skills could be detected and re-taught.

Beginning with nondependent skills then progressing to dependent skills, any rules, skills and/or sub skills level below specified levels may result in Re-Teach Cycles for skills below specified levels. Generally, the Re-Teach Cycle re-presents rules, skills and sub skills from the Nondependent Skills Lesson Teaching Cycles and then the Dependent Skills Lesson Teaching Cycles and/or may present one or more new Skill/Sub Skill Teaching Cycles and/or Applied Skill Teaching Cycles for skills/sub skills and/or rules and/or concepts taught in the Nondependent and/or the Dependent Skills Lesson Teaching Cycles.

Following the teaching cycles routed through as a result of the Unit Teaching Cycle evaluation, an evaluation of skill knowledge may again be performed. If one or more weightings are below specified levels, a Learning Disability Diagnostic may be presented to attempt to diagnose potential learning disabilities from patterns of error inherent in interactions with the Learning Disability Diagnostic and Teaching Cycles.

In addition, notification of the areas of weakness with individual and/or small group instruction recommendations including the results from the Learning Disability Diagnostic, if any, may be sent electronically.

Subsequent Unit Teaching Cycles Evaluation and Routing

Generally, following a prior Unit Teaching Cycle's last Dependent Skills Lesson Teaching Cycle Re-Teach Cycle, routing will proceed to the first Nondependent Skills Lesson Teaching Cycle of the next Unit Teaching Cycle even if the last evaluations in the prior Unit Teaching Cycle were below specified levels. This is done since, generally, the Nondependent and Dependent Skills Lesson Teaching Cycle's of the next Unit Teaching Cycle will provide additional teaching support for the nondependent and dependent skills that were taught in the prior Unit Teaching Cycles. In addition, the upcoming Nondependent Skills Lesson Teaching Cycle evaluations and the upcoming Unit Teaching Cycle evaluations will generally provide additional re-teaches for previously taught nondependent and dependent skills and sub skills that are below specified levels.

Nondependent Skills Evaluations and Routing

Following Pre-Teaching Inventories, if given, routing logic evaluates pre-existing skill knowledge based on the results of the Pre-Teaching Inventory in the Knowledgebase to determine which Teaching Cycles in the subsequent Unit Teaching Cycle's Nondependent Skills Lesson Teaching Cycles to route to and in what order. If a Pre-Teaching Inventory is not given, all teaching cycles in Nondependent Skills Lesson Teaching Cycles will generally be routed through.

Unit Teaching Cycle's Nondependent Skills Lesson Teaching Cycles generally teach new nondependent skills and sub skills that will be used in subsequent Dependent Skills Lesson Teaching Cycles while re-teaching skills from prior Nondependent Skills Lesson Teaching Cycles, if needed, using evaluation aware Re-Teaching Assessments.

Evaluation Aware Re-teaching Assessments

Evaluation Aware Re-teaching Assessments are used re-teach and assess skills and sub skills previously taught in the current and/or prior Nondependent Skills Lesson Teaching Cycles based on an evaluation of skill knowledge for specific nondependent skills below specified levels.

Dependent Skills Evaluations and Routing

Following Pre-Teaching Inventories for subsequent Dependent Skills Lesson Teaching Cycles, if given, routing logic evaluates pre-existing skill knowledge based on the results of the Pre-Teaching Inventory in the Knowledgebase to determine which Teaching Cycles in the subsequent Unit Teaching Cycle's Dependent Skills Lesson Teaching Cycles to route to and in what order. If a Pre-Teaching Inventory is not given, all teaching cycles in Dependent Skills Lesson Teaching Cycles will generally be routed through.

Following completion of each Dependent Skills Lesson Teaching Cycle, routing will generally proceed to the associated Unit Teaching Cycle evaluation.

Unit Teaching Cycle Evaluations and Routing

Following completion of Dependent Skills Lesson Teaching Cycles, Unit Teaching Cycle evaluations for routing and notification purposes may factor in nondependent and dependent skills taught in isolation and assessed in isolation from short-term and/or long-term memory, nondependent and dependent skills taught in application and assessed in application in isolation and context from short-term memory and long-term memory using accumulated skill data from the Knowledgebase to weight skill level for each of the rules, skills and sub skills taught in each of the Unit Teaching Cycle's Nondependent and Dependent Skills Lesson Teaching Cycles.

In general, Unit Teaching Cycle evaluations following each Unit Teaching Cycle's Dependent Skills Lesson Teaching Cycle may factor in results from new rule-based skills and sub skills taught in the Unit Teaching Cycle's Dependent Skills Lesson Teaching Cycle applying nondependent skills taught in prior Unit Teaching Cycle's Nondependent Skills Lesson Teaching Cycles and previously taught rule-based skills from prior Unit Teaching Cycles applying nondependent skills taught in prior Unit Teaching Cycle's Nondependent Skills Lesson Teaching Cycles and previously taught rule-based skills from prior Unit Teaching Cycle's Dependent Skills Lesson Teaching Cycle applying nondependent skills taught in prior Unit Teaching Cycle's Nondependent Skills Lesson Teaching Cycle.

In addition, evaluations will look for patterns of error using nondependent skills in dependent skills and patterns of error using dependent skills when decoding words with multiple dependent skills as well as specific weakness in nondependent skills and dependent skills. An example of finding patterns of error when decoding words with multiple dependent skills would be finding that missed decoding frequently contained two vowels together. If the words boat, sail, scream and day were missed in various discriminations while other words were successfully decoded, the pattern of error would indicate weakness in the ability to blend words using the two vowels go walking rule. The evaluation having determined a skill deficiency for the two vowels go walking rule would provide re-teaches for the rule as needed to teach the two vowels go walking rule. Similarly, weaknesses in variant vowels, diphthongs and diagraphs among other skills could be detected and re-taught.

Beginning with nondependent skills then progressing to dependent skills, any rules, skills and/or sub skills level below specified levels may result in Re-Teach Cycles for skills below specified levels. Generally, the Re-Teach Cycle re-presents rules, skills and sub skills from the Nondependent Skills Lesson Teaching Cycles and then the Dependent Skills Lesson Teaching Cycles and/or may present one or more new Skill/Sub Skill Teaching Cycles and/or Applied Skill Teaching Cycles for skills/sub skills and/or rules and/or concepts taught in the Nondependent and/or the Dependent Skills Lesson Teaching Cycles.

Following the teaching cycles routed through as a result of each Unit Teaching Cycle evaluation, an evaluation of skill knowledge may again be performed. If one or more weightings are below specified levels, a Learning Disability Diagnostic may be presented to attempt to diagnose potential learning disabilities from patterns of error inherent in interactions with the Learning Disability Diagnostic and Teaching Cycles.

In addition, notification of the areas of weakness with individual and/or small group instruction recommendations including the results from the Learning Disability Diagnostic, if any, may be sent electronically.

Subject Matter Teaching Cycle Evaluation and Re-Teach Cycle

Predetermined evaluation points throughout Unit Teaching Cycles, including evaluations following the last Unit Teaching Cycle, or the Subject Matter Teaching Cycle, in conjunction with routing, notification and passing evaluation criteria for a given skill or skills, based initially on short-term memory in isolation, and ultimately long-term memory in application and application in context, are used to teach until subject matter mastery.

Once assessments, evaluations and weightings meet a specified level for each of the skills and sub skills taught in isolation and in application in isolation and in context in short-term and long-term memory; mastery of the subject matter will have been attained.

As yet another example, the following Exhibit A illustrates pseudo code of an example of an embodiment of the present invention. It should be noted, however, that the following pseudo code may not contain examples of all of the features disclosed above, but only provides an example of an embodiment of the present invention.

Exhibit A

1.0 Subject Matter

1.1 Unit 1 Teaching Cycle

1.1.1 Lesson U1.nd (unit 1, Nondependent Skills) Pre-Assessment and Initial Lesson Routing

Pre-Assess Lesson U1.nd Skills
The pre-assessment presents lesson 1 questions for skills (U1.nd.1 through U1.nd.(n) (where n is from 2 to the total number of nondependent skills presented in lesson U1.nd) to determine pre-existing knowledge. The knowledge base is updated with the detail of discriminations tested by the pre-assessment, pass fail status and corresponding skill levels for each skill or sub skill.

The knowledge base for each skill U1.nd.(n) is then evaluated to begin control of routing through the Lesson Teaching Cycle U1.nd.

```
Begin
    Set Total.number.of.nondependent.skills.U1.nd
    N=0
    Lesson U1.nd
      If n is greater than Total.number.of.nondependent.skills.U1.nd
          then go to Lesson U1.nd Post Teaching Inventory
      else
          If skill U1.nd.(n) = “pass”
            then n=n+1, go to Lesson U1.nd
          else Do Skill/Sub Skill Teaching Cycle U1.nd.(n), n=n+1,
          go to Lesson U1.nd
End
```

1.1.2 Lesson Teaching Cycle U1.nd
Nondependent Skill Lesson Teaching Cycles generally teach the same or similar skills and sub skills around logical groupings of Skill/Sub Skill Teaching Cycles called Teaching Cycle Clusters. Each Teaching Cycle Cluster teaches the common or similar rules and skills (e.g., teaching the attributes of letter A, then B, then C, etc. or teaching the number sense of 1, then 2, then 3, etc.). This facilitates learning by teaching the common or similar rules, skills and sub skills and concepts while teaching new skills around those rules, skills and sub skills and concepts.

1.1.2.1 Skill/Sub Skill Teaching Cycle(s) U1.nd.1
Skill/Sub Skill Teaching Cycles teach, practice and assess skills and sub skills in isolation and application from short-term and long-term memory. Date time stamps are used to determine if a skill or sub skill is based on short-term or long-term memory.

Teach U1.nd.1.
The U1nd.1 Teach explains U1.nd.1's underlying concepts and begins developing the skill or sub skill.
The knowledge base is updated to reflect skill U1.nd.1 having been taught or re-taught including a date time stamp detailing when skill U1.nd.1 was taught or re-taught.

Guided Practice for Skill U1.nd.1
The skill U1.nd.1 Guided Practice immerses the student in practice of skill U1.nd.1.
The knowledge base is updated with skill U1.nd.1 practice detail and practice levels as well as date time stamps.

Independent Practice for Skill U1.nd.1
The skill U1.nd.1 Independent Practice assesses the ability to recall and/or apply skill U1.nd.1.
The knowledge base is updated with the detailed skill discriminations, the score and pass/fail status for each skill level assessed for skill U1.nd.1 in the Independent Practice. Date time stamps are also recorded.

Re-Teach Cycle
If U1.nd.1skill.level.passed<max.skill.level and loop.count<max.loop.count then go to basic skill teaching cycle skill U1.nd.1
Skill level achieved for skill U1.nd.1 in the Independent Practice in conjunction with routing criteria determines if skill U1.nd.1 will continue to be re-taught at this time or if the student moves on to skill U1.nd.(n) as determined by the pre-assessment and initial lesson routing.

1.1.2.2 Skill/Sub Skill Teaching Cycle(s) U1.nd.2

Teach Skill U1.nd.2
The U1nd.2 Teach explains U1.nd.1's underlying concepts and begins developing the skill or sub skill. Skill U1.nd.2 is generally related, but nondependent on skill U1.nd.1 mastery.
The knowledge base is updated to reflect skill U1.nd.2 having been taught or re-taught including a date time stamp detailing when skill U1.nd.2 was taught or re-taught

Guided Practice for Skill U1.nd.2—Immerses Student in Practice of Skill U1.nd.2
The knowledge base is updated with skill U1.nd.2 levels practiced as well as date time stamps

Independent Practice for Skill U1.nd.2—Assesses Ability to Recall and/or Apply Skill U1.nd.2
The knowledge base is updated with the detailed skill discriminations, the score and pass/fail status for each skill level assessed for skill U1.nd.2 in the Independent Practice. Date time stamps are also recorded.

Re-Teach Cycle
If U1.nd.2.skill.level.passed<max.skill.level and loop.count<max.loop.count then go to basic skill teaching cycle skill U1.nd.2
Skill level achieved for skill U1.nd.2 in the Independent Practice in conjunction with routing criteria determines if skill U1.nd.2 will continue to be re-taught at this time or if the student moves on to skill U1.nd.(n) as determined by the pre-assessment and initial lesson routing.

1.1.2.3 Periodic Review

1.1.2.4 Skill/Sub Skill Teaching Cycle(s) Skill U1.nd.(n) (Where n Represents Skill 3, 4, 5 etc. for as many nondependent skills as are in lesson 1.)

Teach Skill U1.nd.(n)—Skill U1.nd.(n) is Generally Related to Previous Skill U1.nd.(n), but Nondependent on Skill U1.nd.1 Through U1.nd.(n−1) Mastery
The knowledge base is updated to reflect skill U1.nd.2 having been taught or re-taught including a date time stamp detailing when skill U1.nd.(n) was taught or re-taught

Guided Practice for Skill U1.nd.(n)—Immerses Student in Practice of Skill U1.nd.(n)
The knowledge base is updated with skill U1.nd.(n) levels practiced as well as date time stamps

Independent Practice for Skill U1.nd.(n)—Assesses Ability to Recall and/or Apply Skill U1.nd.(n)
The knowledge base is updated with the detailed skill discriminations, the score and pass/fail status for each skill level assessed for skill U1.nd.(n) in the Independent Practice. Date time stamps are also recorded.

Re-Teach Cycle
If U1.nd.(n).skill.level.passed<max.skill.level and loop.count<max.loop.count then go to basic skill teaching cycle skill U1.nd.(n)
Skill level achieved for skill U1.nd.(n) in the Independent Practice in conjunction with routing criteria determines if skill U1.nd.(n) will continue to be re-taught at this time or if the student moves on to skill U1.nd.(n+) as determined by the pre-assessment and initial lesson routing.

1.1.3 Lesson U1.nd Post Teaching Inventory

1.1.3.1 Post Teaching Inventory (assessment) for Each Skill U1.nd.(n)
The Post Teaching Inventory presents lesson 1 nondependent skill and sub skill questions (skills U1.nd.1 through U1.nd.(n) (where n is from 2 to the max number of nondependent skills presented in lesson U1.nd) to update and assess skill level.
The knowledge base is updated with the detail of discriminations, including the score, pass/fail status and the corresponding skill level for each skill U1.nd.(n) assessed in the Post Teaching Inventory.

1.1.3.2 U1.nd Re-Teach Cycle and Routing
The skill level achieved for each skill U1.nd.(n) in the Post Teaching Inventory in conjunction with routing criteria determines which skills U1.nd.(n) will be re-taught at this time.
   If the PTI.skill.level for each skill U1.nd.(n) not equal “pass” then Do Skill/Sub Skill Teaching Cycle U1.nd.(n) (includes Teach, Guided and Independent Practices).
After the last nondependent skill U1.nd.(n) has been re-taught, the lesson U1.nd Post Teaching Inventory is retaken.

1.1.3.3 Retake Lesson U1.nd Post Teaching Inventory for Skills U1.nd.(n) with Failed Status
The knowledge base is updated with the detail of discriminations, including the score, pass/fail status and the corresponding skill level for each skill U1.nd.(n) assessed in the Post Teaching Inventory.

1.1.3.4 Evaluate the Knowledge base for Skills U1.nd.(n).
If PTI.skill.U1.nd.(n).level for any skill U1.nd.(n)<max level then calculate weightings for skills U1.nd.(n) using any or all assessments (including each Independent Practice, Period Review (if any) and Post Teaching Inventory discriminations, levels and scores).
   If weighted.skill.U1.nd.(n).level<minimum.acceptable.skill.U1.nd.(n).level then generate problem notification with recommended individual or small group instruction lessons, then go to Lesson U1.ds Pre-assessment and Initial Lesson Routing else go to Lesson.U1.ds Pre-assessment and Initial Lesson Routing
else go to Lesson.U1.ds Pre-assessment and Initial Lesson Routing.

1.1.4 Lesson U1.ds (Unit 1, Dependent Skills) Pre-Assessment and Initial Lesson Routing

1.1.4.1 Pre-Assess Lesson U1.ds Skills
The pre-assessment presents lesson 1 questions for skills (U1.ds.1 through U1.ds.(n) (where n is from 2 to the total number of dependent skills presented in lesson U1.ds) to determine pre-existing knowledge. The knowledge base is updated with the detail of discriminations tested by the pre-assessment, pass fail status and corresponding skill levels for each skill or sub skill as well as any nondependent skills U1.nd.(n) applied in any skill U1.ds.(n).

The knowledge base for each skill U1.ds.(n) is then evaluated to begin control of routing through the Lesson Teaching Cycle U1.ds.

```
Begin
    Set Total.number.of.dependent.skills.U1.ds
    N=0
    Lesson U1.ds
      If n is greater than Total.number.of.dependent.skills.U1.ds
          then go to Lesson U1.ds Post Teaching Inventory
      else
          If skill U1.ds.(n) = “pass”
            then n=n+1, go to Lesson U1.ds
          else Do Skill/Sub Skill Teaching Cycle U1.ds.(n), n=n+1,
          go to Lesson U1.ds
End
```

1.1.5 Lesson Teaching Cycle U1.ds
Dependent Skills Lesson Teaching Cycles generally apply the basic knowledge of one or more skills taught in the Unit's Nondependent Skills Teaching Lesson Cycle (in this case, U1.nd) and/or previous Unit's Dependent and Nondependent Skills Lesson Teaching Cycles. Generally, Dependent Skills Lesson Teaching Cycles become progressively more challenging within the lesson and subsequent units as they progressively add to and build on previous dependencies and applications of nondependent and dependent skills.

1.1.5.1 Skill/Sub Skill Teaching Cycle U1.ds.1
Skill/Sub Skill Teaching Cycles teach, practice and assess skills and sub skills in isolation and application from short-term and long-term memory. Date time stamps are used to determine if a skill or sub skill is based on short-term or long-term memory.

Teach U1.ds.1.
The U1.ds.1 Teach explains U1.ds. 1's underlying concepts and begins developing the skill or sub skill generally using knowledge gained from Lesson Teaching Cycle U1.nd.
The knowledge base is updated to reflect skill U1.ds.1 having been taught or re-taught including a date time stamp detailing when U1.ds.1 was taught or re-taught.

Guided Practice for Skill U1.nd.1
The skill U1.ds.1 Guided Practice immerses the student in practice of skill U1.ds.1 generally using knowledge gained from Lesson Teaching Cycle U1.nd.
The knowledge base is updated with skill U1.ds.1 practice detail and practice levels as well as date time stamps.

Independent Practice for Skill U1.ds.1
The skill U1.ds.1 Independent Practice assesses the ability to recall and/or apply skill U1.ds.1 generally using knowledge gained from Lesson Teaching Cycle U1.nd.
The knowledge base is updated with the detailed skill discriminations, the score and pass/fail status for each skill and skill level assessed for skill U1.ds.1 as well as any nondependent skills U1.nd.(n) applied in the U1.ds.1 Independent Practice. Date time stamps are also recorded.

Re-Teach Cycle
If U1.ds.1skill.level.passed<max.skill.level and loop.count<max.loop.count then Do Skill/Sub Skill Teaching Cycle U1.ds.1
Skill level achieved for skill U1.ds.1 in the Independent Practice in conjunction with routing criteria determines if skill U1.ds.1 will continue to be re-taught at this time or if the student moves on to skill U1.ds.(n) as determined by the Lesson U1.ds pre-assessment and initial lesson routing.

1.1.5.2 Skill/Sub Skill Teaching Cycle U1.ds.2

Teach Skill U1.ds.2—Skill U1.ds.2 is Generally Related, but Nondependent on Skill U1.ds.1 Mastery
Knowledge base is updated to reflect skill U1.ds.2 having been taught or re-taught including a date time stamp detailing when skill U1.ds.2 was taught or re-taught

Guided Practice for Skill U1.ds.2—Immerses Student in Practice of Skill U1.ds.2
Knowledge base is updated with skill U1.ds.2 levels practiced as well as date time stamps

Independent Practice for Skill U1.ds.2—Assesses Ability to Recall and/or Apply Skill U1.ds.2 Using Basic Knowledge Gained from One or More Nondependent Skills U1.nd.(n).
Knowledge base is updated to reflect the detailed skill discriminations, the score for each skill level that was assessed and pass/fail status for skill U1.ds.2 as well as any nondependent skills U1.nd.(n) applied in U1.ds.2. Date time stamps are also recorded.

Re-teach cycle—If Skill Level for U1.ds.2<Max Level, then Re-Present Skill U1.ds.2 including Guided and Independent Practices
Skill level achieved for skill U1.ds.2 in the Independent Practice in conjunction with routing criteria (e.g., If U1.ds.2 level<3 and loop count<3 re-teach else continue to skill U1.ds.3) determines if skill U1.ds.2 will be re-taught at this time or if the student moves on to skill U1.ds.3.

1.1.5.3 Skill/Sub Skill Teaching Cycle U1.ds.(n) (Where n Represents Skill 3, 4, 5 etc. for as Many Dependent Skills (i.e., Dependent on Nondependent Skills U1.nd.(n)) as are in Lesson 1.)

Teach Skill U1.ds.(n)—Skill U1.ds.(n) is Generally Related, but Nondependent on Skill U1.ds.1 Through U1.ds.(n−1) Mastery
Knowledge base is updated to reflect skill U1.ds.(n) having been taught or re-taught including a date time stamp detailing when skill U1.ds.(n) was taught or re-taught

Guided Practice for Skill U1.ds.(n)—Immerses Student in Practice of Skill U1.ds.(n)
Knowledge base is updated with skill U1.ds.(n) levels practiced as well as date time stamps

Independent Practice for Skill U1.ds.(n)—Assesses Ability to Recall and/or Apply Skill U1.ds.(n)
Knowledge base is updated to reflect the detailed skill discriminations, the score for each skill level that was assessed and pass/fail status for skill U1.ds.(n) as well as any nondependent skills U1.nd.(n) applied in U1.ds.(n). Date time stamps are also recorded.

Re-Teach—Re-Presents Skill U1.ds.(n) Including Guided and Independent Practices
Skill level achieved for skill U1.ds.(n) in the Independent Practice in conjunction with routing criteria determines if skill U1.ds.(n) will be re-taught at this time, or if the student moves on to skill n+1, or if U1.ds.(n) is the last dependent skill in this lesson, the lesson's dependent skill Post Teaching Inventory.

1.1.6 Lesson U1.ds Post Teaching Inventory

Each Skill U1.ds.(n) (Where n>0 and <Max Number of Dependent Skills in Lesson U1.ds).is Assessed in Application.
Knowledge base is updated to reflect skill discriminations and levels attained for each skill U1.ds.(n) as well as any nondependent skills U1.nd.(n) that are applied. Date time stamps are also recorded.

Evaluate the knowledge base.
If the skill level for skill U1.ds.(n)<max level then re-present skill U1.ds.(n) including Guided and Independent Practices else If skill level for all U1.nd.(n)=max level, go to Lesson.U2.nd

Post Teaching Inventory Re-Teach Cycle
Skill level achieved for skill U1.ds.(n) in the Post Teaching Inventory in conjunction with routing criteria determines if skill U1.ds.(n) will be re-taught at this time, or if the student moves on to skill n+1, or if U1.ds.(n) is the last dependent skill in this lesson, a retake of the lesson U1.ds Post Teaching Inventory.

1.1.7 Retake Lesson U1.ds Post Teaching Inventory

Each Skill U1.ds.(n) is Assessed in Application.
The knowledge base is updated to reflect skill discriminations and skill levels attained for each skill U1.ds.(n) as well as date time stamps recorded.

1.2 Unit 2 Teaching Cycle

1.2.1 Pre-Assessment and Initial Lesson Routing

1.2.1.1 Pre-assess lesson U2.nd skills (unit 2, nondependent skills)
The pre-assessment presents lesson 2 questions (skills U2.nd.1 through U2.nd.(n) (where n is the number of nondependent skills presented in lesson U2.nd) to determine pre-existing knowledge. The knowledge base is updated with the detail of discriminations tested by the pre-assessment, pass fail status and corresponding skill assessment levels.

The knowledge base for each skill U2.nd.(n) is then evaluated to control routing through the Skill/Sub Skill Teaching Cycles.

```
Begin
    Set Max.num.nondependent.skills U2.nd
    N=0
    Lesson U2.nd
      If n is greater than max.num.nondependent.skills U2.nd
          then go to Lesson U2.nd Post Teaching Inventory
      else
          If skill U2.nd.(n) = “pass”
            then n=n+1, go to Lesson U2.nd
          else Do Skill/Sub Skill Teaching Cycle U2.nd.(n), n=n+1, go to
          Lesson U2.nd
End
```

1.2.2 Lesson Teaching Cycle U2.nd

1.2.2.1 Skill/Sub Skill Teaching Cycle for Skill U2.nd.1

Teach Skill U2.nd.1
Knowledge base is updated to reflect skill U2.nd.1 having been taught or re-taught including a date time stamp detailing when skill U2.nd.1 was taught or re-taught

Guided Practice for Skill U2.nd.1—Immerses Student in Practice of Skill U2.nd.1
Knowledge base is updated with skill U2.nd.1 levels practiced as well as date time stamps

Independent Practice for Skill U2.nd.1—Assesses Ability to Recall and Apply Skill U2.nd.1
Knowledge base is updated to reflect the detailed skill discriminations, the score for each skill level that was assessed and pass/fail status for skill U2.nd.1. Date time stamps are also recorded.

Re-Teach Cycle—If Skill Level for U2.nd.1<Max Level, Then Re-Present Skill U2.nd.1 Including Guided and Independent Practices
Skill level achieved for skill U2.nd.1 in the Independent Practice in conjunction with routing criteria (e.g., If U2.nd.1 level<3 and loop count<3 re-teach else continue to skill U1.nd.2) determines if skill U2.nd.1 will be re-taught at this time or if the student moves on to skill U1.nd.2.

1.2.2.2 Skill/Sub Skill Teaching Cycle for Skill U2.nd.2

Teach Skill U2.nd.2—Skill U2.nd.2 is Generally Related, but Nondependent on Skill U2.nd.1 Mastery
Knowledge base is updated to reflect skill U2.nd.2 having been taught or re-taught including a date time stamp detailing when skill U2.nd.2 was taught or re-taught

Guided Practice for Skill U2.nd.2—Immerses Student in Practice of Skill U2.nd.2
Knowledge base is updated with skill U2.nd.2 levels practiced as well as date time stamps

Independent Practice for skill U2.nd.2 —assesses ability to recall and/or apply skill U2.nd.2
Knowledge base is updated to reflect the detailed skill discriminations, the score for each skill level that was assessed and pass/fail status for skill U2.nd.2. Date time stamps are also recorded.

Re-Teach—If Skill Level for U2.nd.2<Max Level, then Re-Present Skill U2.nd.2 Including Guided and Independent Practices
Skill level achieved for skill U2.nd.2 in the Independent Practice in conjunction with routing criteria determines if skill U2.nd.2 will be re-taught at this time or if the student moves on to skill U1.nd.3.

1.2.2.3 Skill/Sub Skill Teaching Cycle for Skill U2.nd.(n) (Where n Represents Skill 3, 4, 5 etc. for as Many Nondependent Skills as are in Lesson 1.)

Teach Skill U2.nd.(n)-Skill U2.nd.(n) is Generally Related to Previous Skill U2.nd.(n), but Nondependent on Skill U2.nd.1 Through U1.nd.(n−1) Mastery
Knowledge base is updated to reflect skill U2.nd.2 having been taught or re-taught including a date time stamp detailing when skill U2.nd.(n) was taught or re-taught

Guided Practice for Skill U2.nd.(n)—Immerses Student in Practice of Skill U2.nd.(n)
Knowledge base is updated with skill U2.nd.(n) levels practiced as well as date time stamps

Independent Practice for Skill U2.nd.(n)—Assesses Ability to Recall and/or Apply Skill U2.nd.(n)
Knowledge base is updated to reflect the detailed skill discriminations, the score for each skill level that was assessed and pass/fail status for skill U2.nd.(n). Date time stamps are also recorded.

Re-Teach cycle—If Skill Level for U2.nd.(n)<Max Level, Then Re-Present Skill U2.nd.(n) Including Guided and Independent Practices
Skill level achieved for skill U2.nd.(n) in the Independent Practice in conjunction with routing criteria determines if skill U2.nd.(n) will be re-taught at this time, or if the student moves on to skill n+1, or if U2.nd.(n) is the last nondependent skill in this lesson, the lesson Post Teaching Inventory.

1.2.3 Lesson U2.nd Post Teaching Inventory
Each skill U2.nd.(n) is assessed and the knowledge base is updated to reflect skill discriminations and skill levels attained for each skill U2.nd.(n) as well as date time stamps recorded.

Evaluate the knowledge base.
If the skill level for each skill U2.nd.(n)<max level, then re-present skill U2.nd.(n) including Guided and Independent Practices else If skill level for all U2.nd.(n)=max level, go to Lesson.U1.ds

Post Teaching Inventory Re-Teach Cycle
Skill level achieved for skill U2.nd.(n) in the Post Teaching Inventory in conjunction with routing criteria determines if skill U2.nd.(n) will be re-taught at this time, or if the student moves on to skill n+1, or if U2.nd.(n) is the last nondependent skill in this lesson, a retake of the lesson U1.nd Post Teaching Inventory.

1.2.4 Retake Lesson U2.nd Post Teaching Inventory
Each skill U2.nd.(n) is assessed and the knowledge base is updated to reflect skill discriminations and skill levels attained for each skill U2.nd.(n) as well as date time stamps recorded.

Evaluate the knowledge base.
If skill level for any skill U2.nd.(n)<max level then calculate weighting for all skill U2.nd.(n) assessments (includes each Independent Practice and Post Teaching Inventory for all skills U2.nd.(n))
   If weighted skill level U2.nd.(n)<minimum acceptable weighted skill level U2.nd.(n)
      then
         if weighted skill level U1.nd.(n)<minimum acceptable skill level U1.nd.(n)
         then
         generate U1.nd.(n)+U2.nd.(n) problem notification, recommend U1.nd.(n)+U2.nd.(n) individual or small group instruction lesson and go to lesson U2.ds.
         else
         generate U2.nd.(n) problem notification, recommend U2.nd.(n) individual or small group instruction lesson and go to lesson U2.ds.
   else go to Lesson.U2.ds.
else go to Lesson.U2.ds.

1.2.5 Lesson U2.ds (Unit 1, Dependent Skills) Cycle
Dependent skills U2.ds.(n) apply the basic knowledge of one or more nondependent skills U2.nd.(n), U1.nd.(n) as well as one or more dependent skills U1.ds.(n).

1.2.5.1 Skill/Sub Skill Teaching Cycle for Skill U2.ds.1.

Teach Skill U2.ds.1
Knowledge base is updated to reflect skill U2.ds.1 having been taught or re-taught including a date time stamp detailing when skill U2.ds.1 was taught or re-taught

Guided Practice for Skill U2.ds.1—Immerses Student in Practice of Skill U2.ds.1
Knowledge base is updated with skill U2.ds.1 levels practiced as well as date time stamps

Independent Practice for Skill U2.ds.1—Assesses Ability to Recall and/or Apply Skill U2.ds.1
Knowledge base is updated to reflect the detailed skill discriminations, the score for each skill level that was assessed and pass/fail status for skill U2.ds.1 as well as any nondependent skills U2.nd.(n) and U1.nd.(n) and dependent skills U1.ds.1 applied in U2.ds.1. Date time stamps are also recorded.

Re-teach cycle—If Skill Level for U2.ds.1<Max Level, Then Re-Present Skill U2.ds.1 Including Guided and Independent Practices
Skill level achieved for skill U2.ds.1 in the Independent Practice in conjunction with routing criteria (e.g., If U2.ds.1 level<3 and loop count<3 re-teach else continue to skill U1.ds.2) determines if skill U2.ds.1 will be re-taught at this time or if the student moves on to skill U2.ds.2.

1.2.5.2 Skill/Sub Skill Teaching Cycle for Skill U2.ds.2

Teach Skill U2.ds.2—Skill U2.ds.2 is Generally Related, but Nondependent on Skill U2.ds.1 Mastery
Knowledge base is updated to reflect skill U2.ds.2 having been taught or re-taught including a date time stamp detailing when skill U2.ds.2 was taught or re-taught

Guided Practice for Skill U2.ds.2—Immerses Student in Practice of Skill U2.ds.2
Knowledge base is updated with skill U2.ds.2 levels practiced as well as date time stamps

Independent Practice for Skill U2.ds.2—Assesses Ability to Recall and/or Apply Skill U2.ds.2 using Basic Knowledge Gained from one or More Nondependent Skills U2.nd.(n).
Knowledge base is updated to reflect the detailed skill discriminations, the score for each skill level that was assessed and pass/fail status for skill U2.ds.2 as well as any nondependent skills U2.nd.(n) and U1.nd.(n) and dependent skills U2.ds.1 and U1.ds.1 applied in U2.ds.2. Date time stamps are also recorded.

Re-Teach Cycle—If Skill Level for U2.ds.2<Max Level, Then Re-Present Skill U2.ds.2 Including Guided and Independent Practices
Skill level achieved for skill U2.ds.2 in the Independent Practice in conjunction with routing criteria (e.g., If U2.ds.2 level<3 and loop count<3 re-teach else continue to skill U1.ds.3) determines if skill U2.ds.2 will be re-taught at this time or if the student moves on to skill U1.ds.3.

1.2.5.3 Skill/Sub Skill Teaching Cycle for Skill U2.ds.(n) (Where n Represents Skill 3, 4, 5 etc. for as Many Dependent Skills (i.e., Dependent on Nondependent Skills U2.nd.(n)) as are in Lesson 1.)

Teach Skill U2.ds.(n)-Skill U2.ds.(n) is Generally Related, but Nondependent on Skill U2.ds.1 Through U1.ds.(n−1) Mastery
Knowledge base is updated to reflect skill U2.ds.(n) having been taught or re-taught including a date time stamp detailing when skill U2.ds.(n) was taught or re-taught

Guided Practice for Skill U2.ds.(n)—Immerses Student in Practice of Skill U2.ds.(n)
Knowledge base is updated with skill U2.ds.(n) levels practiced as well as date time stamps

Independent Practice for Skill U2.ds.(n)—Assesses Ability to Recall and/or Apply Skill U2.ds.(n)
Knowledge base is updated to reflect the detailed skill discriminations, the score for each skill level that was assessed and pass/fail status for skill U2.ds.(n) as well as any nondependent skills U2.nd.(n) and U1.nd.(n) and dependent skills U2.ds.1, U2.ds.2 and U1.ds.1 applied in U2.ds.(n). Date time stamps are also recorded.

Re-Teach—Re-Presents Skill U2.ds.(n) including Guided and Independent Practices
Skill level achieved for skill U2.ds.(n) in the Independent Practice in conjunction with routing criteria determines if skill U2.ds.(n) will be re-taught at this time, or if the student moves on to skill n+1, or if U2.ds.(n) is the last dependent skill in this lesson, the lesson's dependent skill Post Teaching Inventory.
   1.2.6 Lesson U2.ds Post Teaching Inventory

Each Skill U2.ds.(n) (Where n>0 and <Max Number of Dependent Skills in Lesson U2.ds).is Assessed in Application.
Knowledge base is updated to reflect skill discriminations and levels attained for each skill U2.ds.(n) as well as any nondependent skills U2.nd.(n) that are applied. Date time stamps are also recorded.

Evaluate the knowledge base.
If the skill level for skill U2.ds.(n)<max level then re-present skill U2.ds.(n) including Guided and Independent Practices else If skill level for all U2.nd.(n)=max level, go to Lesson.U2.nd

Post Teaching Inventory Re-Teach Cycle
Skill level achieved for skill U2.ds.(n) in the Post Teaching Inventory in conjunction with routing criteria determines if skill U2.ds.(n) will be re-taught at this time, or if the student moves on to skill n+1, or if U2.ds.(n) is the last dependent skill in this lesson, a retake of the lesson U1.ds Post Teaching Inventory.

1.2.7 Retake Lesson U2.ds Post Teaching Inventory

Each Skill U2.ds.(n) is Assessed in Application.
The knowledge base is updated to reflect skill discriminations and skill levels attained for each skill U2.ds.(n) as well as date time stamps recorded.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A computer program product stored on a recordable medium for teaching a subject to a student, the computer program product comprising:
(a) computer program code for performing a first teaching cycle for a first set of skills, the first set of skills being a set of skills in a sequence of skills;
(b) computer program code for performing at least one first independent practice of a multi-level independent practice, the first independent practice being a first interactive assessment that assesses a first level of understanding of the skills in the first set of skills;
(c) computer program code for recording in a knowledge base interactions between the student and the computer program product in the steps of teaching and performing;
(d) computer program code for determining an associated skill level for one or more of the skills of the first set of skills;
(e) computer program code for performing a first re-teach cycle of one or more of the skills of the first set of skills if the associated skill level indicates an unacceptable level of understanding; and
(f) computer program code for routing the student to a next lesson, the routing being based at least in part on interactions corresponding to the first set of skills and one or more skills previously presented.

2. The computer program product of claim 1, further comprising computer program code for performing a guided practice to reinforce one or more skills of the first set of skills.

3. The computer program product of claim 2, wherein the guided practice is a multi-level guided practice, levels of the multi-level guided practice corresponding to a different level of understanding.

4. The computer program product of claim 1, wherein the computer program code for routing includes computer program code for routing the student to a second set of skills if the student has been presented one or more of the first set of skills a first number of times.

5. The computer program product of claim 1, wherein the computer program code for determining includes computer program code for performing a second interactive assessment and the computer program code for routing includes computer program code for dynamically routing to the next lesson based at least in part on results of one or more of the second interactive assessment or the first interactive assessment.

6. The computer program product of claim 5, wherein the second interactive assessment is a multi-level assessment.

7. The computer program product of claim 1, further comprising computer program code for presenting the next lesson based at least in part on the level of understanding associated with one or more of the skills of the first set of skills.

8. The computer program product of claim 7, wherein the presentation of the next lesson is based at least in part on the level of understanding as determined by an interactive assessment.

9. The computer program product of claim 7, wherein the presentation of the next lesson is based at least in part on the level of understanding as determined by an evaluation of the knowledge base.

10. The computer program product of claim 1, wherein the next lesson comprises one or more skills different than skills next in the sequence of skills.

11. The computer program product of claim 10, wherein the next lesson is based at least in part on the level of understanding as determined by an interactive assessment.

12. The computer program product of claim 10, wherein the next lesson is based at least in part on the level of understanding as determined by an evaluation of the knowledge base.

13. The computer program product of claim 1, wherein the next lesson comprises one or more skills next in the sequence of skills.

14. The computer program product of claim 13, wherein the next lesson is based at least in part on the level of understanding as determined by an interactive assessment.

15. The computer program product of claim 13, wherein the next lesson is based at least in part on the level of understanding as determined by an evaluation of the knowledge base.

16. The computer program product of claim 1, wherein the computer program code for determining includes computer program code for performing an evaluation of the knowledge base to determine a first skill level and the computer program code for routing includes computer program code for dynamically routing to the next lesson based at least in part on the evaluation of the knowledge base.

17. The computer program product of claim 16, wherein the computer program code for performing the evaluation includes computer program code for computing a weighted average.

18. The computer program product of claim 17, wherein the weighted average weights long term more than short term and weights application more than isolation.

19. The computer program product of claim 17, wherein the weighted average is based at least in part on a grade level of the student.

20. The computer program product of claim 1, wherein the computer program code for routing is performed by determining a static route independent of results of an interactive assessment or an evaluation of the knowledge base.

21. The computer program product of claim 1, further comprising computer program code for performing a second independent practice, the second independent practice corresponding to a different level of understanding than the first independent practice.

22. The computer program product of claim 1, wherein the first re-teach cycle includes performing a second teaching cycle, a guided practice, and a second independent practice.

23. The computer program product of claim 1, wherein the first re-teach cycle includes performing a second teaching cycle and a guided practice.

24. The computer program product of claim 1, wherein the first re-teach cycle includes performing a second teaching cycle and a second independent practice.

25. The computer program product of claim 1, wherein the first re-teach cycle includes performing a guided practice and a second independent practice.

26. The computer program product of claim 1, wherein the first re-teach cycle includes re-teaching the first set of skills in a different manner.

27. The computer program product of claim 1, further comprising computer program code for performing one or more second re-teach cycles, each re-teach cycle corresponding to a level of understanding and including one or more of a second teaching cycle, a guided practice, and a second independent practice.

28. The computer program product of claim 1, wherein the interactions recorded in the knowledge base includes a date and time stamp the student performed an action and scores and levels attained by the student.

29. The computer program product of claim 1, wherein the routing is based at least in part on scores and skill levels associated with one or more skills attained by the student.

30. The computer program product of claim 1, wherein the routing is based at least in part on a number of times the first set of skills has been presented to the student.

31. The computer program product of claim 1, wherein the routing is based at least on one or more of a short-term isolation assessment, a short-term application assessment, a long-term isolation assessment, and a long-term application assessment.

32. The computer program product of claim 1, further comprising computer program code for performing (a)-(f) a first time for the first set of skills in isolation and computer program code for performing steps (a)-(f) a second time for the first set of skills in application.

33. The computer program product of claim 32, wherein the computer program code for performing the first re-teach cycle in application includes computer program code for performing a re-teach of the first set of skills in isolation and application.

34. The computer program product of claim 1, further comprising computer program code for performing steps (a)-(f) a plurality of times, each time being for a different set of skills.

35. The computer program product of claim 34, further comprising computer program code for performing a second interactive assessment after performing steps (a)-(f) a plurality of times, the second interactive assessment assessing a level of skill for any of the one or more of the skills previously presented.

36. The computer program product of claim 35, further comprising computer program code for altering the order skills are presented to the student based at least in part on the second interactive assessment.

37. The computer program product of claim 35, further comprising computer program code for recording results of the second interactive assessment in the knowledge base.

38. The computer program product of claim 34, further comprising computer program code for performing an evaluation of the knowledge base after performing steps (a)-(f) a plurality of times, the evaluation of the knowledge base evaluating cumulative information for any of the one or more of the skills previously presented.

39. The computer program product of claim 35, further comprising computer program code for altering the order skills are presented to the student based at least in part on the evaluation of the knowledge base.

40. The computer program product of claim 34, further comprising computer program code for performing a second re-teach cycle after performing steps (a)-(f) one or more times, the second re-teach cycle including one or more of a second teaching cycle, a guided practice, and a second independent practice for any of the skills previously presented.

41. The computer program product of claim 1, further comprising computer program code for performing steps (a)-(f) a first time for a set of nondependent skills and computer program code for performing steps (a)-(f) a second time for a set of dependent skills, one or more of the dependent skills being dependent on one or more of the nondependent skills.

42. The computer program product of claim 1, further comprising computer program code for performing a pre-teaching inventory, the pre-teaching inventory determining prior knowledge of each of the skills in the first set of skills.

43. The computer program product of claim 42, wherein the first teaching cycle is based at least in part on results of the pre-teaching inventory.

44. The computer program product of claim 42, further comprising computer program code for storing results of the pre-teaching inventory in the knowledge base.

45. The computer program product of claim 1, further comprising computer program code to determine a pattern of errors, the pattern of errors identifying a first sub-skill that is common to a plurality of skills, wherein the student repeatedly demonstrated a lack of an acceptable level of understanding of the first sub-skill.

46. The computer program product of claim 1, further comprising computer program code for generating a report indicating the level of understanding of at least one skill in the first set of skills.

47. The computer program product of claim 46, wherein the report is provided electronically and further comprising computer program code for drilling down from a unit or a set of skills to individual interactions or skills within the set of skills.

48. The computer program product of claim 1, further comprising computer program code for presenting a learning disability diagnostic.

49. The computer program product of claim 1, further comprising computer program code for providing a notification of a notification event.

50. The computer program product of claim 49, wherein the notification includes strengths, weaknesses, or disabilities with recommendations.
